(19) United States
(12) Patent Application Publication
(10) Pub. No.: US 2026/0196643 A1
(43) Pub. Date: Jul. 9, 2026

(54) BATTERY CELL STACK

(71) Applicants: HYUNDAI MOTOR COMPANY, Seoul (KR); Kia Corporation, Seoul (KR)

(72) Inventor: Hyun Chang KANG, Hwaseong-si (KR)

(73) Assignees: HYUNDAI MOTOR COMPANY, Seoul (KR); Kia Corporation, Seoul (KR)

(21) Appl. No.: 19/386,066

(22) Filed: Nov. 11, 2025

Related U.S. Application Data
(60) Provisional application No. 63/742,513, filed on Jan. 7, 2025.

(51) Int. Cl. H01M 50/289; H01M 10/613; H01M 10/653; H01M 10/6555; H01M 10/658; H01M 50/204; H01M 50/271; H01M 50/342; H01M 50/505; H01M 50/569

(52) U.S. Cl. CPC H01M 50/289; H01M 10/613; H01M 10/653; H01M 10/6555; H01M 10/658; H01M 50/204; H01M 50/271; H01M 50/3425; H01M 50/505; H01M 50/569

(57) ABSTRACT

Provided is a battery cell stack. The battery cell stack may include a plurality of battery cells that are arranged in a widthwise direction thereof, a partition member that is disposed between the plurality of battery cells and that partitions the plurality of battery cells, the partition member may include a partition body that is provided between a pair of battery cells, among the plurality of battery cells, and that extends in a height direction, a cover body that extends from the partition body toward a side in the widthwise direction to cover a first surface that faces a first side of a first battery cell of the pair of battery cells, in the height direction, and a support body that extends from the partition body parallel to the cover body to cover a second surface that faces a second side of the first battery cell in the height direction, the first surface and the second surface facing opposite sides of the first battery cell.

### CROSS-REFERENCE TO RELATED APPLICATIONS

This application claims the benefit of priority to U.S. provisional Application No. 63/742,513 filed in the U.S. Patent and Trademark Office on Jan. 7, 2025, the entire contents of which are incorporated herein by reference in their entireties.

### TECHNICAL FIELD

The present disclosure relates to a battery cell stack.

### BACKGROUND

As global interest in sustainable transportation continues to rise, electric vehicles (EVs) are experiencing rapid growth in both consumer adoption and technological development. This trend has intensified the demand for high-performance batteries capable of meeting the rigorous energy and safety requirements of EV applications. Among the various battery technologies available, lithium-ion batteries have become the preferred choice due to their high energy density, lightweight construction, and efficiency in energy storage and delivery.

Despite these advantages, lithium-ion batteries present significant safety concerns. One key issue stems from the inherent chemical reactivity of lithium, which can lead to hazardous outcomes under certain conditions—such as mechanical damage, manufacturing defects, or exposure to excessive heat. These conditions can trigger internal short circuits or chemical instability, resulting in fires or explosions. The risk is further amplified in EVs, where numerous battery cells are densely packed into modules or packs to achieve the necessary power output.

One of the most critical safety threats is thermal runaway—a chain reaction initiated when a single cell catches fire or overheats, releasing thermal energy and gases that can propagate to adjacent cells. This cascading failure can rapidly compromise the entire battery system, posing serious risks to vehicle integrity and passenger safety.

Thus, there is a need to design battery cell stacks and packs with integrated safety mechanisms, e.g., with an aim to detect early signs of failure, isolate affected cells, and prevent the spread of heat and combustion.

### SUMMARY

The present disclosure has been made to solve the above-mentioned problems occurring in the prior art while advantages achieved by the prior art are maintained intact.

An aspect of the present disclosure provides a battery cell stack that may delay transfer of heat to adjacent battery cells even when a fire occurs in a battery cell.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery cell stack includes a plurality of battery cells that are arranged in a widthwise direction thereof, a partition member that is disposed between the plurality of battery cells and that partitions the plurality of battery cells, the partition member includes a partition body that is provided between a pair of battery cells, among the plurality of battery cells, and that extends in a height direction, a cover body that extends from the partition body toward a side in the widthwise direction to cover a first surface that faces a first side of a first battery cell of the pair of battery cells, in the height direction, and a support body that extends from the partition body parallel to the cover body to cover a second surface that faces a second side of the first battery cell in the height direction, the first surface and the second surface facing opposite sides of the battery cell.

The plurality of battery cells may include a second battery cell that is provided on an opposite side to a side that faces the partition body with respect to the first battery cell, the first surface of the first battery cell and a first surface of the second battery cell facing a first side in the height direction may be configured to be covered by the cover body, and the second surface of the first battery cell and a second surface of the second battery cell facing a second side in the height direction may be configured to be covered by the support body.

The partition member may include an end cover body that extends from the cover body toward the support body to cover together at least a portion of the first battery cell and at least a portion of the second battery cell on a side of the first battery cell in a lengthwise direction, and a guide cover body that extends from the support body toward the cover body to cover at least a portion of the first battery cell and at least a portion of the second battery cell on the side of the first battery cell in the lengthwise direction.

The partition member may further include a connection body that connects the end cover body and the guide cover body and having a thickness that is greater than a thickness of the partition body in the widthwise direction.

The first battery cell may include a cell lead part that extends to the side in the lengthwise direction, and the connection body may protrude from the partition body toward the cell lead part of the first battery cell.

The connection body may be spaced apart from the cell lead part.

The battery cell stack may further include an end plate that is disposed at a side of the plurality of battery cells in the widthwise direction, and a support member that is disposed between, among the plurality of battery cells, a battery that is located at an end in the widthwise direction and the end plate, and that covers a side of, among the plurality of battery cells, the battery cell located at the end in the widthwise direction.

The support member may be disposed parallel to the cover body.

The support member may include a support partition body that is provided between, among the plurality of battery cells, the battery cell located at the end in the widthwise direction and the end plate and that extends in the height direction, a first support cover body that extends from the support partition body toward the cover body, and a second support cover body that extends from the support partition body toward the support body.

The cover body may include a cover venting hole that is formed on an area that faces the first battery cell or an area that faces the second battery cell, or a cover notch part that is formed on an area that faces the first battery cell or an area that faces the second battery cell and has a cut shape or a thickness that is smaller than a thickness of a surrounding area, and the battery cell stack may further include an inner fire-resistant member that is provided between the cover body and the first battery cell or between the cover body and the second battery cell and including an inner notch part that is formed on an area that faces the cover venting hole or cover notch part and has a cut shape or a thickness that is smaller than a thickness of a surrounding area.

The battery cell stack may further include a sensing assembly including a bus bar that is electrically connected to the plurality of battery cells and a sensing frame that supports the bus bar and has a sensing hole formed on an area that faces the plurality of battery cells, a sensing cover that covers an outer side of the sensing assembly and including a cover hole formed on an area that faces the sensing hole, and a sensing fire-resistant member that is disposed between the sensing assembly and the sensing cover and including a sensing notch part that is formed on an area that faces the sensing hole and the cover hole and has a cut shape or a thickness that is smaller than a thickness of a surrounding area.

A surface of the partition body that faces the first battery cell may be formed of a material having thermal conductivity or a material having heat insulation or fire resistance.

The partition member may include a first partition member that covers the first battery cell and the second battery cell together and a second partition member that is provided parallel to the first partition member, and the battery cell stack may further include a barrier member that contacts i) at least one of the first partition member and the second partition member, or ii) at least one of the first battery cell and the second battery cell.

The barrier member may be formed of a material having heat insulation or fire resistance or a material having thermal conductivity.

The battery cell stack may further include a cooling plate that is disposed between the first partition member and the second partition member to cool the first partition member and the second partition member.

Each of the plurality of battery cells may include a first electrode, a second electrode having a polarity different from the first electrode, a separator that is provided between the first electrodes and the second electrodes, and a case including a packaging area that surrounds the first electrode, the second electrode, and the separator, and an extension area that extends from the packaging area to a side the battery cell in the lengthwise direction of, and the extension area may be bent to a side in the widthwise direction to cover a side of the packaging area in the lengthwise direction.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a battery cell stack according to an embodiment of the present disclosure;

FIG. 2 is an exploded perspective view illustrating a battery cell stack according to an embodiment of the present disclosure;

FIG. 3 is a longitudinal cross-sectional view of a battery cell stack according to an embodiment of the present disclosure;

FIG. 4 is a perspective view of battery cells and a partition member of a battery cell stack according to an embodiment of the present disclosure;

FIG. 5 is a perspective view of a pair of partition members and a battery cell disposed therebetween according to an embodiment of the present disclosure;

FIG. 6 is a perspective view of a partition member viewed from another direction according to an embodiment of the present disclosure;

FIG. 7 is a side view of a battery cell and a partition member viewed in a lengthwise direction according to an embodiment of the present disclosure;

FIG. 8 is a transverse cross-sectional view of battery cells and a partition member according to an embodiment of the present disclosure;

FIG. 9 is a transverse cross-sectional view of battery cells and a partition member according to an embodiment of the present disclosure;

FIG. 10 is a longitudinal cross-sectional view of a partition member, battery cells, a barrier member, and a cooling plate according to an embodiment of the present disclosure;

FIG. 11 is a longitudinal cross-sectional view of a partition member, battery cells, a barrier member, and a cooling plate according to an embodiment of the present disclosure;

FIG. 12 is a longitudinal cross-sectional view of a partition member, battery cells, a barrier member, and a cooling plate according to an embodiment of the present disclosure;

FIG. 13 is a longitudinal cross-sectional view of a battery cell stack for illustrating a support member according to another embodiment of the present disclosure;

FIG. 14 is a perspective view of a pair of partition members and a battery cell disposed therebetween according to another embodiment of the present disclosure;

FIG. 15 is a front view of a partition member and battery cells viewed in a lengthwise direction according to another embodiment of the present disclosure;

FIG. 16 is a side view of a partition member and battery cells viewed in a widthwise direction according to another embodiment of the present disclosure;

FIG. 17 is a longitudinal cross-sectional view of a partition member and battery cells according to another embodiment of the present disclosure;

FIG. 18 is a transverse cross-sectional view of a partition member and battery cells according to another embodiment of the present disclosure;

FIG. 19 is a transverse cross-sectional view of a partition member and battery cells according to another embodiment of the present disclosure;

FIG. 20 is a longitudinal cross-sectional view of a partition member, a support member, battery cells, and an end plate according to another embodiment of the present disclosure;

FIG. 21 is a longitudinal cross-sectional view of a partition member, a support member, battery cells, and an end plate for illustrating a support member according to another embodiment different from FIG. 20 of the present disclosure;

FIG. 22 is a longitudinal cross-sectional view of a partition member, battery cells, and a barrier member according to another embodiment of the present disclosure;

FIG. 23 is a perspective view of battery cells and a partition member viewed in a lengthwise direction according to still another embodiment of the present disclosure;

FIG. 24 is a longitudinal cross-sectional view of battery cells and a partition member according to still another embodiment of the present disclosure;

FIG. 25 is a transverse cross-sectional view of battery cells and a partition member according to still another embodiment of the present disclosure;

FIG. 26 is a transverse cross-sectional view of battery cells and a partition member according to still another embodiment of the present disclosure;

FIG. 27 is a longitudinal cross-sectional view of a partition member, a support member, battery cells, and an end plate according to still another embodiment of the present disclosure;

FIG. 28 is a longitudinal cross-sectional view of a partition member, a support member, battery cells, and an end plate for illustrating another support member that is different from FIG. 27;

FIG. 29 is a longitudinal cross-sectional view of a partition member, battery cells, and a barrier member according to another embodiment;

FIG. 30 is a longitudinal cross-sectional view of a partition member, battery cells, and a support member according to still another embodiment;

FIG. 31 is a longitudinal cross-sectional view of a partition member, battery cells, and a support member for illustrating a support member that is different from that of FIG. 30;

FIG. 32 is a longitudinal cross-sectional view of a partition member, battery cells, and a support member according to still another embodiment;

FIG. 33 is a longitudinal cross-sectional view of a partition member, battery cells, and a support member for illustrating a support member that is different from that of FIG. 32;

FIG. 34 is a transverse cross-sectional view of a partition member, battery cells, and a support member according to still another embodiment;

FIG. 35 is a longitudinal cross-sectional view of a partition member, battery cells, and a support member for illustrating a support member that is different from that of FIG. 34;

FIG. 36 is a longitudinal cross-sectional view of battery cell stack according to an embodiment of the present disclosure;

FIG. 37 is an enlarged view of part A shown in FIG. 36;

FIG. 38 is an enlarged view of part B shown in FIG. 36;

FIG. 39 is a front view of a first partition member and a second partition member viewed in a lengthwise direction according to an embodiment of the present disclosure;

FIG. 40 is a perspective view of a first end cover body of a first partition member and a second end cover body of a second partition member according to an embodiment of the present disclosure;

FIG. 41 is a longitudinal cross-sectional view of a first partition member and a second partition member when a first end cover body of the first partition member and a second end cover body of the second partition member are coupled to each other;

FIG. 42 is a transverse cross-sectional view of a first partition member and a second partition member when a first guide cover body of the first partition member and a second guide cover body of the second partition member are coupled to each other;

FIG. 43 is a side view of an end cover body viewed in a widthwise direction according to still another embodiment of the present disclosure;

FIG. 44 is an exploded perspective view illustrating a state, in which a coupling member and a guide coupling member are spaced apart from an end plate of a battery cell stack, according to still another embodiment of the present disclosure;

FIG. 45 is a side view of a partition member, a coupling member, a guide coupling member, and a nut member of a battery cell stack viewed in a lengthwise direction according to still another embodiment of the present disclosure;

FIG. 46 is a perspective view illustrating that one surface of a partition member is formed of a material having thermal conductivity or a material having heat insulating property according to an embodiment of the present disclosure;

FIG. 47 is a view illustrating a manufacturing process of a battery cell according to an embodiment of the present disclosure;

FIG. 48 is an enlarged view of a cover of a battery cell according to an embodiment of the present disclosure;

FIG. 49 is a transverse cross-sectional view of a battery cell stack according to an embodiment of the present disclosure;

FIG. 50 is a transverse cross-sectional view of battery cells, a partition member, and a sensing assembly according to another embodiment of the present disclosure;

FIG. 51 is a longitudinal cross-sectional view of other battery cells, an inner fire-resistant member, a partition member, and an outer fire-resistant member according to an embodiment of the present disclosure;

FIG. 52 is a plan view of a cover body including a cover venting hole according to various embodiments of the present disclosure;

FIG. 53 illustrates a side view and a plan view of a fire-resistant member including a cover notch part viewed in a lengthwise direction according to various embodiments of the present disclosure;

FIG. 54 is a perspective view of a battery cell stack according to still another embodiment of the present disclosure;

FIG. 55 is a transverse cross-sectional view of battery cells, a sensing assembly, a sensing fire-resistant member, and a sensing cover illustrated in FIG. 53; and

FIG. 56 is a plan view of a battery pack, in which a battery cell stack is mounted, according to an embodiment of the present disclosure.

### DETAILED DESCRIPTION

Hereinafter, some embodiments of the present disclosure will be described in detail with reference to the accompanying drawings. In adding reference numerals to the components of the drawings, it should be noted that the same components have the same numerals as possible even when they are illustrated on different drawings. Furthermore, in describing the embodiments of the present disclosure, detailed descriptions associated with well-known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

In the specification below, a widthwise direction may refer to the X direction or an opposite direction to the X direction, and a lengthwise direction may refer to the Y direction or an opposite direction to the Y direction. In addition, a height direction may refer to the Z direction or an opposite direction to the Z direction.

In the specification below, a width direction may be a width direction of the battery cell 110 or a width direction of the partition members 600, 600-1, 600-2, 600-3, 600-4, 600-5, and 600-6, or a width direction of the cover body 620, 620-1, 620-2, 620-3, 620-4, 620a-5, 620b-5, 620a-6, 620b-6, 620c-6, or a direction in which the battery cells 110 are stacked.

In the specification below, a height direction may refer to a direction in which the battery cell 110 extends from one surface of the battery packs 100 and 100-6 on which the battery cell 110 is mounted.

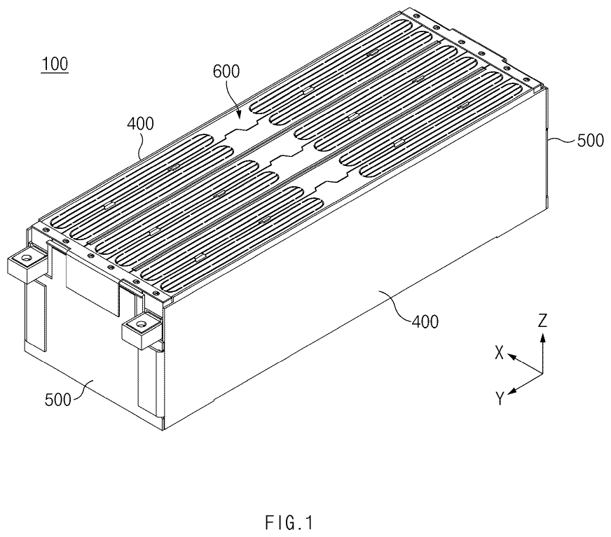

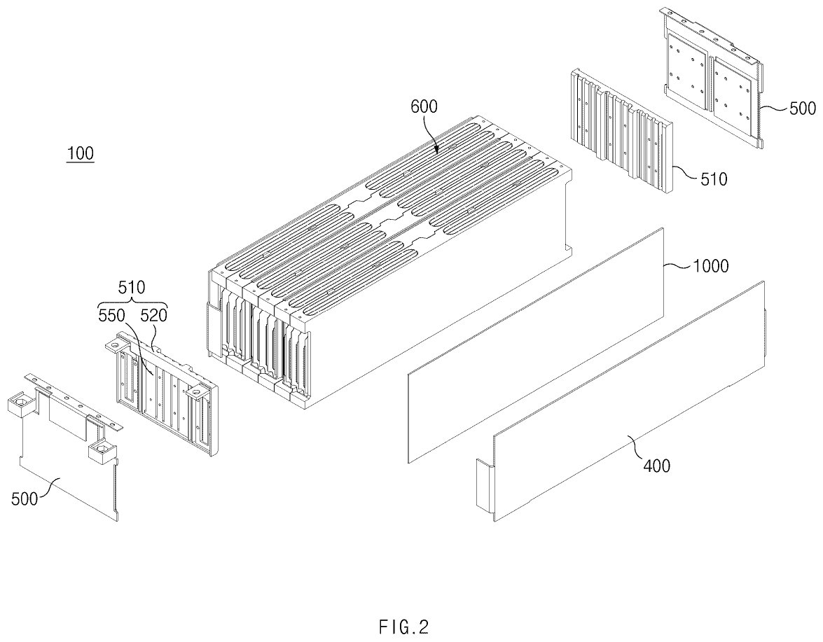

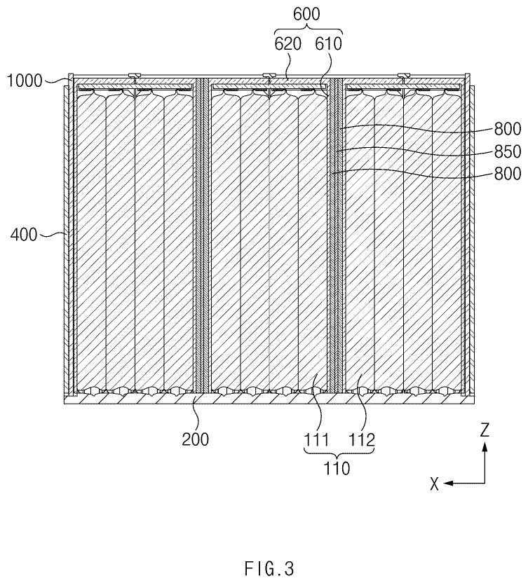

FIG. 1 is a perspective view illustrating a battery cell stack according to an embodiment of the present disclosure. FIG. 2 is an exploded perspective view illustrating a battery cell stack according to an embodiment of the present disclosure. FIG. 3 is a longitudinal cross-sectional view of a battery cell stack according to an embodiment of the present disclosure.

Referring to FIG. 1, FIG. 2, and FIG. 3, a battery cell stack 100 may include battery cells 110, a pair of end plates 400, a pair of sensing covers 500, a pair of sensing assemblies 510, and a partition member 600.

The battery cells 110 may be arranged in the widthwise direction (hereinafter, the X direction or an opposite direction to the X direction). A plurality of battery cells 110 may be provided. Each of the plurality of battery cells 110 may extend in the lengthwise direction (hereinafter, the Y direction or an opposite direction to the Y direction).

Here, the widthwise direction may refer to the X direction or an opposite direction to the X direction, and may refer to a direction, in which the plurality of battery cells 110 are stacked. In addition, the lengthwise direction may refer to the Y direction or an opposite direction to the Y direction, and may refer to a lengthwise direction of the plurality of battery cells 110 or a lengthwise direction of the battery cell stack 100.

A pair of end plates 400 may be disposed on opposite sides of the battery cells 110 in the widthwise direction. A pair of end plates 400 may provide a surface pressure to the battery cells 110 on opposite sides.

A sensing assembly 510 and a sensing cover 500 may be provided on each of opposite sides of the battery cells 110 in the lengthwise direction. The sensing assembly 510 may include a busbar 550 that is electrically connected to the plurality of battery cells 110, and a sensing frame 520 that supports the busbar 550.

The sensing cover 500 may cover an outer side of the sensing assembly 510. The sensing cover 500 may be coupled to the pair of end plates 400.

The partition member 600 may be disposed on one side (the Z direction) of the plurality of battery cells 110 in the height direction to partition at least one of the plurality of battery cells 110. Here, the height direction may refer to the Z direction or an opposite direction to the Z direction. In addition, the height direction may be referred to as an upward/downward direction depending on an installation direction of the battery cell stack 100.

The partition member 600 may be disposed between the pair of battery cells 110, among the plurality of battery cells 110, to partition the pair of battery cells 110. The partition member 600 may accommodate the plurality of battery cells 110 in separate spaces that are partitioned along the widthwise direction.

As illustrated in FIG. 3, the battery cells 110 may include a first battery cell 111 and a second battery cell 112 that are adjacent to each other. Any one of the plurality of partition members 600 may be provided between the pair of battery cells 110 that includes the first battery cell 111 and the second battery cell 112.

The partition member 600 may include a partition body 610 and a cover body 620. The partition body 610 and the cover body 620 may be integrally formed. The plurality of partition members 600 may be provided such that the number thereof is equal to or smaller than the number of the plurality of battery cells 110.

The partition body 610 may be provided between the pair of battery cells 110. The partition body 610 may extend in the height direction.

The cover body 620 may be disposed on one side of each of the pair of battery cells 110 in the height direction. One surface that faces one side of each of the first battery cell 111 and the second battery cell 112 in the height direction may be covered by the cover body 620.

The cover body 620 may extend from an opposite end of the partition body 610 to one side of the widthwise direction, and may cover together opposite surfaces of the first battery cell 111 and the second battery cell 112.

The cover body 620 may cover together the first battery cell 111 and the second battery cell 112 that are partitioned by the partition body 610.

A support member 1000 may be provided between the plurality of battery cells 110 and the pair of end plates 400. The support member 1000 may be disposed between the battery cell 110 located at one end in the widthwise direction, among the plurality of battery cells 110, and the end plate 400, and may cover one side of the battery cell 110 located at one end in the widthwise direction, among the plurality of battery cells 110. The support member 1000 may cover one side of the battery cell 110, which faces the end plate 400.

The end plate 400, the support member 1000, the plurality of battery cells 110, the partition member 600, and the barrier member 800 and the cooling plate 850 to be described later may contact a thermal interface material (TIM) 200.

The battery cell stack 100 according to an embodiment of the present disclosure may not include a base plate for contacting a thermal interface material (TIM) 200. However, the present disclosure is not limited thereto, and the battery cell stack 100 may further include a base plate that covers the thermal interface material (TIM) 200.

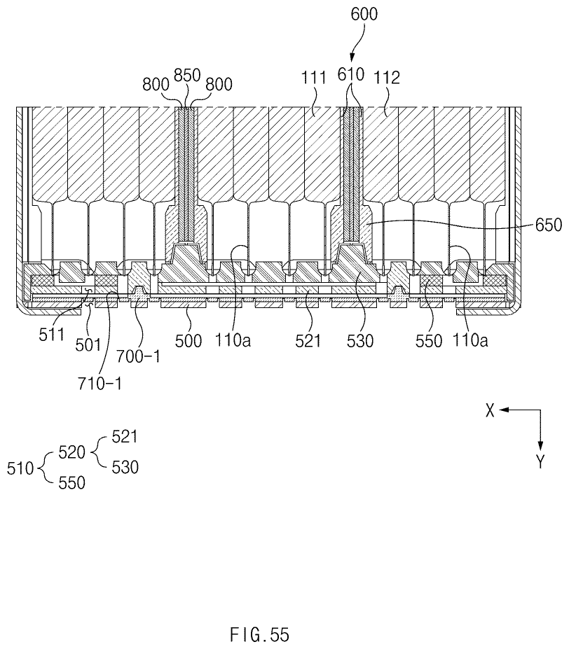

The thermal interface material (TIM) 200 may be provided on an opposite side (an opposite direction to the Z direction) of the end plate 400, the support member 1000, the plurality of battery cells 110, the partition member 600, the barrier member 800, and the cooling plate 850 in the height direction, and it may be a configuration for adhering the battery cell stack 100 to a pack housing 1200 (see FIG. 55), and may be a configuration for transferring heat of the battery cells 110 to the pack housing 1200.

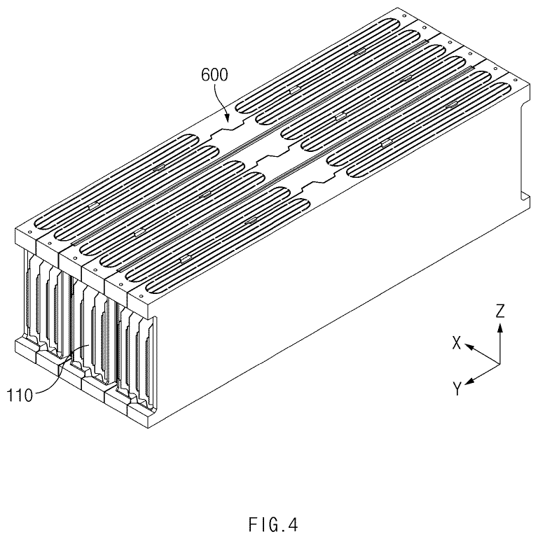

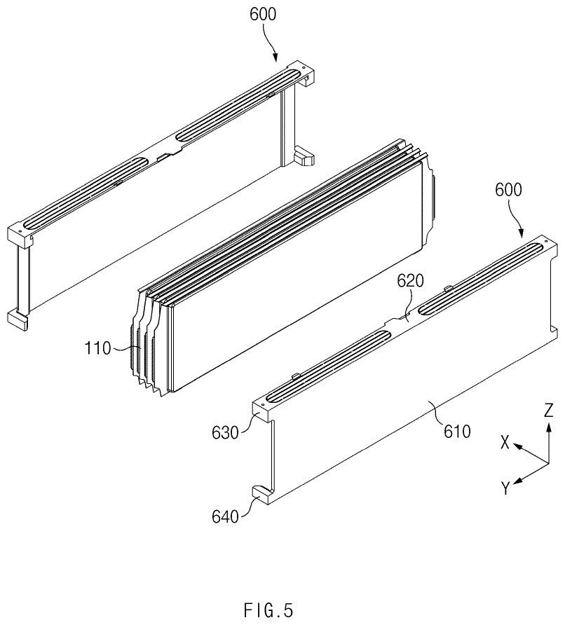

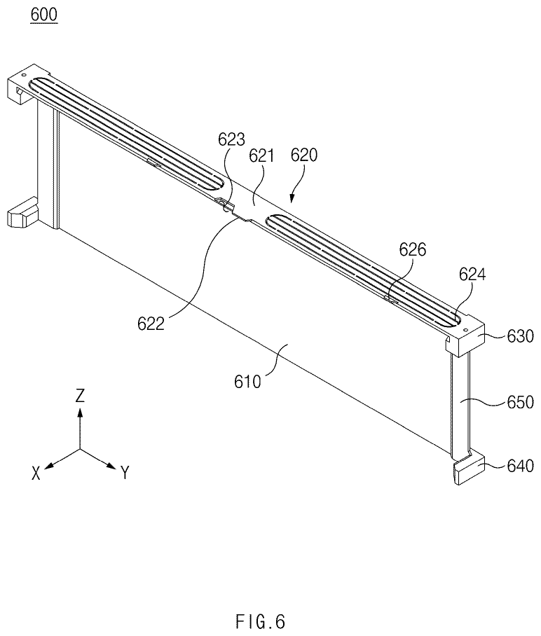

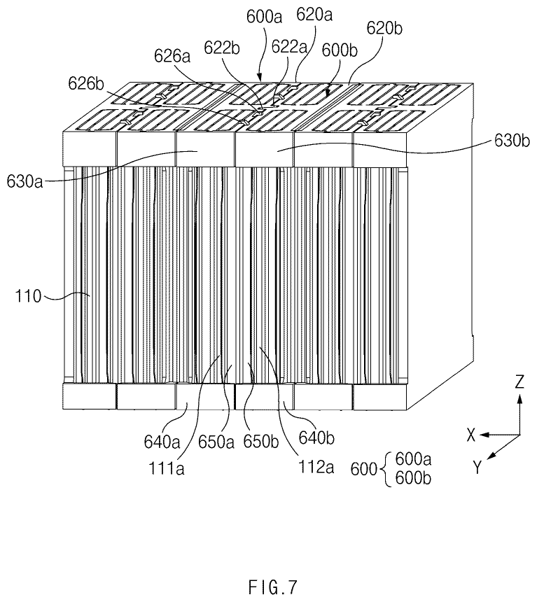

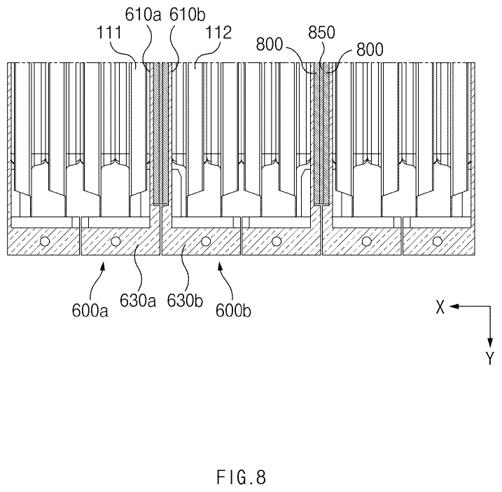

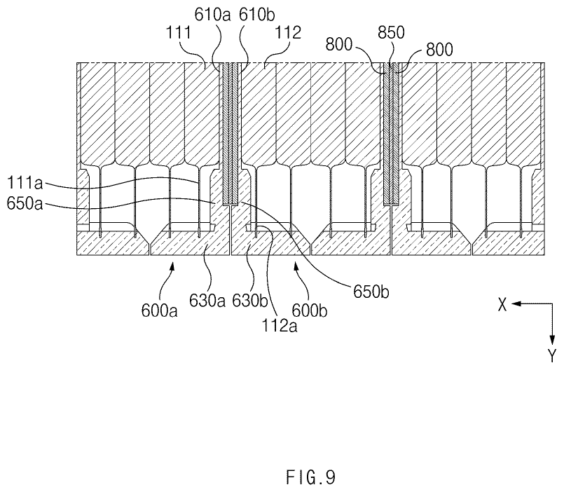

FIG. 4 is a perspective view of battery cells and a partition member of a battery cell stack according to an embodiment of the present disclosure. FIG. 5 is a perspective view of a pair of partition members and a battery cell disposed therebetween according to an embodiment of the present disclosure. FIG. 6 is a perspective view of a partition member viewed from another direction according to an embodiment of the present disclosure. FIG. 7 is a side view of a battery cell and a partition member viewed in a lengthwise direction according to an embodiment of the present disclosure. FIG. 8 is a transverse cross-sectional view of battery cells and a partition member according to an embodiment of the present disclosure. FIG. 9 is a transverse cross-sectional view of battery cells and a partition member according to an embodiment of the present disclosure.

Referring to FIG. 4, FIG. 5, FIG. 6, FIG. 7, FIG. 8, and FIG. 9, the partition member 600 may partition the plurality of battery cells 110 that are stacked in the widthwise direction. A plurality of battery cells 110 may be stacked between a pair of adjacent partition members 600.

FIG. 5 illustrates that four battery cells 110 are stacked between a pair of adjacent partition members 600, but the number of battery cells 110 disposed between the pair of adjacent partition members 600 is not limited thereto.

The partition member 600 may further include an end cover body 630, a guide cover body 640, and a connection body 650, as well as the partition body 610 and the cover body 620.

The partition body 610, the cover body 620, the end cover body 630, the guide cover body 640, and the connection body 650 may be formed integrally although the partition body 610, the cover body 620, the end cover body 630, the guide cover body 640, and the connection body 650 may be used as terms of ‘body’.

The partition body 610 and the cover body 620 may extend along the lengthwise direction of the battery cell 110.

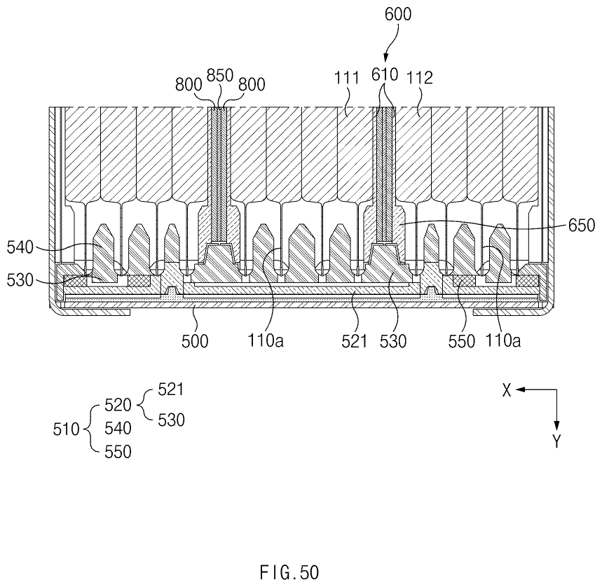

The cover body 620 may include a cover body area 621, a cover protrusion area 622, a cover insertion groove 623, a cover notch part 624, or a cover venting hole 625 (see FIG. 50). The cover body 620 may further a cover rib 626.

The cover protrusion area 622 may be a part that protrudes from the cover body area 621 of any one of a pair of adjacent cover bodies 620 to the other one of the cover bodies 620.

The cover insertion groove 623 may be formed adjacent to the cover protrusion area 622, and may be a portion into which the cover protrusion area 622 of another cover body 620 adjacent to the cover protrusion area 622 may be inserted. The cover protrusion area 622 may be formed in a tapered shape toward a direction away from the cover body area 621, and the cover insertion groove 623 may be formed in a shape corresponding to the cover protrusion area 622 so that the cover protrusion area 622 is inserted.

The cover protrusion area 622 and the cover insertion groove 623 may be portions for a pair of adjacent cover bodies 620 to overlap each other. For example, the cover protrusion area 622 and the cover insertion groove 623 may be located at a middle portion with respect to a longitudinal direction (a direction opposite to the Y direction or the Y direction) of the cover body 620.

The cover notch part 624 may be formed on an area of the cover body area 621, which faces the pair of battery cells 110 partitioned by the partition body 610, and may have a cut shape or have a thickness that is smaller than that of a surrounding area.

The cover venting hole 625 may be formed on an area of the cover body area 621, which faces the pair of battery cells 110 partitioned by the partition body 610, and may be formed to pass in the height direction.

The cover venting hole 625 and the cover notch part 624 are areas for venting foreign substances or high-pressure fluid caused by fire to the outside of the battery cell stack 100 (see FIG. 1) when a fire occurs in the battery cell 110, and may be selected depending on embodiments.

The cover notch part 624 may be formed in a pair so as to be spaced apart from each other with the cover protrusion area 622 and the cover insertion groove 623 interposed therebetween.

The cover rib 626 may be a portion that protrudes from the cover body area 621 toward one side (Z direction) in the height direction of another cover body area 621 adjacent thereto. A plurality of cover ribs 626 may be provided along the longitudinal direction (a direction opposite to the Y direction or the Y direction) of the cover body area 621.

The end cover body 630 may extend from the cover body 620 toward an opposite side (an opposite direction to the Z direction) in the height direction to cover at least a portion of the pair of battery cells 110 on one side of the pair of battery cells 110 in the lengthwise direction.

That is, the cover body 620 may cover one surface that faces one side of the battery cell 110 in the height direction, and the end cover body 630 may cover at least a portion of one surface of the battery cell 110 in the lengthwise direction.

The guide cover body 640 may be disposed parallel to the end cover body 630 to cover at least a portion of the pair of battery cells 110 on one side of the battery cells 110 with respect to the lengthwise direction.

The end cover body 630 and the guide cover body 640 together may cover opposite end areas of the pair of battery cells 110 in the height direction on one side of the pair of battery cells 110 in the lengthwise direction.

The end cover bodies 630 of the pair of adjacent partition members 600 may contact each other, and the guide cover bodies 640 of the pair of adjacent partition members 600 may also contact each other.

The pair of end cover bodies 630 and the pair of guide cover bodies 640 may have structures for preventing foreign substances or high-pressure fluid generated from the battery cell 110, in which a fire occurs, from being introduced through opposite sides of the battery cell 110 in the lengthwise direction.

The connection body 650 may be a part that connects the end cover body 630 and the guide cover body 640, and may extend from the end cover body 630 to the guide cover body 640.

The connection body 650 may connect the end cover body 630 and the guide cover body 640. The connection body 650 may have a thickness that is greater than a thickness of the partition body 610 in the widthwise direction.

In an embodiment of the present disclosure, the connection body 650 of the partition member 600 may protrude from the partition body 610 to one side in the widthwise direction. The connection body 650 may cover one side of the first battery cell 111 in the widthwise direction together.

Like the end cover body 630 and the guide cover body 640, the connection body 650 may also be provided on opposite sides of the partition body 610 in the lengthwise direction.

As illustrated in FIG. 7, the partition member 600 may be disposed between the pair of battery cells 110, among the plurality of battery cells 110, and may partition the pair of battery cells 110.

The partition member 600 may include a first partition member 600a and a second partition member 600b that are adjacent to each other. The first partition member 600a and the second partition member 600b may be formed in structures corresponding to each other. Both the first partition member 600a and the second partition member 600b may have a shape of the partition member 600 shown in FIG. 6.

The first partition member 600a may be disposed between the pair of battery cells 110 partitioned by the partition member 600, and may cover the first battery cell 111 that is any one of the pair of battery cells 110 partitioned by the partition member 600.

The second partition member 600b may be disposed between the second battery cell 112 that is the other one of the pair of battery cells 110 partitioned by the partition member 600 and the first partition member 600a, and may cover the second battery cell 112.

The first partition member 600a and the second partition member 600b may be disposed to be symmetrical to each other in the widthwise direction. The first partition member 600a and the second partition member 600b may constitute one unit, and may be arranged along the widthwise direction.

The first partition member 600a may include a first partition body 610a, a first cover body 620a, a first end cover body 630a, a first guide cover body 640a, and a first connection body 650a.

The second partition member 600b may include a second partition body 610b, a second cover body 620b, a second end cover body 630b, a second guide cover body 640b, and a second connection body 650b.

The first partition body 610a may be disposed between the first battery cell 111 and the second partition member 600b, and may extend in the height direction.

The first cover body 620a may extend from the first partition body 610a to one side (the X direction) in the widthwise direction to cover one surface of the first battery cell 111, which faces one side (the Z direction) in the height direction. The first cover body 620a may extend to one side (the X direction) in the widthwise direction to cover one surface of the first battery cell 111 from one end of the first partition body 610a in the height direction.

The first cover body 620a may include a cover venting hole 625 (see FIG. 50) that is formed in an area that faces the first battery cell 111, or a cover notch part 624 that is formed in an area that faces the first battery cell 111 and has a cut shape or has a thickness that is smaller than that of a surrounding area.

The cover venting hole 625 or the cover notch part 624 may be a part for venting foreign substances or high-pressure fluid caused by fire to the outside of the battery cell stack 100 (see FIG. 1) when a fire occurs in the battery cell 110.

The second partition body 610b may be disposed between the second battery cell 112 and the first partition body 610a, and may extend in the height direction.

The second cover body 620b may extend from the second partition body 610b to an opposite side (an opposite direction to the X direction) in the widthwise direction to cover one surface of the second battery cell 112, which faces one side (the Z direction) in the height direction. The second cover body 620b may extend to an opposite side (an opposite direction to the X direction) in the widthwise direction to cover one surface of the second battery cell 112 from an opposite end of the second partition body 610b.

The second cover body 620b may include a cover venting hole 625 that is formed in an area facing the second battery cell 112, or a cover notch part 624 that is formed in an area facing the second battery cell 112 and has a cut shape or has a thickness that is smaller than that of a surrounding area.

The cover venting hole 625 or the cover notch part 624 may be a part for venting foreign substances or high-pressure fluid caused by fire to the outside of the battery cell stack 100 (see FIG. 1) when a fire occurs in the battery cell 110.

A direction, in which the first cover body 620a extends from the first partition body 610a, and a direction, in which the second cover body 620b extends from the second partition body 610b, may be opposite to each other.

The first cover body 620a may include a first cover body area 621a, a first cover protrusion area 622a, a first cover insertion groove 623, a cover notch part 624, and a first cover rib 626a.

The second cover body 620b may include a second cover body area 621b, a second cover protrusion area 622b, a second cover insertion groove 623, a cover notch part 624, and a second cover rib 626b.

The first cover protrusion area 622a may be inserted into the first cover insertion groove 623 of the second cover body 620b, and the second cover protrusion area 622b may be inserted into the second cover insertion groove 623 of the first cover body 610b. The first cover protrusion area 622a and the second cover protrusion area 622b may extend in a direction opposite to the width direction (a direction opposite to the X direction or the X direction).

The first cover rib 626a may protrude toward one side (Z direction) in the height direction of the second cover body area 621b, and the second cover rib 626b may protrude toward one side (Z direction) in the height direction of the first cover body area 621a.

According to this structure, even when the battery cell 110 is swelled and the first cover body 620a and the second cover body 620b are pressed by the battery cell 110, the first cover body 620a and the second cover body 620b may be prevented from being separated in a width direction (an opposite direction of X direction or X direction) or a height direction (an opposite direction of Z direction or Z direction), and thus a robust isolation structure between the battery cells 110 may be maintained.

Therefore, even if the battery cell 110 is swelled, the isolation structure between the battery cells 110 of the battery cell stack 100 is maintained, thereby maintaining the effect of delaying the thermal transfer between the battery cells 110.

The first end cover body 630a may extend from the first cover body 620a toward an opposite side (an opposite direction to the Z direction) in the height direction to cover at least a portion of the first battery cell 111 on one side of the first battery cell 111 in the lengthwise direction. The first end cover body 630a may protrude from the first cover body 620a toward a first cell lead part 111a on one side of the first battery cell 111 with respect to the lengthwise direction.

The first guide cover body 640a may be disposed parallel to the first end cover body 630a to cover at least a portion of the first battery cell 111 on one side of the first battery cell 111 in the lengthwise direction. The first guide cover body 640a may be connected to the first partition body 610a.

The first end cover body 630a and the first guide cover body 640a together may cover a portion of one side surface of the first battery cell 111 in the lengthwise direction.

The second end cover body 630b may extend from the second cover body 620b toward an opposite side (an opposite direction to the Z direction) in the height direction to cover at least a portion of the second battery cell 112 on one side of the second battery cell 112 in the lengthwise direction. The second end cover body 630b may protrude from the second cover body 620b toward a second cell lead part 112a on one side of the second battery cell 112 in the lengthwise direction.

The second guide cover body 640b may be disposed parallel to the second end cover body 630b to cover at least a portion of the second battery cell 112 on one side of the second battery cell 112 in the lengthwise direction.

The second end cover body 630b and the second guide cover body 640b together may cover a portion of one side surface of the second battery cell 112 in the lengthwise direction.

The first end cover body 630a and the second end cover body 630b may be in contact with each other, and the first guide cover body 640a and the second guide cover body 640b may be in contact with each other.

The first end cover body 630a and the second end cover body 630b may overlap each other, and the first guide cover body 640a and the second guide cover body 640b may overlap each other.

As will be described below, the first end cover body 630a and the second end cover body 630b may be coupled to each other, and the first guide cover body 640a and the second guide cover body 640b may be coupled to each other.

A thickness of the first end cover body 630a in a height direction and a thickness of the first guide cover body 640a in a height direction may be thicker than a thickness of the first cover body 620a in a height direction, and a thickness of the second end cover body 630b in a height direction and a thickness of the second guide cover body 640b in a height direction may be thicker than a thickness of the second cover body 620b.

According to this structure, the first partition body 610a and the second partition body 610b may isolate the first battery cell 111 from the second battery cell 111, the first cover body 620a may cover one side (Z direction) in the height direction of the first battery cell 111, and the second cover body 620b may cover one side (Z direction) in the height direction of the second battery cell 112.

Furthermore, according to the structure of the first end cover body 630a, the second end cover body 630b, the first guide cover body 640a, and the second guide cover body 640b, even if pressure is applied to the first end cover body 630a, the second end cover body 630b, and the first guide cover body 640a and the second guide cover body 640b due to swelling in the battery cell 110, the relative positions of the first end cover body 630a, the second end cover body 630b, and the partition member 600 may not be changed and the partition member 600 may not be deformed.

Thus, the first end cover body 630a, the second end cover body 630b, and the first guide cover body 640a and the second guide cover body 640b may not be deformed even when subjected to pressure, and an isolation structure between the battery cells 110 may be firmly maintained. Therefore, even if a fire occurs in the battery cells 110, an isolated structure of a plurality of battery cells 110 may be maintained, and a thermoelectric transition between the battery cells 110 may be delayed.

The first connection body 650a may have a thickness that is greater than a thickness of the first partition body 610a in the widthwise direction. The first connection body 650a may extend in the height direction from the first end cover body 630a to the first guide cover body 640a.

The second connection body 650b may have a thickness that is greater than a thickness of the second partition body 610b with respect to the widthwise direction. The second connection body 650b may extend in the height direction from the second end cover body 630b to the second guide cover body 640b.

As an example, the first battery cell 111 may include a first cell lead part 111a that extends toward opposite sides of the battery cell stack 100 (see FIG. 1) in the lengthwise direction, and the second battery cell 112 may include a second cell lead part 112a that extends toward opposite sides of the battery cell stack 100 in the lengthwise direction.

The first connection body 650a and the second connection body 650b may be disposed between the first cell lead part 111a and the second cell lead part 112a.

The first connection body 650a may further protrude from the first partition body 610a toward the first cell lead part 111a of the first battery cell 111, and may be spaced apart from the first cell lead part 111a.

The second connection body 650b may further protrude from the second partition body 610b toward the second cell lead part 112a of the second battery cell 112, and may be spaced apart from the second cell lead part 112a.

The first connection body 650a may cover an area except for an area provided with the first cell lead part 111a on one side of the first battery cell 111 in the lengthwise direction, together with the first end cover body 630a and the first guide cover body 640a.

The second connection body 650b may cover an area except for an area provided with the second cell lead part 112a on one side of the second battery cell 112 in the lengthwise direction, together with the second end cover body 630b and the second guide cover body 640b.

The first connection body 650a may be disposed on one side (Y-direction) of the first battery cell 111 in the longitudinal direction, and the thickness of the first connection body 650a in the width direction may be greater than the thickness of the first partition wall body 610a in the width direction. The second connection body 650b may be disposed on one side (Y-direction) of the second battery cell 112 in the longitudinal direction, and the thickness of the second connection body 650b in the width direction may be greater than the thickness of the second partition wall body 610b in the width direction.

Even in the structure of the first connection body 650a and the second connection body 650b, even if swelling occurs in the battery cell 110 and pressure is applied to the first connection body 650a and the second connection body 650b, the relative positions of the first connection body 650a and the second connection body 650b may not be changed and the partition member 600 may not be deformed, thereby having a robust isolation structure. Therefore, even if a fire occurs in the battery cell 110, an isolated structure of the battery cell 110 may be maintained, and heat transfer between the battery cells 110 may be delayed.

In an aspect of the battery cell 110, opposite sides of the battery cell 110 in the height direction may be covered by the thermal interface material 210 and the cover body 620, one surface of the battery cell 110 in the widthwise direction may be covered by the partition body 610, and a portion of circumferences of opposite surfaces of the battery cell 110 in the lengthwise direction may be covered by the end cover body 630, the guide cover body 640, and the connection body 650.

With the structure, even when a fire occurs in any one of the plurality of battery cells 110, the partition member 600 according to an embodiment of the present disclosure may delay transfer of heat to another battery cell 110, in which a fire does not occur, due to the configuration of the partition body 610.

Furthermore, the partition member 600 according to an embodiment of the present disclosure may cover at least a portion of opposite sides of the plurality of battery cells 110 in the lengthwise direction. Accordingly, even when a fire occurs in any one of the plurality of battery cells 110, it is possible to prevent foreign substances or high-pressure fluid from being introduced through one side of another battery cell 110, in which a fire does not occur, in the lengthwise direction.

Furthermore, when a fire occurs in any one of the plurality of battery cells 110, foreign substances or high-pressure fluid caused by the fire may be guided when being vented to the outside of the battery cell stack 100 through the cover venting hole 625 or the cover notch part 624, and may be prevented from being introduced to another adjacent battery cell 110.

Furthermore, even if swelling occurs in the battery cell 110, the position of the cover end body 630, the guide end body 640, and the connection body 650 may be prevented from being changed or deformed, so a solid isolation structure between the plurality of the battery cells 110 may be provided, and a thermal transfer between the plurality of the battery cells 110 may be delayed.

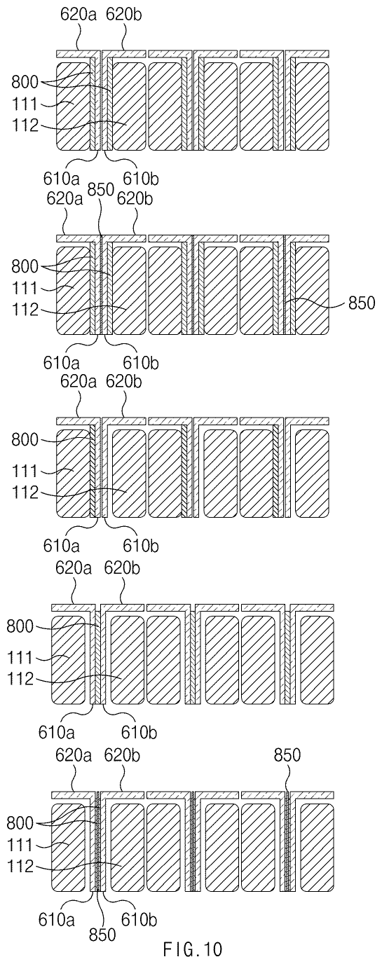

FIG. 10 is a longitudinal cross-sectional view of a partition member, battery cells, a barrier member, and a cooling plate according to an embodiment of the present disclosure.

Referring to FIG. 10, the partition member 600 may include a first partition member 600a that covers the first battery cell 111, and a second partition member 600b that is provided parallel to the first partition member 600a while covering the second battery cell 112.

According to an embodiment of the present disclosure, the barrier member 800 that is disposed between at least one of the first partition member 600a and the second partition member 600b, and at least one of the first battery cell 111 and the second battery cell 112 may be disposed.

As an example, the barrier member 800 may be disposed between the first battery cell 111 and the first partition body 610a of the first partition member 600a, and between the second battery cell 112 and the second partition body 610b of the second partition member 600b.

As an example, the barrier member 800 may be disposed between the first battery cell 111 and the first partition body 610a of the first partition member 600a, and between the second battery cell 112 and the second partition body 610b of the second partition member 600b, and a cooling plate 850 may be disposed between the first partition body 610a and the second partition body 610b.

As an example, the barrier member 800 may be disposed only between the first battery cell 111 and the first partition body 610a of the first partition member 600a, and may not be disposed between the second battery cell 112 and the second partition body 610b of the second partition member 600b.

As an example, the barrier member 800 may be disposed between the first partition body 610a of the first partition member 600a and the second partition body 610b of the second partition member 600b.

As an example, the barrier member 800 may be disposed between the first partition member 600a and the second partition member 600b. A pair of barrier members 800 may be provided, and the pair of barrier members 800 may contact the first partition member 600a and the second partition member 600b, respectively, and a cooling plate 850 may be disposed between the pair of barrier members 800.

According to an embodiment, the barrier member 800 that contacts i) at least one of the first battery cell 111 and the second battery cell 112 partitioned by the partition member 600, or ii) at least one of the first partition member 600a and the second partition member 600b may be used together with the partition member 600.

The barrier member 800 may be formed of a material having heat insulation or fire resistance, or a material having thermal conductivity.

Furthermore, according to an embodiment of the present disclosure, a cooling plate 850 that is disposed between the first partition member 600a and the second partition member 600b, or between a pair of adjacent barrier members 800 may be used together with the partition member 600.

The cooling plate 850 may be disposed between the first partition member 600a and the second partition member 600b to cool the first partition member 600a and the second partition member 600b. The cooling plate 850 may also be disposed between a pair of barrier members 800 that are disposed between the first partition member 600a and the second partition member 600b.

The cooling plate 850 may be formed of a material having thermal conductivity. The cooling plate 850 may be formed of a material having heat dissipation properties. As an example, the cooling plate 850 may be formed of aluminum.

The barrier member 800 or the cooling plate 850 may receive heat from the partition member 600 or the battery cell 110 in contact and exchange heat with a cooling channel formed inside the pack housing 1200 through the thermal interface material 200. Here, the cooling channel may refer to a passage for cooling water to flow.

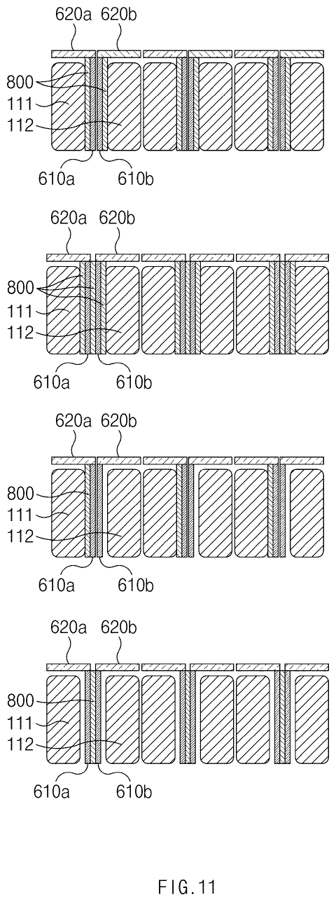

FIG. 11 is a longitudinal cross-sectional view of a partition member, battery cells, a barrier member, and a cooling plate according to an embodiment of the present disclosure.

Referring to FIG. 11, according to an embodiment of the present disclosure, the partition member 600 may include a first partition member 600a that covers the first battery cell 111, and a second partition member 600b that is provided parallel to the first partition member 600a while covering the second battery cell 112.

FIG. 11 illustrates a structure, in which the first partition body 610a and the second partition body 610b are formed of a material having thermal conductivity.

As such, the first partition body 610a and the second partition body 610b are formed of a material having thermal conductivity, and the partition member 600 may perform a function of the cooling plate 850 illustrated in FIG. 10.

Even with the structure, according to an embodiment of the present disclosure, the barrier member 800 that contacts i) at least one of the first partition member 600a and the second partition member 600b, and ii) at least one of the first battery cell 111 and the second battery cell 112 partitioned by the partition member 600 may be applied.

As an example, the barrier member 800 may be disposed between the first battery cell 111 and the first partition body 610a of the first partition member 600a, and between the second battery cell 112 and the second partition body 610b of the second partition member 600b.

As an example, the barrier member 800 may be disposed between the first battery cell 111 and the first partition body 610a of the first partition member 600a, between the second battery cell 112 and the second partition body 610b of the second partition member 600b, and between the first partition body 610a and the second partition body 610b.

As an example, the barrier member 800 may be disposed only between the first battery cell 111 and the first partition body 610a of the first partition member 600a, and may not be disposed between the second battery cell 112 and the second partition body 610b of the second partition member 600b.

As an example, the barrier member 800 may be disposed between the first partition body 610a of the first partition member 600a and the second partition body 610b of the second partition member 600b.

According to an embodiment of the present disclosure, the partition member 600 may have a partition body 610 that is formed of a material having thermal conductivity, and the barrier member 800 that contacts i) at least one of the pair of battery cells 110 partitioned by the partition member 600, or ii) at least one of the first partition member 600a and the second partition member 600b, may be used together with the partition member 600.

The barrier member 800 may be formed of a material having heat insulation or fire resistance, or a material having thermal conductivity.

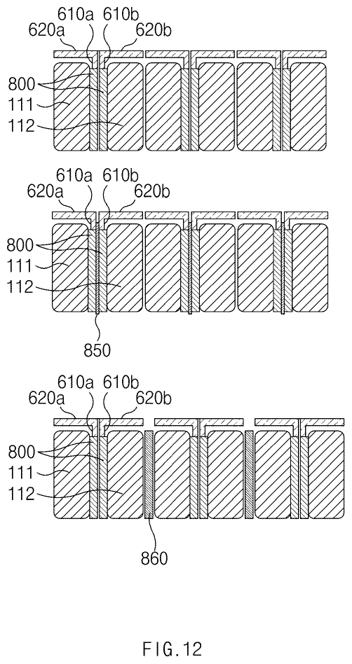

FIG. 12 is a longitudinal cross-sectional view of a partition member, battery cells, a barrier member, and a cooling plate according to an embodiment of the present disclosure.

Referring to FIG. 12, according to an embodiment of the present disclosure, the partition member 600 may include a first partition member 600a that covers the first battery cell 111, and a second partition member 600b that is provided parallel to the first partition member 600a while covering the second battery cell 112.

FIG. 12 illustrates a structure, in which at least a portion of the first partition body 610a and at least a portion of the second partition body 610b are replaced with the barrier member 800 formed of a material having heat insulation or fire resistance, or a material having thermal conductivity.

In this way, the first partition body 610a and the second partition body 610b may be formed of a material having heat insulation or fire resistance, or a material having thermal conductivity, and the barrier member 800 may perform a role of the partition body 610 together.

As an example, the barrier member 800 that is integrally formed with or coupled to the first partition member 600a may contact the first battery cell 111, and the barrier member 800 that is integrally formed with or coupled to the second partition member 600b may contact the second battery cell 112.

As an example, the barrier member 800 that is integrally formed with or coupled to the first partition member 600a may contact the first battery cell 111, and the barrier member 800 that is integrally formed with or coupled to the second partition member 600b may contact the second battery cell 112, and a cooling plate 850 may be disposed between the pair of adjacent barrier members 800.

As an example, the barrier member 800 that is integrally formed with or coupled to the first partition member 600a may contact the first battery cell 111, and the barrier member 800 that is integrally formed with or coupled to the second partition member 600b may contact the second battery cell 112, and a surface-pressure member 860 may be disposed between the pair of battery

cells 110 that do not contact the barrier member 800.

According to an embodiment of the present disclosure, the partition body 610 may be formed of a material having heat insulation or fire resistance, or a material having thermal conductivity, and the barrier member 800 that contacts i) at least one of the pair of battery cells 110 partitioned by the partition member 600 may be used together.

The barrier member 800 may be formed of a material having heat insulation or fire resistance, or a material having thermal conductivity.

Furthermore, according to an embodiment of the present disclosure, a cooling plate 850 that is disposed between a pair of adjacent barrier members 800 may be used together with the partition member 600.

The cooling plate 850 may be formed of a material having thermal conductivity. The cooling plate 850 may be formed of a material having heat dissipation properties. As an example, the cooling plate 850 may be formed of aluminum.

Furthermore, according to an embodiment of the present disclosure, a surface-pressure member 860 that is disposed while not contacting the barrier member 800 between the pair of battery cells 110 may be used together with the partition member 600.

As described above, the arrangement of the barrier member 800, the cooling plate 850, or the surface-pressure member 860 as illustrated in FIG. 10, FIG. 11, and FIG. 12 may be selectively used.

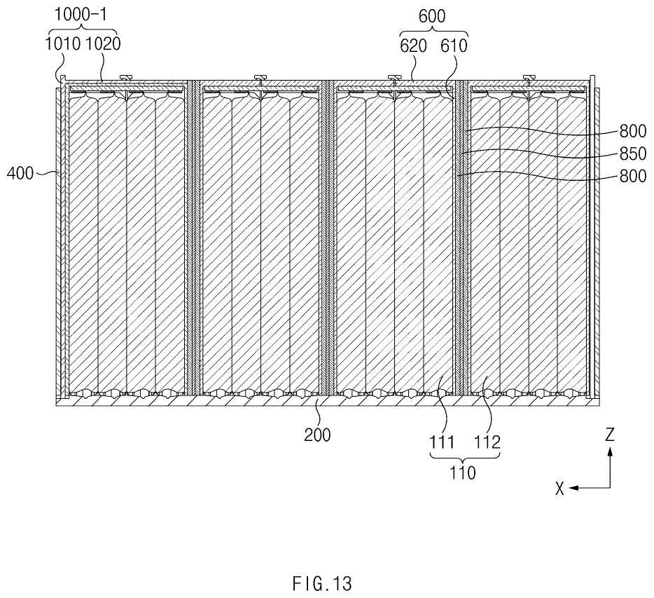

FIG. 13 is a longitudinal cross-sectional view of a battery cell stack for illustrating a support member according to another embodiment of the present disclosure.

FIG. 13 is a longitudinal cross-sectional view of a battery cell stack according to another embodiment of the present disclosure.

Referring to FIG. 13, the battery cell stack 100 (see FIG. 1) may include a plurality of battery cells 110 that are stacked in the widthwise direction, and a support member 1000-1 that is disposed between, among the plurality of battery cells 110, the battery cell 110 located at one end in the widthwise direction and the end plate 400.

The support member 1000-1 may have a shape that is different from a shape of the support member 1000 illustrated in FIG. 3. As an example, the support member 1000-1 may include a support partition body 1010 and a support cover body 1020, unlike the support member 1000 that has only the support partition body 1010.

The support member 1000 illustrated in FIG. 3 and the support member 1000-1 illustrated in FIG. 13 may both be disposed parallel to the first cover body 620a or the second cover body 620b. Furthermore, the support member 1000 and the support member 1000-1 may both cover one side of the battery cell 110 located at one end with respect to the widthwise direction, among the plurality of battery cells 110.

The support partition body 1010 may be disposed between the battery cell 110 located at one end in the widthwise direction, among the plurality of battery cells 110, and the end plate 400. The support partition body 1010 may extend in the height direction.

The support cover body 1020 may extend from the support partition body 1010 toward the cover body 620. The support partition body 1010 and the support cover body 1020 may be formed integrally.

The support partition body 1010 may cover one surface of, among the plurality of battery cells 110, the battery cell 110 located at one end in the widthwise direction, which faces the widthwise direction.

The support cover body 1020 may be disposed parallel to the cover body 620, and may cover one surface of, among the plurality of battery cells 110, the battery cell 110 located at one end in the widthwise direction, which faces one side (the Z direction) of the battery cell 110 in the height direction. The support partition body 1010 and the support cover body 1020 may be formed in an “L” shape.

The support member 1000 illustrated in FIG. 3 and the support member 1000-1 illustrated in FIG. 13 may be appropriately used depending on the number of battery cells 110.

As an example, the support member 1000 may be used when, among the plurality of battery cells 110, the battery cell 110 located at one end in the widthwise direction is covered by the partition member 600, and the support member 1000-1 may be used when, among the plurality of battery cells 110, the battery cell 110 located at one end in the widthwise direction is not covered by the partition member 600.

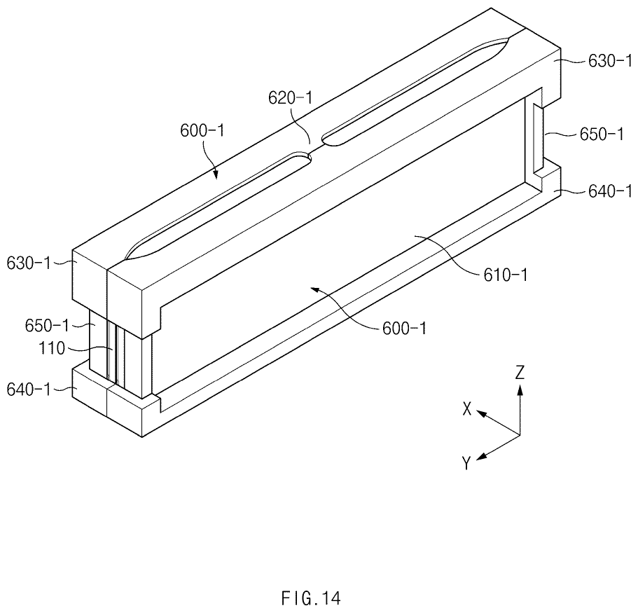

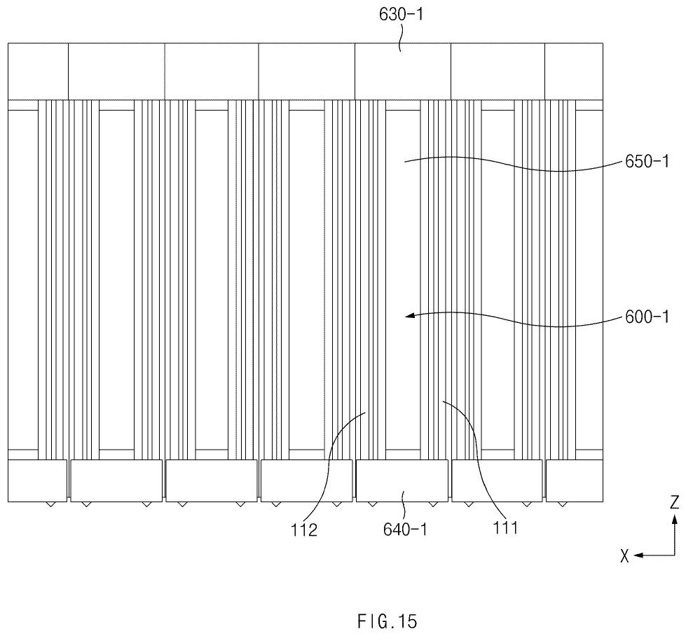

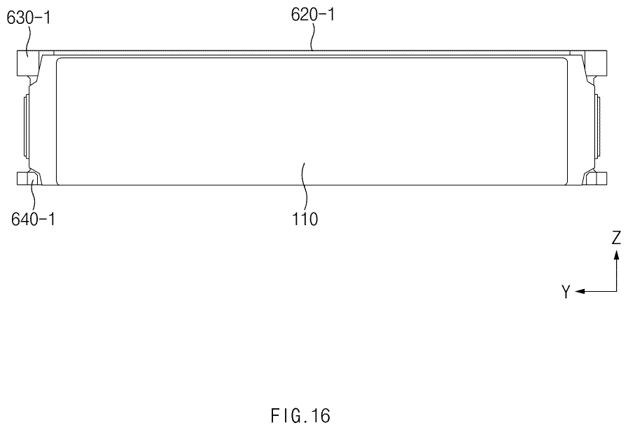

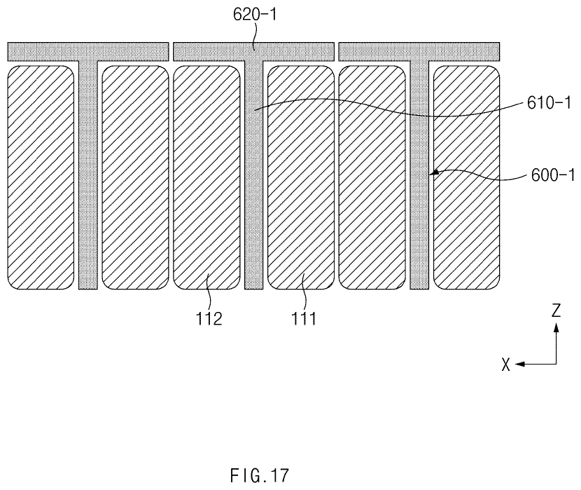

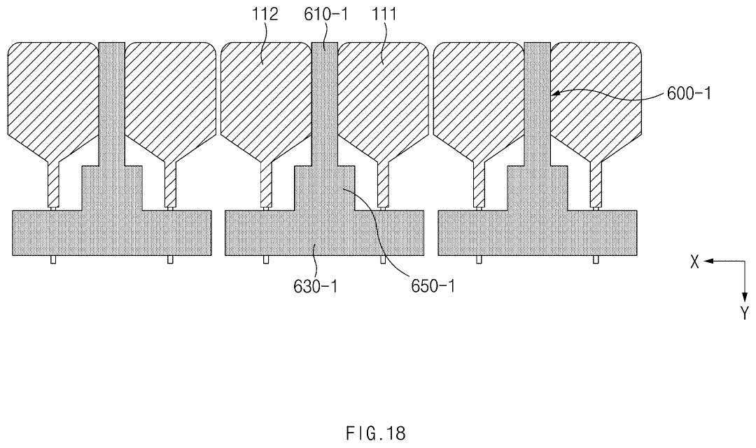

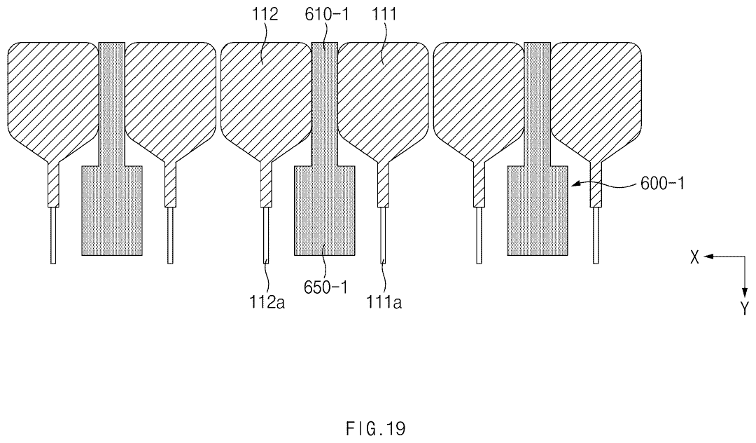

FIG. 14 is a perspective view of a pair of partition members and a battery cell disposed therebetween according to another embodiment of the present disclosure. FIG. 15 is a front view of a partition member and battery cells viewed in a lengthwise direction according to another embodiment of the present disclosure. FIG. 16 is a side view of a partition member and battery cells viewed in a widthwise direction according to another embodiment of the present disclosure. FIG. 17 is a longitudinal cross-sectional view of a partition member and battery cells according to another embodiment of the present disclosure. FIG. 18 is a transverse cross-sectional view of a partition member and battery cells according to another embodiment of the present disclosure. FIG. 19 is a transverse cross-sectional view of a partition member and battery cells according to another embodiment of the present disclosure.

Referring to FIG. 14, FIG. 15, FIG. 16, FIG. 17, FIG. 18 and FIG. 19, the plurality of battery cells 110 may be arranged in the widthwise direction.

A partition member 600-1 may partition the plurality of battery cells 110 that are stacked in the widthwise direction. The partition member 600-1 may accommodate the plurality of battery cells 110 in separate spaces that are partitioned along the widthwise direction.

The partition member 600-1 may be disposed between the pair of battery cells 110, among the plurality of battery cells 110, to partition the pair of battery cells 110. A plurality of battery cells 110 may be stacked between a pair of adjacent partition members 600.

FIG. 14 illustrates that two battery cells 110 are stacked between a pair of adjacent partition members 600-1, but the number of battery cells 110 disposed between the pair of adjacent partition members 600-1 is not limited thereto.

The partition member 600-1 may further include a partition body 610-1, a cover body 620-1, an end cover body 630-1, a guide cover body 640-1, and a connection body 650-1.

The partition body 610-1, the cover body 620-1, the end cover body 630-1, the guide cover body 640-1, and the connection body 650-1 may be formed integrally.

The partition body 610-1 and the cover body 620-1 may extend along the lengthwise direction of the battery cell 110.

The partition body 610-1 may be provided between the pair of battery cells 110 that are partitioned by the partition member 600-1, and may extend in the height direction.

The cover body 620-1 may extend from the partition body 610-1 to opposite sides in the widthwise direction to cover together surfaces of the pair of battery cells 110, which face one side (the Z direction) in the height direction. The cover body 620-1 may extend from an opposite end of the partition body 610-1 to opposite sides in the widthwise direction, and may cover surfaces of the pair of battery cells 110 together.

The cover body 620-1 may include a cover venting hole 625 (see FIG. 50) that is formed on an area that faces the pair of battery cells 110 partitioned by the partition body 610, or a cover notch part 624 (see FIG. 6) that is formed on an area that faces the pair of battery cells 110 partitioned by the partition body 610 and has a cut shape or a thickness that is smaller than that of a surrounding area.

The cover venting hole 625 or the cover notch part 624 may be a hole for venting foreign substances or high-pressure fluid caused by fire to the outside of the battery cell stack 100 (see FIG. 1) when a fire occurs in the battery cell 110.

The end cover body 630-1 may extend from the cover body 620-1 toward an opposite side (an opposite direction to the Z direction) in the height direction to cover at least a portion of the pair of battery cells 110 on one side of the pair of battery cells 110 in the lengthwise direction.

That is, the cover body 620-1 may cover an opposite surface of the battery cell 110 in the height direction, and the end cover body 630-1 may cover at least a portion of one surface of the battery cell 110 in the lengthwise direction.

The guide cover body 640-1 may be disposed parallel to the end cover body 630 to cover at least a portion of the pair of battery cells 110 on one side of the battery cells 110 in the lengthwise direction.

The end cover body 630-1 and the guide cover body 640-1 together may cover opposite end areas of the pair of battery cells 110 in the height direction on one side of the pair of battery cells 110 in the lengthwise direction.

An end cover bodies 630-1 of the pair of adjacent partition members 600-1 may overlap each other, and a guide cover bodies 640-1 of the pair of adjacent partition members 600-1 may also overlap each other.

The pair of end cover bodies 630-1 and the pair of guide cover bodies 640-1 may have structures for preventing foreign substances or high-pressure fluid generated from the battery cell 110, in which a fire occurs, from being introduced through one side of the battery cell 110 in the lengthwise direction.

A thickness of the end cover body 630-1 in the height direction and a thickness of the guide cover body 640-1 in the height direction may be thicker than a thickness of the cover body 620-1 in the height direction.

According to the structure of the pair of end cover bodies 630-1 and the pair of guide cover bodies 640-1, even if pressure is applied to the pair of end cover bodies 630-1 and the pair of guide cover bodies 640-1 due to swelling in the battery cell 110, the relative positions of the pair of end cover bodies 630-1 and the pair of guide cover bodies 640-1 may not be changed and the partition

### Member 600-1 May Not Be Deformed.

As such, the pair of end cover bodies 630-1 and the pair of guide cover bodies 640-1 may not be deformed even when subjected to pressure, and an isolation structure between the battery cells 110 may be firmly maintained. Therefore, even if a fire occurs in the battery cells 110, an isolation structure of the battery cells 110 may be maintained, and a thermoelectric transition between the battery cells 110 may be delayed.

The connection body 650-1 may be a part that connects the end cover body 630-1 and the guide cover body 640-1, and may extend from the end cover body 630-1 to the guide cover body 640-1. The connection body 650-1 may have a thickness that is greater than a thickness of the partition body 610-1 in the widthwise direction.

In another embodiment of the present disclosure, the connection body 650-1 of the partition member 600-1 may protrude from the partition body 610-1 to opposite sides in the widthwise direction. The connection body 650-1 may protrude from the partition body 610-1 toward the pair of battery cells 110 that are partitioned by the partition member 600-1.

According to the structure of the connection body 650-1, even if swelling occurs in the battery cell 110 and pressure is applied to the connection body 650-1, the relative position of the pair of connection bodies 650-1 may not be changed and the division member 600 may not be deformed, thereby having a robust isolation structure. Therefore, even if a fire occurs in the battery cell 110, an isolated structure of the plurality of battery cells 110 may be maintained, and a thermoelectric transition between the battery cells 110 may be delayed.

The battery cells 110 may include a first battery cell 111 and a second battery cell 112 that are adjacent to each other. In this case, a partition member 600-1 of any one of the plurality of partition members 600-1 may be defined as a configuration that is provided between the pair of battery cells 110 including a first battery cell 111 and a second battery cell 112.

According to another embodiment of the present disclosure, the connection body 650-1 of the partition member 600-1 may protrude from the partition body 610-1 to opposite sides in the widthwise direction to cover together sides of the first battery cell 111 and the second battery cell 112 in the lengthwise direction.

The first battery cell 111 may include a first cell lead part 111a that extends toward opposite sides of the battery cell stack 100 (see FIG. 1) in the lengthwise direction, and the second battery cell 112 may include a second cell lead part 112a that extends toward opposite sides of the battery cell stack 100 in the lengthwise direction.

The connection body 650-1 may protrude from the partition body 610-1 toward a first cell lead part 111a and a second cell lead part 112a. The connection body 650-1 may be spaced apart from the first cell lead part 111a and the second cell lead part 112a.

The connection body 650-1 may also be provided on opposite sides of the partition body 610-1 with respect to the lengthwise direction.

As illustrated in FIG. 18 and FIG. 19, the connection body 650-1 may cover a part of opposite surfaces of the first battery cell 111 in the lengthwise direction, except for an area, in which the first cell lead part 111a is provided, and a part of opposite surfaces of the second battery cell 112 in the lengthwise direction, except for an area, in which the second cell lead part 112a is provided, together with the end cover body 630-1 and the guide cover body 640-1.

The connection body 650-1 may be spaced apart from both the first cell lead part 111a and the second cell lead part 112a. With the structure, the connection body 650-1 may cover a part of opposite surfaces of the battery cell 110 in the lengthwise direction, except for the first and second cell lead parts 111a and 112a, while connecting the cell lead parts 111a and 112a to the sensing assembly 510.

In an aspect of the battery cell 110, opposite surfaces of the battery cell 110 in the height direction may be covered by the thermal interface material 210 (see FIG. 3) and the cover body 620-1, one surface of the battery cell 110 in the widthwise direction may be covered by the partition body 610-1, and circumferential portions of opposite surfaces of the battery cell 110 in the lengthwise direction may be covered by the end cover body 630-1, the guide cover body 640-1, and the connection body 650-1.

With the structure, even when a fire occurs in any one of the plurality of battery cells 110, the partition member 600-1 according to another embodiment of the present disclosure may delay transfer of heat to another battery cell 110, in which a fire does not occur, due to the configuration of the partition body 610-1.

Furthermore, the partition member 600-1 according to another embodiment of the present disclosure may cover at least a portion of opposite sides of the plurality of battery cells 110 in the lengthwise direction. Accordingly, even when a fire occurs in any one of the plurality of battery cells 110, it is possible to prevent foreign substances or high-pressure fluid from being introduced into the battery cell 110 through an area, except for the cell lead parts 111a and 112a, on one side of another battery cell 110 in the lengthwise direction, in which a fire does not occur.

Furthermore, when a fire occurs in any one of the plurality of battery cells 110, foreign substances or high-pressure fluid caused by the fire may be guided when being vented to the outside of the battery cell stack 100 through the cover venting hole 625 or the cover notch part 624, and may be prevented from being introduced to another adjacent battery cell 110.

Furthermore, even if swelling occurs in the battery cell 110, the positions of the cover end body 630-1, the guide end body 640-1, and the connection body 650-1 may be prevented from being changed or the cover end body 630-1, the guide end body 640-1, and the connection body 650-1 may not be deformed, so that even if a fire occurs in the battery cell 110, a solid isolation structure between multiple battery cells 110 may be maintained, and a heat transfer between multiple battery cells 110 may be delayed.

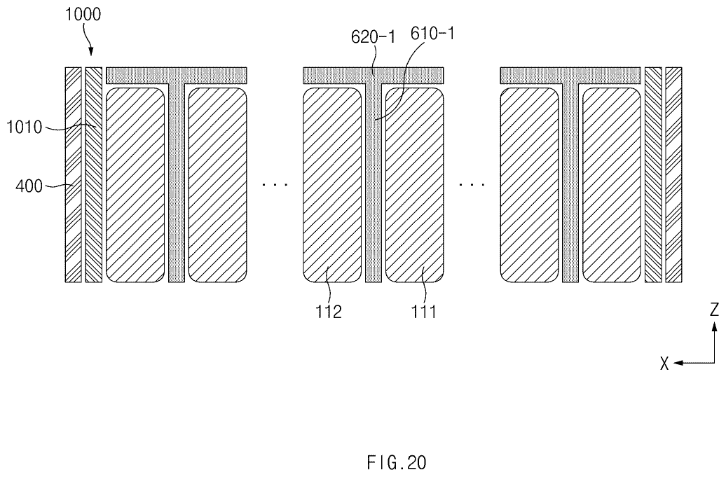

FIG. 20 is a longitudinal cross-sectional view of a partition member, a support member, battery cells, and an end plate according to another embodiment of the present disclosure.

According to another embodiment of the present disclosure, the battery cell stack 100 may include end plates 400 that are disposed on opposite sides of the plurality of battery cells 110 in the widthwise direction, and support members 1000 that are disposed between the battery cells 110 located at opposite ends in the widthwise direction and the end plates 400.

The support member 1000 may cover one side of the battery cell 110 located at one end in the widthwise direction, among the plurality of battery cells 110. The support member 1000 may be a configuration having only the support partition body 1010.

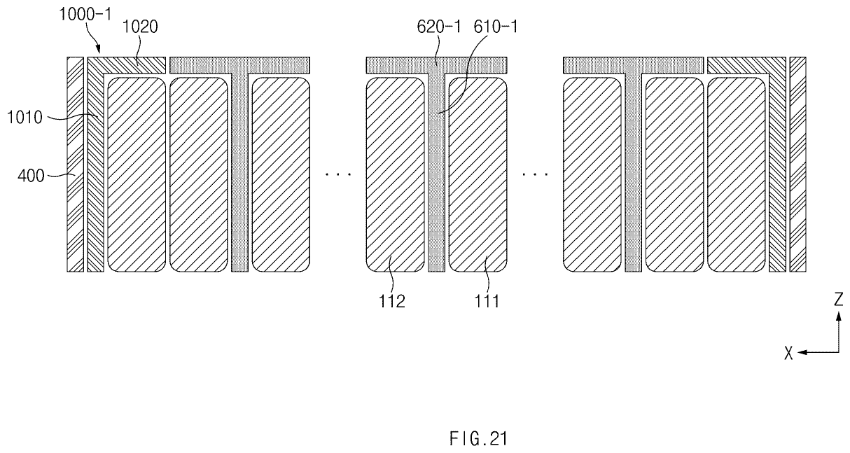

FIG. 21 is a longitudinal cross-sectional view of a partition member, a support member, battery cells, and an end plate for illustrating a support member according to another embodiment different from FIG. 20 of the present disclosure.

Referring to FIG. 21, the support member 1000-1 of FIG. 21 may have a shape that is different from that of the support member 1000 of FIG. 20.

As an example, the support member 1000-1 may include the support partition body 1010 and a support cover body 1020, unlike the support member 1000 that has only the support partition body 1010.

Both the support member 1000 and the support member 1000-1 may be disposed parallel to the cover body 620-1. Furthermore, the support member 1000 and the support member 1000-1 may both cover one side of the battery cell 110 located at one end with respect to the widthwise direction, among the plurality of battery cells 110.

The support partition body 1010 may be disposed between the battery cell 110 located at one end in the widthwise direction, among the plurality of battery cells 110, and the end plate 400. The support partition body 1010 may extend in the height direction.

The support cover body 1020 may extend from the support partition body 1010 toward the cover body 620-1. The support partition body 1010 and the support cover body 1020 may be formed integrally.

The support partition body 1010 may cover one surface of the battery cell 110 located at one end in the widthwise direction, among the plurality of battery cells 110, which faces one side in the widthwise direction.

The support cover body 1020 may be disposed parallel to the cover body 620-1, and may cover one surface of the battery cell 110 located at one end in the widthwise direction, among the plurality of battery cells 110, which faces one side in the height direction. The support partition body 1010 and the support cover body 1020 may be formed in an “L” shape.

The support member 1000 illustrated in FIG. 20 and the support member 1000-1 illustrated in FIG. 21 may be appropriately used depending on the number of battery cells 110.

As an example, the support member 1000 may be used when, among the plurality of battery cells 110, the battery cell 110 located at one end in the widthwise direction is covered by the partition member 600, and the support member 1000-1 may be used when, among the plurality of battery cells 110, the battery cell 110 located at one end in the widthwise direction is not covered by the partition member 600.

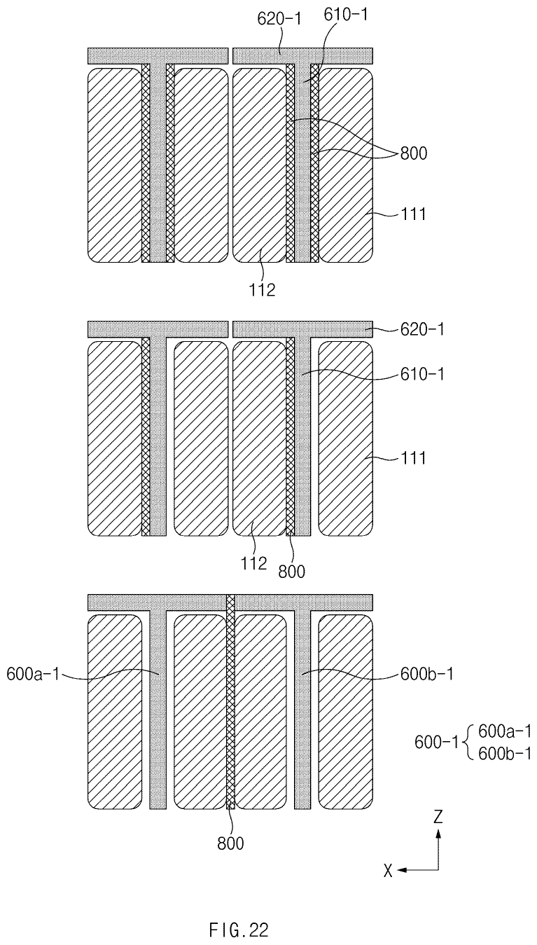

FIG. 22 is a longitudinal cross-sectional view of a partition member, battery cells, and a barrier member according to another embodiment of the present disclosure.

Referring to FIG. 22, the partition member 600-1 may include a first partition member 600a-1, and a second partition member 600b-1 that is provided parallel to the first partition member 600a-1.

According to another embodiment of the present disclosure, the battery cell stack 100 (see FIG. 1) may include the barrier member 800 that contacts at least one of the first partition member 600a-1 and the second partition member 600b-1.

The barrier member 800 may be formed of a material having heat insulation or fire resistance, or a material having thermal conductivity.

The barrier member 800 may be disposed between at least one battery cell 110, among the first battery cell 111 and the second battery cell 112 that are partitioned by the partition body 610-1, and the partition body 610-1.

The barrier member 800 may be provided i) between the partition member 600 and at least one battery cell 110, among the pair of battery cells 110 that are partitioned by the partition member 600, or ii) between the first partition member 600a and the second partition member 600b.

As an example, the barrier member 800 may be disposed between the partition body 610-1 and the first battery cell 111, and between the partition body 610-1 and the second battery cell 112. That is, two barrier members 800 may be provided for each partition member 600.

As an example, the barrier member 800 may be disposed only between the partition body 610-1 and any one of the first and second battery cells 111 and 112 that are partitioned by the partition body 610-1. That is, one barrier member 800 may be provided for each partition member 600.

As an example, the barrier member 800 may be disposed between the first partition member 600a-1 and the second partition member 600b-1.

The barrier member 800 may contact at least one of the first and second battery cells 111 and 112 partitioned by the partition member 600-1 to prevent a temperature of the first battery cell 111 or the second battery cell 112 from rising by improving thermal conductivity while securing fire resistance between the first battery cell 111 and the second battery cell 112.

Furthermore, although not separately illustrated in the drawings, the battery cell stack 100 may further include a cooling plate 850 that is disposed between the first partition member 600a-1 and the second partition member 600b-1.

The cooling plate 850 may be disposed between the first partition member 600a-1 and the second partition member 600b-1 to cool the first partition member 600a-1 and the second partition member 600b-1, or the first battery cell 111 and the second battery cell 112. The cooling plate 850 may also be disposed between a pair of barrier members 800 that are disposed between the first partition member 600a-1 and the second partition member 600b-1.

The cooling plate 850 may be formed of a material having thermal conductivity. The cooling plate 850 may be formed of a material having heat dissipation properties. As an example, the cooling plate 850 may be formed of aluminum.

Furthermore, although not separately illustrated in the drawings, at least a portion of the partition body 610-1 may be replaced with the barrier member 800 (see FIG. 10) or the cooling plate 850.

Furthermore, instead of the barrier member 800 and the cooling plate 850, a surface-pressure member 860 (see FIG. 12) that applies a surface pressure to the battery cell 110 may be used.

The barrier member 800 or the cooling plate 850 may receive heat from the partition member 600 or the battery cell 110 in contact and exchange heat with a cooling channel formed inside the pack housing 1200 through the thermal interface material 200. Here, the cooling channel may refer to a passage for cooling water to flow.

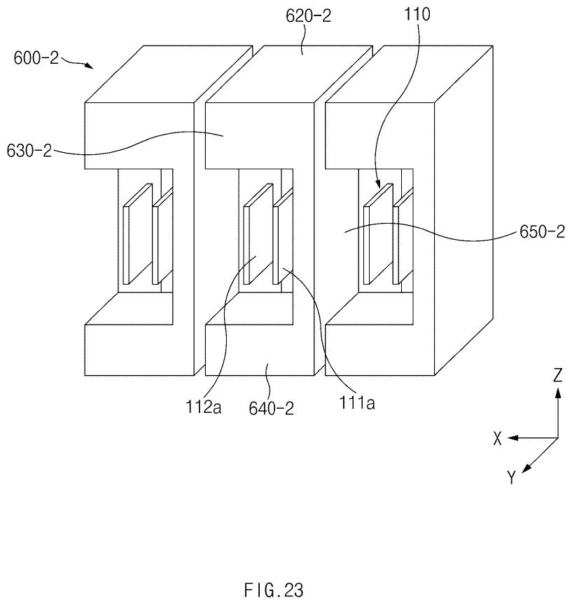

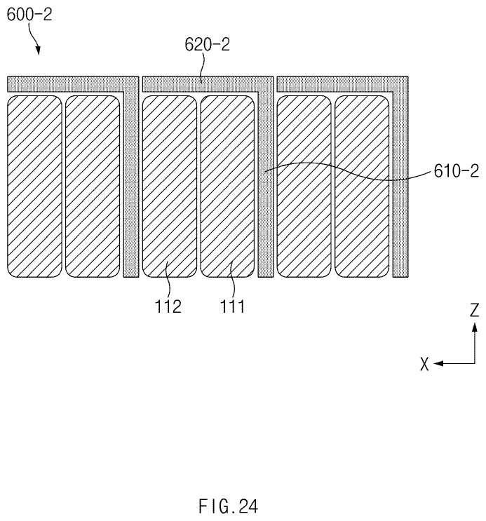

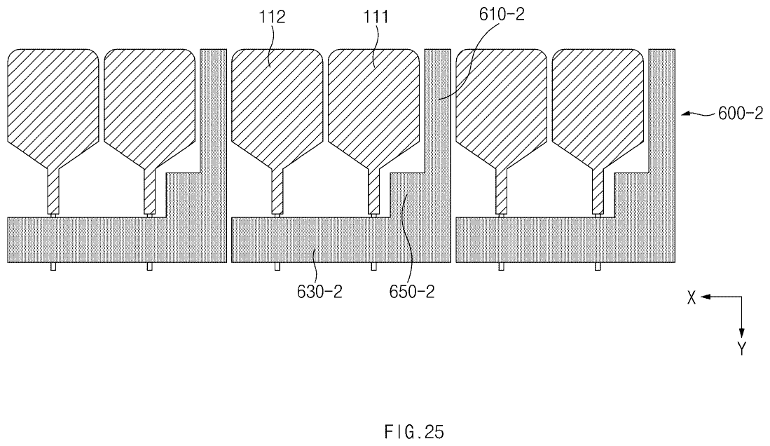

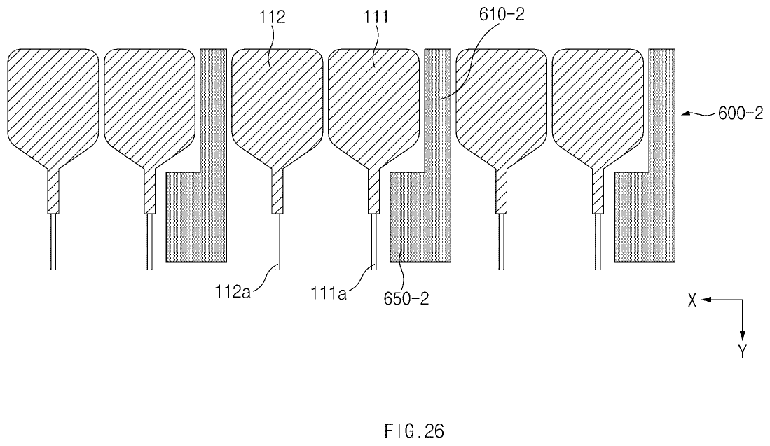

FIG. 23 is a perspective view of battery cells and a partition member viewed in a lengthwise direction according to still another embodiment of the present disclosure. FIG. 24 is a longitudinal cross-sectional view of battery cells and a partition member according to still another embodiment of the present disclosure. FIG. 25 is a transverse cross-sectional view of battery cells and a partition member according to still another embodiment of the present disclosure. FIG. 26 is a transverse cross-sectional view of battery cells and a partition member according to still another embodiment of the present disclosure.

Referring to FIG. 23, FIG. 24, FIG. 25 and FIG. 26, according to another embodiment of the present disclosure, the battery cell stack 100 (see FIG. 1) may include a plurality of battery cells 110 and a partition member 600-2.

The plurality of battery cells 110 may be arranged in the widthwise direction. The plurality of battery cells 110 may contact a heat transfer material 200.

FIG. 23 illustrates that two battery cells 110 are stacked between a pair of adjacent partition members 600-2, but the number of battery cells 110 disposed between the pair of adjacent partition members 600-2 is not limited thereto.

The partition member 600-2 may be disposed between the plurality of battery cells 110 and may partition the plurality of battery cells 110. The partition member 600-2 may accommodate the plurality of battery cells 110 in separate spaces that are partitioned along the widthwise direction.

The partition member 600-2 may have a shape that is different from that of the partition member 600 according to an embodiment of the present disclosure.

The partition member 600-2 may include a partition body 610-2, a cover body 620-2, an end cover body 630-2, a guide cover body 640-2, and a connection body 650-2.

The partition body 610-2, the cover body 620-2, the end cover body 630-2, the guide cover body 640-2, and the connection body 650-2 may be formed integrally.

The partition body 610-2 may be provided between the pair of battery cells 110, among the plurality of battery cells 110, and may extend in the height direction.

The cover body 620-1 may extend from the partition body 610-2 to one side (the X direction) in the widthwise direction to cover one surface of the first battery cell 111 that is any one of the pair of battery cells 110 partitioned by the partition body 610-2, which faces one side (the Z direction) in the height direction. The cover body 620-1 may extend from an opposite end of the partition body 610-1 to one side in the widthwise direction to cover one surface of the first battery cell 111.

More specifically, according to still another embodiment of the present disclosure, the cover body 620-2 of the partition member 600-2 may cover together the first battery cell 111 that is any one of the pair of battery cells 110 partitioned by the partition body 610-2 and the second battery cell 112 that is provided on an opposite side to one side that faces the partition body 610-2 with

respect to the first battery cell 111.

One surface of the first battery cell 111 and one surface of the second battery cell 112, which faces one side in the height direction, may be covered by the cover body 620-2. The cover body 620-2 may cover the first battery cell 111 and the second battery cell 112 together.

The cover body 620-2 may include a cover venting hole 625 (see FIG. 50) that is formed on an area that faces the first battery cell 111 or the second battery cell 112, or a cover notch part 624 (see FIG. 6) that is formed on an area that faces the first battery cell 111 or the second battery cell 112 and has a cut shape or a thickness that is smaller than that of a surrounding area.

The cover venting hole 625 or the cover notch part 624 may be a hole for venting foreign substances or high-pressure fluid caused by fire to the outside of the battery cell stack 100 (see FIG. 1) when a fire occurs in the battery cell 110.

The end cover body 630-2 may extend from the cover body 620-2 toward an opposite side (an opposite direction to the Z direction) in the height direction to cover together at least a portion of the first battery cell 111 and at least a portion of the second battery cell 112 on one side of the first battery cell 111 in the lengthwise direction. The end cover body 630-2 may protrude from the cover body 620-2 to an opposite side in the height direction.

The guide cover body 640-2 may be disposed parallel to the end cover body 630-2 to cover at least a portion of the first battery cell 111 and at least a portion of the second battery cell 112 on one side of the first battery cell 111 in the lengthwise direction.

The pair of adjacent end cover bodies 630-2 may overlap each other, and the pair of adjacent guide cover bodies 640-2 may also overlap each other.

A thickness of the end cover body 630-2 in the height direction and a thickness of the guide cover body 640-2 in the height direction may be thicker than a thickness of the cover body 620-2 in the height direction.

According to the structure of the pair of end cover bodies 630-2 and the pair of guide cover bodies 640-2, even if swelling occurs in the battery cell 110 and pressure is applied to the pair of end cover bodies 630-2 and the pair of guide cover bodies 640-2, the relative positions of the pair of end cover bodies 630-2 and the pair of guide cover bodies 640-2 may not be changed and the partition member 600-2 may not be deformed, thereby having a robust isolation structure. Therefore, even if a fire occurs in the battery cell 110, an isolated structure of the battery cell 110 may be maintained, and heat transfer between the battery cells 110 may be delayed.

The connection body 650-2 may connect the end cover body 630-2 and the guide cover body 640-2. A thickness of the connection body 650-2 in the widthwise direction may be greater than a thickness of the partition body 610-2 in the widthwise direction.

According to the structure of the connection body 650-2, even if swelling occurs in the battery cell 110 and pressure is applied to the connection body 650-2, the relative position of the pair of connection bodies 650-2 may not be changed and the division member 600-2 may not be deformed, thereby having a robust isolation structure. Therefore, even if a fire occurs in the battery cell 110, a structure in which a plurality of battery cells 110 are isolated may be maintained, and a thermoelectric transition between the battery cells 110 may be delayed.

According to still another embodiment of the present disclosure, the connection body 650-2 may be provided between the partition body 610-2 and the end cover body 630-2, and may protrude from the partition body 610-2 toward the first battery cell 111. The connection body 650-2 may protrude further from the partition body 610-2 to one side in the widthwise direction only toward the first battery cell 111.

The first battery cell 111 may include a first cell lead part 111a that extends to opposite sides of the battery cell stack 100 in the lengthwise direction, and the second battery cell 112 may include a second cell lead part 112a that extends to opposite sides of the battery cell stack 100 in the lengthwise direction.

The connection body 650-2 may protrude from the partition body 610-2 toward the first cell lead part 111a of the first battery cell 111. The connection body 650-2 may be spaced apart from the first cell lead part 111a and the second cell lead part 112a.

With the structure, even when a fire occurs in any one of the plurality of battery cells 110, the partition member 600-2 according to still another embodiment of the present disclosure may delay transfer of heat to another battery cell 110, in which a fire does not occur, due to the configuration of the partition body 610-2.

Furthermore, the partition member 600-2 according to still another embodiment of the present disclosure may cover at least a portion of one side of the plurality of battery cells 110 in the lengthwise direction. Accordingly, even when a fire occurs in any one of the plurality of battery cells 110, it is possible to prevent foreign substances or high-pressure fluid from being introduced into the battery cell 110 through an area, except for the cell lead parts 111a and 112a, from one side of another battery cell 110 in the lengthwise direction, in which a fire does not occur.

Furthermore, when a fire occurs in any one of the plurality of battery cells 110, foreign substances or high-pressure fluid caused by the fire may be guided when being vented to the outside of the battery cell stack 100 through the cover venting hole 625 or the cover notch part 624, and may be prevented from being introduced to another adjacent battery cell 110.

In addition, even if swelling occurs in the battery cell 110, the relative position of the cover end body 630-2, the guide end body 640-2, and the connection body 650-2 may be prevented from changing or deformation, so even if a fire occurs in the battery cell 110, a solid isolation structure between multiple battery cells 110 may be maintained, and thermal heat transfer between multiple battery cells 110 may be delayed.

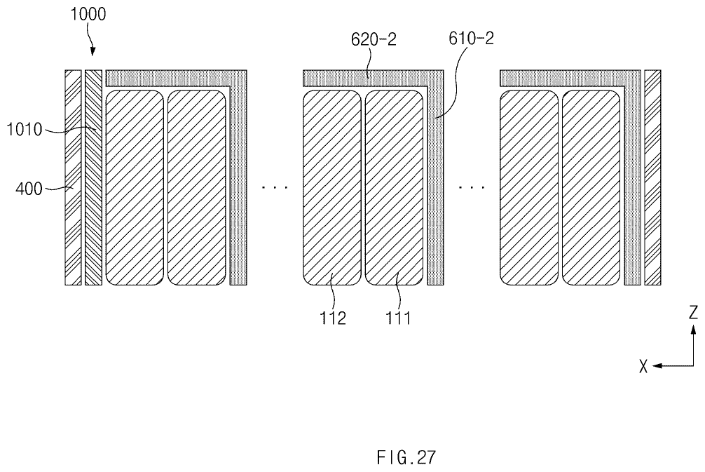

FIG. 27 is a longitudinal cross-sectional view of a partition member, a support member, battery cells, and an end plate according to still another embodiment of the present disclosure.

Referring to FIG. 27, according to still another embodiment of the present disclosure, the battery cell stack 100 (see FIG. 1) may further include end plates 400 that are disposed on opposite sides of the plurality of battery cells 110 in the widthwise direction, and support members 1000.

A pair of end plates 400 may be provided and may be disposed parallel to each other. The plurality of battery cells 110 may be arranged between the pair of end plates 400 in the widthwise direction.

A support member 1000 may be disposed between the battery cell 110 located at one end in the widthwise direction, among the plurality of battery cells 110, and the end plate 400. The support member 1000 may cover one side of the battery cell 110 located at one end in the widthwise direction, among the plurality of battery cells 110.

The support member 1000 may cover one surface of the battery cell 110 located at one end in the widthwise direction, among the plurality of battery cells 110, which faces the end plate 400. The support member 1000 may include only the support partition body 1010.

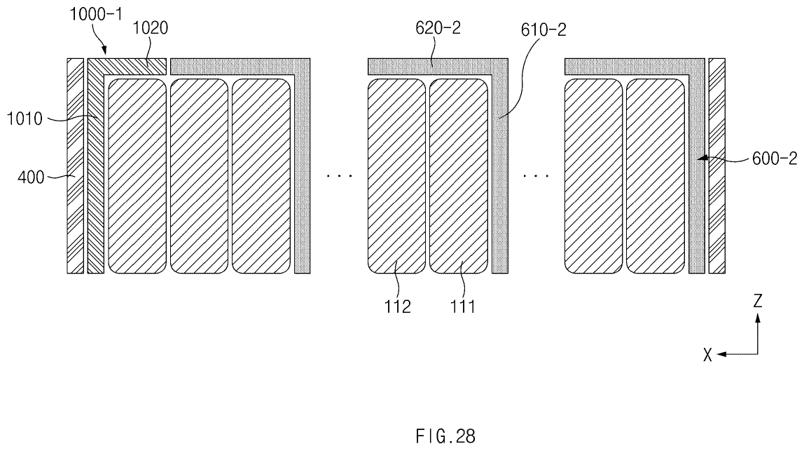

FIG. 28 is a longitudinal cross-sectional view of a partition member, a support member, battery cells, and an end plate for illustrating another support member that is different from FIG. 27.

Referring to FIG. 28, the support member 1000-1 of FIG. 28 may have a shape that is different from that of the support member 1000 of FIG. 22.

Both the support member 1000 and the support member 1000-1 may be disposed parallel to the cover body 620-2. Furthermore, the support member 1000 and the support member 1000-1 may both cover one side of the battery cell 110 located at one end with respect to the widthwise direction, among the plurality of battery cells 110.

As an example, the support member 1000-1 may include the support partition body 1010 and a support cover body 1020, unlike the support member 1000 that has only the support partition body 1010.

The support partition body 1010 may be disposed between the battery cell 110 located at one end in the widthwise direction, among the plurality of battery cells 110, and the end plate 400. The support partition body 1010 may extend in the height direction.

The support cover body 1020 may extend from the support partition body 1010 toward the cover body 620-1. The support partition body 1010 and the support cover body 1020 may be formed integrally.

The support partition body 1010 may cover one surface of the battery cell 110 located at one end in the widthwise direction, among the plurality of battery cells 110, which faces one side in the widthwise direction.

The support cover body 1020 may be disposed parallel to the cover body 620-2, and may cover one surface of the battery cell 110 located at one end in the widthwise direction, among the plurality of battery cells 110, which faces one side in the height direction. The support partition body 1010 and the support cover body 1020 may be formed in an “L” shape.

The support member 1000 illustrated in FIG. 27 and the support member 1000-1 illustrated in FIG. 28 may be appropriately used depending on the number of battery cells 110.

As an example, the support member 1000 may be used when, among the plurality of battery cells 110, the battery cell 110 located at one end in the widthwise direction is covered by the partition member 600-2, and the support member 1000-1 may be used when, among the plurality of battery cells 110, the battery cell 110 located at one end in the widthwise direction is not covered by the partition member 600-2.

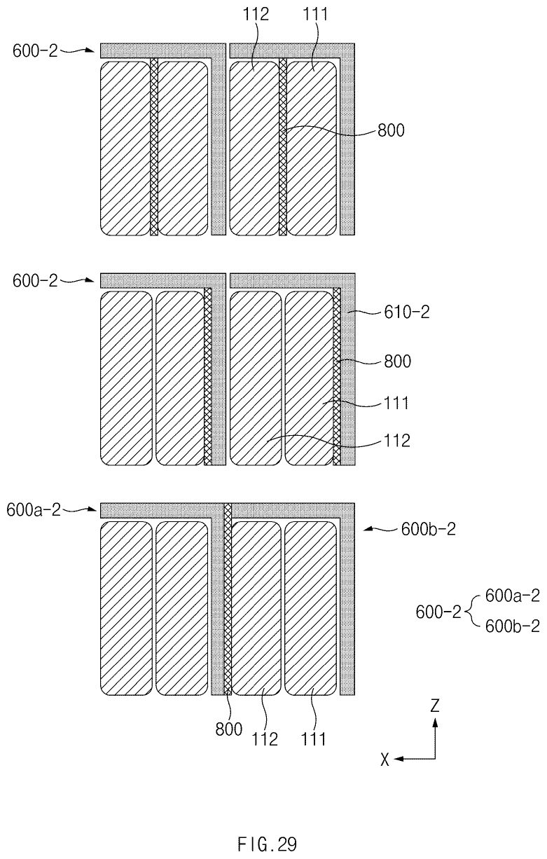

FIG. 29 is a longitudinal cross-sectional view of a partition member, battery cells, and a barrier member according to another embodiment;

Referring to FIG. 29, the partition member 600-2 may include a first partition member 600a-2, and a second partition member 600b-2 that is provided parallel to the first partition member 600a-2.

According to still another embodiment of the present disclosure, the battery cell stack 100 (see FIG. 1) may include the barrier member 800 that i) contacts at least one of the first partition member 600a-2 and the second partition member 600b-2, and ii) contacts at least one of the first battery cell 111 and the second battery cell 112.

The barrier member 800 may be formed of a material having heat insulation or fire resistance, or a material having thermal conductivity.

The barrier member 800 may be disposed between at least one battery cell 110, among the first battery cell 111 and the second battery cell 112 that are partitioned by the partition body 610-2, and the partition body 610-2.

The barrier member 800 may be provided i) between the partition member 600-2 and at least one battery cell 110, among the pair of battery cells 110 that are partitioned by the partition member 600-2, or ii) between the first partition member 600a-2 and the second partition member 600b-2.

As an example, the barrier member 800 may be disposed between the first battery cell 111 and the second battery cell 112.

As an example, the barrier member 800 may be disposed between the partition body 610-2 and the first battery cell 111.

As an example, the barrier member 800 may be disposed between the first partition member 600a-2 and the second partition member 600b-2.

The barrier member 800 may contact at least one of the first and second battery cells 111 and 112 that are covered by the partition member 600-2 to prevent a temperature of the first battery cell 111 or the second battery cell 112 from rising by improving thermal conductivity while securing fire resistance between the first battery cell 111 and the second battery cell 112.

Furthermore, although not separately illustrated in the drawings, the battery cell stack 100 may further include a cooling plate 650 (see FIG. 10) that is disposed between the first partition member 600a-2 and the second partition member 600b-2.

The cooling plate 850 may be disposed between the first partition member 600a-2 and the second partition member 600b-2 to cool the first partition member 600a-2 and the second partition member 600b-2, or the first battery cell 111 and the second battery cell 112. The cooling plate 850 may also be disposed between a pair of barrier members 800 that are disposed between the first partition member 600a-2 and the second partition member 600b-2.

The cooling plate 850 may be formed of a material having thermal conductivity. The cooling plate 850 may be formed of a material having heat dissipation properties. As an example, the cooling plate 850 may be formed of aluminum.

Furthermore, although not separately illustrated in the drawings, at least a portion of the partition body 610-2 may be replaced with the barrier member 800 (see FIG. 10) or the cooling plate 850.

Furthermore, instead of the barrier member 800 and the cooling plate 850, a surface-pressure member 860 (see FIG. 12) that applies a surface pressure to the battery cell 110 may be used.

The barrier member 800 or the cooling plate 850 may receive heat from the partition member 600 or the battery cell 110 in contact and exchange heat with a cooling channel formed inside the pack housing 1200 through the thermal interface material 200. Here, the cooling channel may refer to a passage for cooling water to flow.

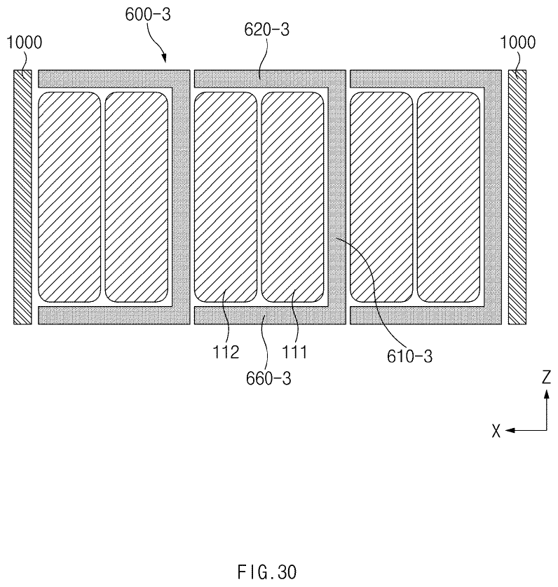

FIG. 30 is a longitudinal cross-sectional view of a partition member, battery cells, and a support member according to still another embodiment.

Referring to FIG. 30, according to another embodiment of the present disclosure, the battery cell stack 100 (see FIG. 1) may include a plurality of battery cells 110 and a partition member 600-3.

The plurality of battery cells 110 may be arranged in the widthwise direction. The plurality of battery cells 110 may contact a heat transfer material 210 (see FIG. 3).

The partition member 600-3 may be disposed between the plurality of battery cells 110 and may partition the plurality of battery cells 110. The partition member 600-3 may accommodate the plurality of battery cells 110 in separate spaces that are partitioned along the widthwise direction.

The partition member 600-3 may have a shape that is different from that of the partition members 600, 600-1, and 600-2 according to various embodiments of the present disclosure.

FIG. 30 illustrates that two battery cells 110 are stacked between a pair of adjacent partition members 600-3, but the number of battery cells 110 disposed between the pair of adjacent partition members 600-3 is not limited thereto.

The partition member 600-3 may include a partition body 610-3, a cover body 620-3, an end cover body, a guide cover body, and a connection body, and may further include a support body 660-3. The partition member 600-3 may also be integrally formed.

Here, the descriptions of the partition members 600, 600-1, and 600-2 may be applied to the same structures as those of the partition member 600-3, such as the end cover body, the guide cover body, and the connection body.

The partition body 610-3 may be provided between the pair of battery cells 110, among the plurality of battery cells 110, and may extend in the height direction.

The plurality of battery cells 110 may include a first battery cell 111 that is any one of the pair of battery cells 110 partitioned by the partition member 600-3, and a second battery cell 112 that is provided on an opposite side to the side that faces the partition body 610-3 with respect to the first battery cell 111.

The cover body 620-3 may extend from the partition body 610-3 to one side (the X direction) in the widthwise direction to cover one surface of the first battery cell 111 that is any one of the pair of battery cells 110 partitioned by the partition body 610-3, which faces one side in the height direction. The cover body 620-3 may extend from one end of the partition body 610-3 in the height direction to one side in the widthwise direction. The cover body 620-3 may extend to cover together one surface of the first battery cell 111, which faces one side in the height direction, and one surface of the second battery cell 112, which faces one side in the height direction.

The cover body 620-3 may include a cover venting hole 625 (see FIG. 50) that is formed on an area that faces the first battery cell 111 or an area that faces the second battery cell 112, or a cover notch part 624 (see FIG. 6) that is formed on an area that faces the first battery cell 111 or the second battery cell 112 and has a cut shape or a thickness that is smaller than that of a surrounding area.

The support body 660-3 may extend from the partition body 610-3 in parallel to the cover body 620-3 to cover an opposite surface of the first battery cell 111, which faces an opposite side in the height direction (an opposite direction to the Z direction). The support body 660-3 may extend from the partition body 610-3 to one side (the X direction) in the widthwise direction to be parallel to the cover body 620-3. The support body 660-3 may extend from an opposite end of the partition body 610-3 in the height direction and may cover an opposite surface of the first battery cell 111. The support body 660-3 may cover together an opposite surface of the first battery cell 111, which faces an opposite side in the height direction, and an opposite surface of the second battery cell 112, which faces an opposite side in the height direction.

The support body 660-3 may be disposed between the first battery cell 111 and the heat transfer material 200, and between the second battery cell 112 and the heat transfer material 200.

That is, with respect to the first battery cell 111 and the second battery cell 112, the cover body 620-3 may be provided on one side in the height direction, and the support body 660-3 may be provided on an opposite side in the height direction.

Although not separately illustrated in FIG. 30, the end cover body may extend from the cover body 620-3 toward the support body 660-3 to cover together at least a portion of the first battery cell 111 and at least a portion of the second battery cell 112 on one side of the first battery cell 111 in the lengthwise direction.

The guide cover body may also extend from the support body 660-3 toward the cover body 620-3 to cover together at least a portion of the first battery cell 111 and at least a portion of the second battery cell 112 on one side of the first battery cell 111 in the lengthwise direction.

The pair of adjacent end cover bodies may overlap each other, and the pair of adjacent guide cover bodies may also overlap each other.

According to the structure of the pair of end cover bodies and the pair of guide cover bodies, even if swelling occurs in the battery cell 110 and pressure is applied to the pair of end cover bodies and the pair of guide cover bodies, the relative position of the pair of end cover bodies and the pair of guide cover bodies may not be changed and the partition member 600-3 may not be deformed, thereby having a robust isolation structure. Therefore, even if a fire occurs in the battery cell 110, an isolated structure between the plurality of battery cells 110 may be maintained, and thermoelectric heat transfer between the battery cells 110 may be delayed.

The connection body may also connect the end cover body and the guide cover body, and may have a thickness that is greater than a thickness of the partition body 610-3 in the widthwise direction.

According to the structure of the connection body, even if pressure is applied to the connection body due to swelling in the battery cell 110, the relative position of the pair of connection bodies may not be changed and the division member 600-3 may not be deformed, thereby having a robust isolation structure. Therefore, even if a fire occurs in the battery cell 110, an isolated structure between the plurality of battery cells 110 may be maintained, and a thermoelectric transition between the battery cells 110 may be delayed.

Similarly, although not separately illustrated in the drawings, the first battery cell 111 may include a first cell lead part 111a (see FIG. 26) that extends toward opposite sides of the battery cell stack 100 in the lengthwise direction, and the second battery cell 112 may include a second cell lead part 112a that extends toward opposite sides of the battery cell stack 100 in the lengthwise direction.

The connection body may protrude from the partition body 610-3 to one side in the widthwise direction. The connection body may protrude from the partition body 610-3 toward the first cell lead part 111a of the first battery cell 111. The connection body may be spaced apart from the first cell lead part 111a and the second cell lead part 112a.

With the structure, even when a fire occurs in any one of the plurality of battery cells 110, the partition member 600-3 according to still another embodiment of the present disclosure may delay transfer of heat to another battery cell 110, in which a fire does not occur, due to the configuration of the partition body 610-3.

Furthermore, the partition member 600-3 according to still another embodiment of the present disclosure may also cover at least a portion of opposite sides of the plurality of battery cells 110 in the lengthwise direction. Accordingly, even when a fire occurs in any one of the plurality of battery cells 110, it is possible to prevent foreign substances or high-pressure fluid from being introduced into the battery cell 110 through an area, except for the cell lead parts 111a and 112a, on one side of another battery cell 110 in the lengthwise direction, in which a fire does not occur.

In addition, even if swelling occurs in the battery cell 110, the position of the cover end body, the guide end body, and the connection body may be prevented from changing or deforming, so that a solid isolation structure between the plurality of the battery cells 110 may be maintained, and even if a fire occurs in the battery cell 110, a thermal heat transfer between the plurality of battery cells 110 may be delayed.

According to still another embodiment of the present disclosure, the battery cell stack 100 (see FIG. 1) may further include end plates 400 that are disposed on opposite sides of the plurality of battery cells 110 in the widthwise direction, and support members 1000.

A pair of end plates 400 (see FIG. 2) may be provided and may be disposed parallel to each other. The plurality of battery cells 110 may be arranged between the pair of end plates 400 in the widthwise direction.

A support member 1000 may be disposed between the battery cell 110 located at one end in the widthwise direction, among the plurality of battery cells 110, and the end plate 400. The support member 1000 may cover one side of the battery cell 110 located at one end in the widthwise direction, among the plurality of battery cells 110.

The support member 1000 may cover one surface of the battery cell 110 located at one end in the widthwise direction, among the plurality of battery cells 110, which faces the end plate 400.

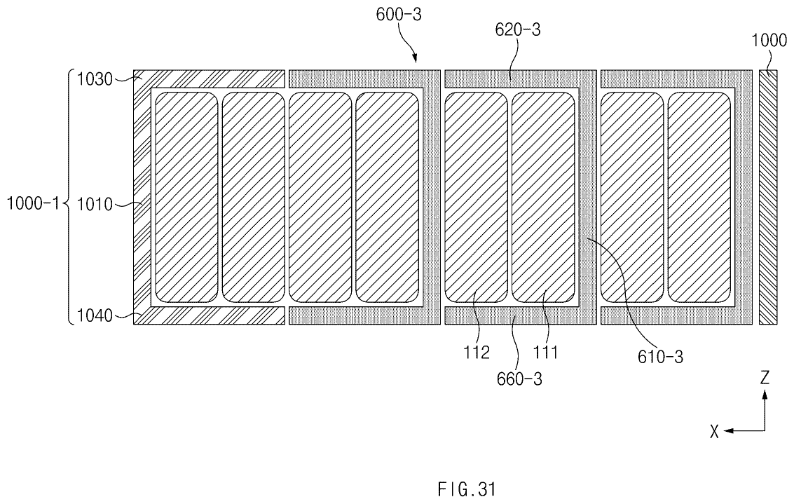

FIG. 31 is a longitudinal cross-sectional view of a partition member, battery cells, and a support member for illustrating a support member that is different from that of FIG. 30.

Referring to FIG. 31, the support member 1000-1 may have a shape that is different from a shape of the support member 1000. As an example, the support member 1000-1 may include the support partition body 1010, a first support cover body 1030, and a second support cover body 1040, unlike the support member 1000 that has only the support partition body 1010.

Both the support member 1000 and the support member 1000-1 may be disposed parallel to the cover body 620-3. Furthermore, the support member 1000 and the support member 1000-1 may both cover one side of the battery cell 110 located at one end with respect to the widthwise direction, among the plurality of battery cells 110.

The support partition body 1010 may be disposed between the battery cell 110 located at one end in the widthwise direction, among the plurality of battery cells 110, and the end plate 400. The support partition body 1010 may extend in the height direction.

The first support cover body 1030 may extend from the support partition body 1010 toward the cover body 620-3. Although it is illustrated on the drawing that the first support cover body 1030 extends from one end of the support partition body 1010 in the height direction toward the cover body 620-3, the present disclosure is not limited thereto.

The second support cover body 1040 may extend from the support partition body 1010 toward the support body 660-3. Although it is illustrated on the drawing that the second support cover body 1040 extends from an opposite end of the support partition body 1010 in the height direction toward the cover body 620-3, the present disclosure is not limited thereto.

The support partition body 1010 may cover one surface of, among the plurality of battery cells 110, the battery cell 110 located at one end in the widthwise direction, which faces the widthwise direction.

The first support cover body 1030 may be disposed parallel to the cover body 620-3, and may cover one surface of the battery cell 110 located at one end in the widthwise direction, among the plurality of battery cells 110, which faces one side in the height direction.

The second support cover body 1040 may be disposed parallel to the support body 660-3, and may cover an opposite surface of the battery cell 110 located at one end in the widthwise direction, among the plurality of battery cells 110, which faces an opposite side in the height direction.

The support partition body 1010, the first support cover body 1030, and the second support cover body 1040 may be integrally formed.

The support member 1000 and the support member 1000-1 may be appropriately used depending on the number of battery cells 110. The support member 1000-1 may be used as one, and the support member 1000-1 may be used as two.

As an example, the support member 1000 may be used when, among the plurality of battery cells 110, the battery cell 110 located at one end in the widthwise direction is covered by the partition member 600-3, and the support member 1000-1 may be used when, among the plurality of battery cells 110, the battery cell 110 located at one end in the widthwise direction is not covered by the partition member 600-3.

Although not separately illustrated in the drawings, according to still another embodiment of the present disclosure, the battery cell stack 100 (see FIG. 1) may include the barrier member 800 (see FIG. 29).

The partition member 600-3 may include a first partition member 600-3 that covers the first battery cell 111 and the second battery cell 112 together, and a second partition member 600-3 that is provided parallel to the first partition member 600-3.

According to still another embodiment of the present disclosure, the battery cell stack 100 may include the barrier member 800 that i) contacts at least one of the first partition member 600a-3 and the second partition member 600b-3, and ii) contacts at least one of the first battery cell 111 and the second battery cell 112.

The barrier member 800 may be formed of a material having heat insulation or fire resistance, or a material having thermal conductivity.

The barrier member 800 may be disposed between the first battery cell 111 partitioned by the partition body 610-3, and the partition body 610-3.

The barrier member 800 may be provided i) between the partition member 600-3 and at least one battery cell 110, among the pair of battery cells 110 that are partitioned by the partition member 600-3, or ii) between the first partition member 600a-3 and the second partition member 600b-3.

As an example, the barrier member 800 may be disposed between the first battery cell 111 and the second battery cell 112.

As an example, the barrier member 800 may be disposed between the partition body 610-3 and the first battery cell 111.

As an example, the barrier member 800 may be disposed between the first partition member 600-3 and the second partition member 600-3.

The barrier member 800 may contact at least one of the first and second battery cells 111 and 112 that are covered by the partition member 600-3 to prevent a temperature of the first battery cell 111 or the second battery cell 112 from rising by improving thermal conductivity while securing fire resistance between the first battery cell 111 and the second battery cell 112.

Furthermore, although not separately illustrated in the drawings, the battery cell stack 100 may further include a cooling plate 650 (see FIG. 10) that is disposed between the first partition member 600-3 and the second partition member 600-3.

The cooling plate 850 may be disposed between the first partition member 600-3 and the second partition member 600-3 to cool the first partition member 600-3 and the second partition member 600-3, or the first battery cell 111 and the second battery cell 112. The cooling plate 850 may also be disposed between a pair of barrier members 800 that are disposed between the first partition member 600-3 and the second partition member 600-3.

The cooling plate 850 may be formed of a material having thermal conductivity. The cooling plate 850 may be formed of a material having heat dissipation properties. As an example, the cooling plate 850 may be formed of aluminum.

Furthermore, although not separately illustrated in the drawings, at least a portion of the partition body 610-3 may be replaced with the barrier member 800 (see FIG. 10) or the cooling plate 850.

Furthermore, instead of the barrier member 800 and the cooling plate 850, a surface-pressure member 860 (see FIG. 12) that applies a surface pressure to the battery cell 110 may be used.

The barrier member 800 or the cooling plate 850 may receive heat from the partition member 600 or the battery cell 110 in contact and exchange heat with a cooling channel formed inside the pack housing 1200 through the thermal interface material 200. Here, the cooling channel may mean a passage for cooling water to flow.

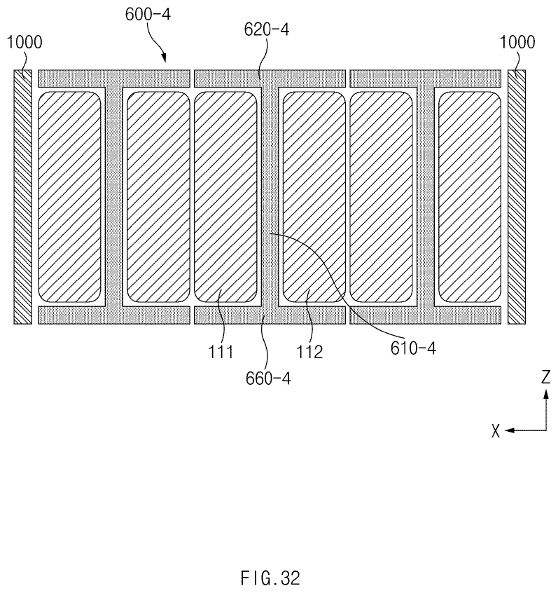

FIG. 32 is a longitudinal cross-sectional view of a partition member, battery cells, and a support member according to still another embodiment of the present disclosure.

Referring to FIG. 32, according to another embodiment of the present disclosure, the battery cell stack 100 (see FIG. 1) may include a plurality of battery cells 110 and a partition member 600-4.

The plurality of battery cells 110 may be arranged in the widthwise direction. The plurality of battery cells 110 may contact a heat transfer material 200 (see FIG. 3).

The partition member 600-4 may be disposed between the pair of battery cells 110, among the plurality of battery cells 110, to partition the pair of battery cells 110. The partition member 600-4 may accommodate the plurality of battery cells 110 in separate spaces that are partitioned along the widthwise direction.

The partition member 600-4 may have a shape that is different from that of the partition members 600, 600-1, 600-2, and 600-3 according to various embodiments of the present disclosure.

FIG. 32 illustrates that two battery cells 110 are stacked between a pair of adjacent partition members 600-4, but the number of battery cells 110 disposed between the pair of adjacent partition members 600-4 is not limited thereto.

The partition member 600-4 may include a partition body 610-4, a cover body 620-4, an end cover body, a guide cover body, and a connection body, and may further include a support body 660-4. The partition member 600-4 may also be integrally formed.

Here, the descriptions of the partition members 600, 600-1, and 600-2 may be applied to the same structures as those of the partition member 600-3, such as the end cover body, the guide cover body, and the connection body.

The partition body 610-4 may be provided between the pair of battery cells 110, among the plurality of battery cells 110, and may extend in the height direction.

The plurality of battery cells 110 may include a first battery cell 111 and a second battery cell 112 that are partitioned by the partition body 610-4.

The cover body 620-4 may extend from the partition body 610-4 to opposite sides in the widthwise direction to cover together surfaces of the pair of battery cells 110 that are partitioned by the partition body 610-4, which face one side (the Z direction) in the height direction. The cover body 620-4 may extend from one end of the partition body 610-4 in the height direction to opposite sides in the widthwise direction. The cover body 620-4 may extend to cover together one surface of the first battery cell 111 and one surface of the second battery cell 112.

The cover body 620-4 may include a cover venting hole 625 (see FIG. 50) that is formed on an area that faces the first battery cell 111 or the second battery cell 112, or a cover notch part 624 (see FIG. 6) that is formed on an area that faces the first battery cell 111 or the second battery cell 112 and has a cut shape or a thickness that is smaller than that of a surrounding area.

The support body 660-4 may extend from the partition body 610-4 in parallel to the cover body 620-4 to cover opposite surfaces of the pair of battery cells 110, which face an opposite side (an opposite direction to the Z direction) in the height direction, between opposite sides of the pair of battery cells 110 in the height direction. The support body 660-4 may extend from an opposite end of the partition body 610-4 in the height direction to opposite sides in the widthwise direction.

That is, with respect to the first battery cell 111 and the second battery cell 112, the cover body 620-4 may be provided on one side in the height direction, and the support body 660-4 may be provided on an opposite side in the height direction.

The partition member 600-4 may be formed in an “I” shape on a cross section of the partition member 600-4, on which the partition body 610-4, the cover body 620-4, and the support body 660-4 are illustrated.

Although not separately illustrated in FIG. 32, the end cover body may extend from the cover body 620-4 toward the support body 660-4 to cover at least portions of the pair of battery cells 110 together on one side of the pair of battery cells 110 in the lengthwise direction.

The guide cover body may also extend from the support body 660-4 toward the cover body 620-4 to cover at least a portion of the pair of battery cells 110 on one side of the pair of battery cells 110 in the lengthwise direction.

The pair of adjacent end cover bodies may overlap each other, and the pair of adjacent guide cover bodies may also overlap each other.

According to the structure of the pair of end cover bodies and the pair of guide cover bodies, even if swelling occurs in the battery cell 110 and pressure is applied to the pair of end cover bodies and the pair of guide cover bodies, the position of the partition member 600-4 may not be changed and the partition member 600-4 may not be deformed, thereby having a robust isolation structure. Therefore, even if a fire occurs in the battery cell 110, an isolated structure between the plurality of the battery cells 110 may be maintained, and a thermoelectric heat transfer between the battery cells 110 may be delayed.

The connection body may also connect the end cover body and the guide cover body, and may have a thickness that is greater than a thickness of the partition body 610-4 in the widthwise direction.

According to the structure of the connection body, even if pressure is applied to the connection body due to swelling in the battery cell 110, the relative position of the pair of connection bodies may not be changed and the partition member 600-4 may not be deformed, thereby having a robust isolation structure. Therefore, even if a fire occurs in the battery cell 110, the isolated structure of the plurality of battery cells 110 may be maintained, and a thermoelectric transition between the battery cells 110 may be delayed.

Similarly, although not separately illustrated in the drawings, the first battery cell 111 may include a first cell lead part 111a (see FIG. 26) that extends toward opposite sides of the battery cell stack 100 in the lengthwise direction, and the second battery cell 112 may include a second cell lead part 112a that extends toward opposite sides of the battery cell stack 100 in the lengthwise direction.

The connection body may protrude from the partition body 610-4 to opposite sides with respect to the widthwise direction. The connection body may protrude from the partition body 610-3 toward a first cell lead part 111a of the first battery cell 111 and a second cell lead part 112a of the second battery cell 112. The connection body may be spaced apart from the first cell lead part 111a and the second cell lead part 112a.

With the structure, even when a fire occurs in any one of the plurality of battery cells 110, the partition member 600-4 according to still another embodiment of the present disclosure may delay transfer of heat to another battery cell 110, in which a fire does not occur, due to the configuration of the partition body 610-4.

Furthermore, the partition member 600-4 according to still another embodiment of the present disclosure may also cover at least a portion of opposite sides of the plurality of battery cells 110 in the lengthwise direction. Accordingly, even when a fire occurs in any one of the plurality of battery cells 110, it is possible to prevent foreign substances or high-pressure fluid from being introduced into the battery cell 110 through an area, except for the cell lead parts 111a and 112a, on one side of another battery cell 110 in the lengthwise direction, in which a fire does not occur.

In addition, even if swelling occurs in the battery cell 110, the position of the cover end body, the guide end body, and the connection body may be prevented from changing or deforming, so that even if a fire occurs in the battery cell 110, a solid isolation structure between the plurality of battery cells 110 may be maintained, and thermal heat transfer between the plurality of battery cells 110 may be delayed.

According to still another embodiment of the present disclosure, the battery cell stack 100 may further include end plates 400 that are disposed on one side of the plurality of battery cells 110 in the widthwise direction, and support members 1000.

A pair of end plates 400 may be provided and may be disposed parallel to each other. The plurality of battery cells 110 may be arranged between the pair of end plates 400 in the widthwise direction.

A support member 1000 may be disposed between the battery cell 110 located at one end in the widthwise direction, among the plurality of battery cells 110, and the end plate 400. The support member 1000 may cover one side of the battery cell 110 located at one end in the widthwise direction, among the plurality of battery cells 110.

The support member 1000 may cover one surface of the battery cell 110 located at one end in the widthwise direction, among the plurality of battery cells 110, which faces the end plate 400.

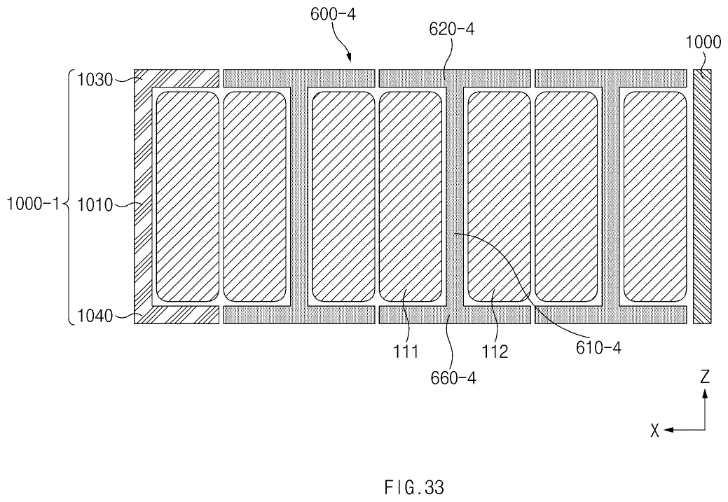

FIG. 33 is a longitudinal cross-sectional view of a partition member, battery cells, and a support member for illustrating a support member that is different from that of FIG. 32.

Referring to FIG. 33, the support member 1000-1 may have a shape that is different from a shape of the support member 1000. As an example, the support member 1000-1 may include the support partition body 1010, a first support cover body 1030, and a second support cover body 1040, unlike the support member 1000 that has only the support partition body 1010.

Both the support member 1000 and the support member 1000-1 may be disposed parallel to the cover body 620-3. Furthermore, the support member 1000 and the support member 1000-1 may both cover one side of the battery cell 110 located at one end with respect to the widthwise direction, among the plurality of battery cells 110.

The support partition body 1010 may be disposed between the battery cell 110 located at one end in the widthwise direction, among the plurality of battery cells 110, and the end plate 400. The support partition body 1010 may extend in the height direction.

The first support cover body 1030 may extend from the support partition body 1010 toward the cover body 620-4. Although it is illustrated on the drawing that the first support cover body 1030 extends from one end of the support partition body 1010 in the height direction toward the cover body 620-4, the present disclosure is not limited thereto.

The second support cover body 1040 may extend from one end of the support partition body 1010 toward the support body 660-4. Although it is illustrated on the drawing that the second support cover body 1040 extends from an opposite end of the support partition body 1010 in the height direction toward the support body 660-4, the present disclosure is not limited thereto.

The support partition body 1010 may cover one surface of the battery cell 110 located at one end in the widthwise direction, among the plurality of battery cells 110, which faces one side in the widthwise direction.

The first support cover body 1030 may be disposed parallel to the cover body 620-4, and may cover one surface of the battery cell 110 located at one end in the widthwise direction, among the plurality of battery cells 110, which faces one side in the height direction.

The second support cover body 1040 may be disposed parallel to the support body 660-4, and may cover an opposite surface of the battery cell 110 located at one end in the widthwise direction, among the plurality of battery cells 110, which faces an opposite side in the height direction.

The support partition body 1010, the first support cover body 1030, and the second support cover body 1040 may be integrally formed.

The support member 1000 and the support member 1000-1 may be appropriately used depending on the number of battery cells 110. The support member 1000-1 may be used as one, and the support member 1000-1 may be used as two.

As an example, the support member 1000 may be used when, among the plurality of battery cells 110, the battery cell 110 located at one end in the widthwise direction is covered by the partition member 600-4, and the support member 1000-1 may be used when, among the plurality of battery cells 110, the battery cell 110 located at one end in the widthwise direction is not covered by the partition member 600-4.

Although not separately illustrated in the drawings, according to still another embodiment of the present disclosure, the battery cell stack 100 (see FIG. 1) may include the barrier member 800 (see FIG. 22).

The partition member 600-4 may include a first partition member 600-4 that covers the first battery cell 111 and the second battery cell 112 together, and a second partition member 600-4 that is provided parallel to the first partition member 600-4.

According to still another embodiment of the present disclosure, the battery cell stack 100 may include the barrier member 800 that contacts at least one of the first partition member 600-4 and the second partition member 600-4.

The barrier member 800 may be formed of a material having heat insulation or fire resistance, or a material having thermal conductivity.

The barrier member 800 may be disposed between at least one battery cell 110, among the first battery cell 111 and the second battery cell 112 that are partitioned by the partition body 610-4, and the partition body 610-4.

The barrier member 800 may be provided i) between the partition member 600-4 and at least one battery cell 110, among the pair of battery cells 110 that are partitioned by the partition member 600-4, or ii) between the first partition member 600-4 and the second partition member 600-4.

As an example, the barrier member 800 may be disposed between the partition body 610-4 and the first battery cell 111, and between the partition body 610-4 and the second battery cell 112. That is, two barrier members 800 may be provided for each partition member 600.

As an example, the barrier member 800 may be disposed only between the partition body 610-4 and any one of the first and second battery cells 111 and 112 that are partitioned by the partition body 610-4. That is, one barrier member 800 may be provided for each partition member 600.

As an example, the barrier member 800 may be disposed between the first partition member 600-4 and the second partition member 600-4.

The barrier member 800 may contact at least one of the first and second battery cells 111 and 112 partitioned by the partition member 600-4 to prevent a temperature of the first battery cell 111 or the second battery cell 112 from rising by improving thermal conductivity while securing fire resistance between the first battery cell 111 and the second battery cell 112.

Furthermore, although not separately illustrated in the drawings, the battery cell stack 100 may further include a cooling plate 850 (see FIG. 10) that is disposed between a pair of adjacent partition members 600-4.

The cooling plate 850 may be disposed between the pair of partition members 600-4 to cool the pair of partition members 600-4 or the first battery cell 111 and the second battery cell 112. The cooling plate 850 may also be disposed between the pair of barrier members 800 that are disposed between the pair of partition members 600-4.

The cooling plate 850 may be formed of a material having thermal conductivity. The cooling plate 850 may be formed of a material having heat dissipation properties. As an example, the cooling plate 850 may be formed of aluminum.

Furthermore, although not separately illustrated in the drawings, at least a portion of the partition body 610-4 may be replaced with the barrier member 800 (see FIG. 12) or the cooling plate 850.

Furthermore, instead of the barrier member 800 and the cooling plate 850, a surface-pressure member 860 (see FIG. 12) that applies a surface pressure to the battery cell 110 may be used.

The barrier member 800 or the cooling plate 850 may receive heat from the partition member 600 or the battery cell 110 in contact and exchange heat with a cooling channel formed inside the pack housing 1200 through the thermal interface material 200. Here, the cooling channel may refer to a passage for cooling water to flow.

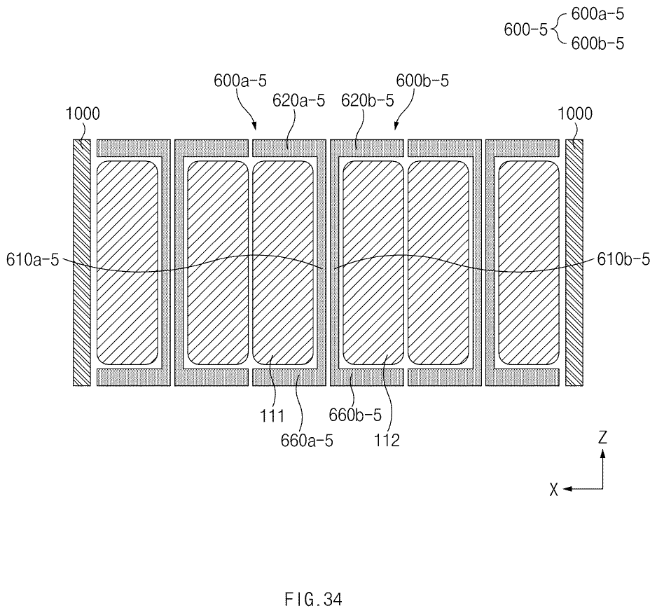

FIG. 34 is a transverse cross-sectional view of a partition member, battery cells, and a support member according to still another embodiment.

Referring to FIG. 34, according to another embodiment of the present disclosure, the battery cell stack 100 (see FIG. 1) may include a plurality of battery cells 110 and a partition member 600-5.

The plurality of battery cells 110 may be arranged in the widthwise direction. The plurality of battery cells 110 may contact a heat transfer material 200.

FIG. 34 illustrates that two battery cells 110 are stacked between a pair of adjacent partition members 600-5, but the number of battery cells 110 disposed between the pair of adjacent partition members 600-5 is not limited thereto.

The partition member 600-5 may be disposed between the pair of battery cells 110, among the plurality of battery cells 110, and may partition the plurality of battery cells 110. The partition member 600-5 may accommodate the plurality of battery cells 110 in separate spaces that are partitioned along the widthwise direction.

The partition member 600-5 may have a shape that is different from that of the partition members 600, 600-1, 600-2, 600-3, and 600-4 according to various embodiments of the present disclosure.

The partition member 600-5 may include a first partition member 600a-5 and a second partition member 600b-5.

The first partition member 600a-5 may be disposed between the pair of battery cells 110, and may cover one surface and an opposite surface of the first battery cell 111 that is any one of the pair of battery cells 110, which face opposite sides in the height direction.

The second partition member 600b-5 may be disposed between the second battery cell 112 that is the other one of the pair of battery cells 110 and the first partition member 600a-5, and may cover one surface and an opposite surface of the second battery cell 112, which face opposite sides in the height direction.

The first partition member 600a-5 may include a first partition body 610a-5, a first cover body 620a-5, a first end cover body, a first guide cover body, and a first connection body, and may further include a first support body 660a-5. The first partition member 600a-5 may be integrally formed.

The second partition member 600b-5 may include a second partition body 610b-5, a second cover body 620b-5, a second end cover body, a second guide cover body, and a second connection body, and may further include a second support body 660b-5. The second partition member 600b-5 may be integrally formed.

The description of the first end cover body, the first guide cover body, and the first connection body, and the second end cover body, the second guide cover body, and the second connection body and the like may be applied to a description of the partition member 600 according to an embodiment of the present disclosure.

The first partition body 610a-5 may be disposed between the first battery cell 111 and the second partition member 600b-5, and may extend in the height direction.

The first cover body 620a-5 may extend from the first partition body 610a-5 to one side (the X direction) in the widthwise direction to cover one surface of the first battery cell 111, which faces one side (the Z direction) in the height direction. The first cover body 620a-5 may extend from one end of the first partition body 610a-5 in the height direction to one side in the widthwise direction.

The first support body 660a-5 may extend from the first partition body 610a-5 in parallel to the first cover body 620a-5 to cover an opposite surface of the first battery cell 111, which faces an opposite side in the height direction on the opposite side of the first battery cell 111 in the height direction. The first support body 660a-5 may extend from an opposite end of the first partition body 610a-5 in the height direction to one side (the X direction) in the widthwise direction.

The second partition body 610b-5 may be provided between the second battery cell 112 and the first partition body 610a-5, and may extend in the height direction.

The second cover body 620b-5 may extend from the second partition body 610b to an opposite side (an opposite direction to the X direction) in the widthwise direction to cover one surface of the second battery cell 112, which faces one side in the height direction. The second cover body 620b-5 may extend from one end of the second partition body 610b-5 in the height direction to an opposite side in the widthwise direction.

The first cover body 620a-5 and the second cover body 620b-5 may extend from the first partition body 610a-5 and the second partition body 610b-5 in opposite directions, respectively.

The first cover body 620a-5 and the second cover body 620b-5 may overlap each other. According to this structure, even if the battery cell 110 is swelled, even if the first cover body 620a-5 and the second cover body 620b-5 are pressed by the battery cell 110, the first cover body 620a-5 and the second cover body 620b-5 may be prevented from being separated in a width direction (an opposite direction to the X direction or the X direction) or a height direction (an opposite direction to the Z direction or the Z direction), and thus an isolation structure between the battery cells 110 may be maintained.

Therefore, even if the battery cell 110 is swollen, the isolation structure between the battery cells 110 of the battery cell stack 100 may be maintained, thereby maximizing the effect of delaying the thermal transfer between the battery cells 110.

The first cover body 620a-5 or the second cover body 620b-5 may include a cover venting hole 625 (see FIG. 50) that is formed on an area that faces the first battery cell 111 or an area that faces the second battery cell 112, or a cover notch part 624 (see FIG. 6) that is formed on an area that faces the first battery cell 111 or an area that faces the second battery cell 112 and has a cut shape or a thickness that is smaller than that of a surrounding area.

The second support body 660b-5 may extend from the second partition body 610b-5 in parallel to the second cover body 620b-5 to cover an opposite surface of the second battery cell 112 on an opposite side of the second battery cell 112 in the height direction. The second support body 660b-5 may extend from an opposite end of the second partition body 610b-5 in the height direction to an opposite side (an opposite direction to the X direction) in the widthwise direction.

The first support body 660a-5 and the second support body 660b-5 may extend from the first partition body 610a-5 and the second partition body 610b-5 in opposite directions, respectively.

The first support body 660a-5 and the second support body 660b-5 may overlap each other. According to the structure, even if the battery cell 110 is swelled, even if the first support body 660a-5 and the second support body 660b-5 are pressed by the battery cell 110, the first support body 660a-5 and the second support body 660b-5 may be prevented from being separated in the width direction (an opposite direction to the X direction or the X direction) or the height direction (an opposite direction to the Z direction or the Z direction), and thus an isolation structure between the battery cells 110 may be maintained.

Therefore, even if the battery cell 110 is swollen, the isolation structure between the battery cells 110 of the battery cell stack 100 may be maintained, thereby maximizing the effect of delaying the thermal transfer between the battery cells 110.

That is, the first cover body 620a-5 and the first support body 660a-5 may be provided on opposite sides of the first battery cell 111 in the height direction, and the second cover body 620b-5 and the second support body 660b-5 may be provided on opposite sides of the second battery cell 112 in the height direction.

Although not separately illustrated in FIG. 34, the first end cover body may extend from the first cover body 620a-5 toward the first support body 660a-5 to cover at least a portion of the first battery cell 111 on one side of the first battery cell 111 in the lengthwise direction.

The first guide cover body may also extend from the first support body 660a-5 toward the first cover body 620a-5 to cover at least a portion of the first battery cell 111 on one side of the first battery cell 111 in the lengthwise direction.

The first connection body may connect the first end cover body and the first guide cover body, and may have a thickness that is greater than a thickness of the first partition body 610a-5 in the widthwise direction.

The second end cover body may extend from the second cover body 620b-5 toward the second support body 660b-5 to cover at least a portion of the second battery cell 112 on one side of the second battery cell 112 in the lengthwise direction.

The second guide cover body may extend from the second support body 660b-5 toward the second cover body 620b-5 to cover at least a portion of the second battery cell 112 on one side of the second battery cell 112 in the lengthwise direction.

The second connection body may connect the second end cover body and the second guide cover body, and may have a thickness that is greater than a thickness of the second partition body 610b-5 in the widthwise direction.

The first end cover body and the second end cover body may be in contact with each other, and the first guide cover body and the second guide cover body may be in contact with each other.

The first end cover body and the second end cover body may overlap each other, and the first guide cover body and the second guide cover body may overlap each other.

As will be described below, the first end cover body and the second end cover body may be coupled to each other, and the first guide cover body and the second guide cover body may be coupled to each other.

A thickness of the first end cover body in a height direction and a thickness of the first guide cover body in a height direction may be thicker than a thickness of the first cover body 620a-5 in a height direction, and a thickness of the second end cover body in a height direction and a thickness of the second guide cover body in a height direction may be thicker than a thickness of the second cover body 620b-5.

According to the structure, the first partition body 610a-5 and the second partition body 610b-5 may isolate the first battery cell 111 from the second battery cell 111, the first cover body 620a-5 may cover one side (Z direction) in the height direction of the first battery cell 111, and the second cover body 620b-5 may cover one side (Z direction) in the height direction of the second battery cell 112.

Furthermore, according to the structure of the first and second end cover bodies, the first and second guide cover bodies, and the second guide cover bodies, even if pressure is applied to the first and second end cover bodies due to swelling in the battery cell 110, the relative positions of the first and second end cover bodies, the first and second guide cover bodies, and the partition member 600-5 may not be changed and deformed. Therefore, even if a fire occurs in the battery cell 110, a robust isolation structure of the plurality of the battery cells 110 may be maintained, and heat transfer between battery cells 110 may be delayed.

According to the structure of the first connection body and the second connection body, even if swelling occurs in the battery cell 110 and pressure is applied to the first connection body and the second connection body, the relative positions of the first connection body and the second connection body may not be changed and deformation may not be performed in the partition member 600-5, so that a robust isolation structure may be maintained. Therefore, the thermal transfer between the battery cells 110 may be delayed.

Similarly, although not separately illustrated in the drawings, the first battery cell 111 may include a first cell lead part 111a (see FIG. 26) that extends toward opposite sides of the battery cell stack 100 in the lengthwise direction, and the second battery cell 112 may include a second cell lead part 112a that extends toward opposite sides of the battery cell stack 100 in the lengthwise direction.

The first connection body may protrude from the first partition body 610a-5 toward the first cell lead part 111a, and the second connection body may protrude from the second partition body 610b-5 toward the second cell lead part 112a.

The first connection body may be spaced apart from the first cell lead part 111a, and the second connection body may be spaced apart from the second cell lead part 112a.

With the structure, even when a fire occurs in any one of the plurality of battery cells 110, the partition member 600-5 according to still another embodiment of the present disclosure may delay transfer of heat to another battery cell 110, in which a fire does not occur, due to the configuration of the first partition body 610a-5 and the second partition body 610b-5.

Furthermore, the partition member 600-5 according to still another embodiment of the present disclosure may also cover at least a portion of opposite sides of the plurality of battery cells 110 in the lengthwise direction. Accordingly, even when a fire occurs in any one of the plurality of battery cells 110, it is possible to prevent foreign substances or high-pressure fluid from being introduced into the battery cell 110 through an area, except for the cell lead parts 111a and 112a, on one side of another battery cell 110 in the lengthwise direction, in which a fire does not occur.

In addition, even if swelling occurs in the battery cell 110, the position of the cover end body, the guide end body, and the connection body may be prevented from changing or the cover end body, the guide end body, and the connection body may be prevented from deformation, so a solid isolation structure between the plurality of the battery cells 110 may be provided, and a thermal transfer between the plurality of the battery cells 110 may be delayed.

According to still another embodiment of the present disclosure, the battery cell stack 100 (see FIG. 1) may further include an end plate 400 that is disposed on one side of the plurality of battery cells 110 in the widthwise direction, and support members 1000.

A pair of end plates 400 may be provided and may be disposed parallel to each other. The plurality of battery cells 110 may be arranged between the pair of end plates 400 in the widthwise direction.

A support member 1000 may be disposed between the battery cell 110 located at one end in the widthwise direction, among the plurality of battery cells 110, and the end plate 400. The support member 1000 may cover one side of the battery cell 110 located at one end in the widthwise direction, among the plurality of battery cells 110.

That, the support member 1000 may cover one surface of the battery cell 110 located at one end in the widthwise direction, among the plurality of battery cells 110, which faces the end plate 400.

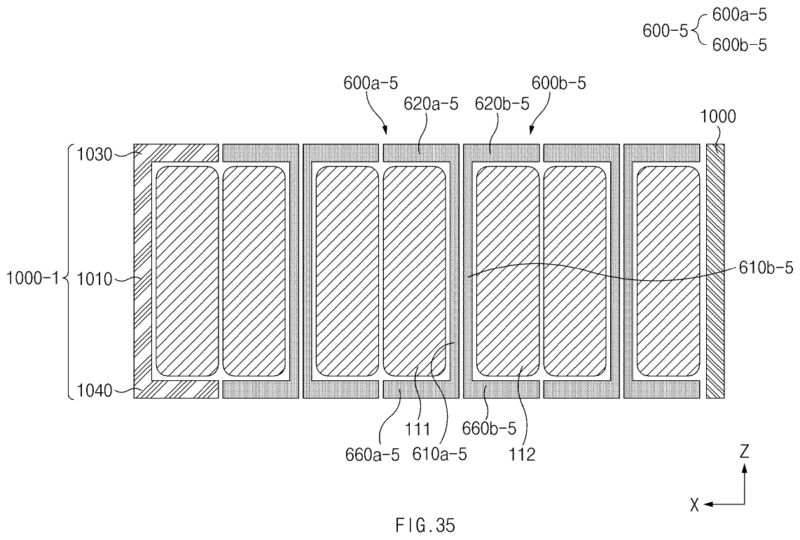

FIG. 35 is a longitudinal cross-sectional view of a partition member, battery cells, and a support member for illustrating a support member that is different from that of FIG. 34.

Referring to FIG. 35, the support member 1000-1 may have a shape that is different from a shape of the support member 1000. As an example, the support member 1000-1 may include the support partition body 1010, a first support cover body 1030, and a second support cover body 1040, unlike the support member 1000 that has only the support partition body 1010.

Both the support member 1000 and the support member 1000-1 may be disposed parallel to the cover body 620-3. Furthermore, the support member 1000 and the support member 1000-1 may both cover one side of the battery cell 110 located at one end with respect to the widthwise direction, among the plurality of battery cells 110.

The support partition body 1010 may be disposed between the battery cell 110 located at one end in the widthwise direction, among the plurality of battery cells 110, and the end plate 400. The support partition body 1010 may extend in the height direction.

The first support cover body 1030 may extend from the support partition body 1010 toward the first cover body 620a-5 or the second cover body 620b-5. However, although FIG. 35 illustrates that the first support cover body 1030 extends from one end of the support partition body 1010 in the height direction toward the first cover body 620a-5, the present disclosure is not limited thereto, and it is sufficient as long as it extends from the support partition body 1010.

The second support cover body 1040 may extend from one end of the support partition body 1010 toward the first support body 660a-5 or the second support body 660b-5. However, although FIG. 35 illustrates that the second support cover body 1040 extends from an opposite end of the support partition body 1010 in the height direction toward the first support body 660a-5, the present disclosure is not limited thereto, and it is sufficient as long as it extends from the support partition body 1010.

The support partition body 1010 may cover one surface of the battery cell 110 located at one end in the widthwise direction, among the plurality of battery cells 110, which faces one side in the widthwise direction.

The first support cover body 1030 may be disposed parallel to the first cover body 620a-5 or the second cover body 620b-5, and may cover one surface of the battery cell 110 located at one end in the widthwise direction, among the plurality of battery cells 110, which faces one side in the height direction.

The second support cover body 1040 may be disposed parallel to the first support body 660a-5 or the second support body 660b-5, and may cover an opposite surface of the battery cell 110 located at one end in the widthwise direction, among the plurality of battery cells 110, which faces an opposite side in the height direction.

The support partition body 610, the first support cover body 1030, and the second support cover body 1040 may be integrally formed.

The support member 1000 and the support member 1000-1 may be appropriately used depending on the number of battery cells 110. The support member 1000-1 may be used as one, and the support member 1000-1 may be used as two.

As an example, the support member 1000 may be used when, among the plurality of battery cells 110, the battery cell 110 located at one end in the widthwise direction is covered by the partition member 600-5, and the support member 1000-1 may be used when, among the plurality of battery cells 110, the battery cell 110 located at one end in the widthwise direction is not covered by the partition member 600-5.

Although not separately illustrated in the drawings, according to still another embodiment of the present disclosure, the battery cell stack 100 (see FIG. 1) may include the barrier member 800 (see FIG. 10).

The partition member 600-5 may include a first partition member 600a-5 that covers the first battery cell 111, and a second partition member 600b-5 that is provided parallel to the first partition member 600a-5 while covering the second battery cell 112.

According to still another embodiment of the present disclosure, the battery cell stack 100 may include the barrier member 800 that contacts i) at least one battery cell 110, among the first battery cell 111 and the second battery cell 112, or ii) the first partition member 600a-5 and the second partition member 600b-5.

The barrier member 800 may be formed of a material having heat insulation or fire resistance, or a material having thermal conductivity.

The barrier member 800 may be disposed between at least one battery cell 110, among the first battery cell 111 and the second battery cell 112 that are partitioned by the partition body 610-5, and the partition body 610-5.

The barrier member 800 may be provided i) between the first partition member 600-5 and the first battery cell 111, or ii) between the second partition member 600b-5 and the second battery cell 112, or iii) between the first partition member 600a-5 and the second partition member 600b-5.

The barrier member 800 may contact at least one of the first and second battery cells 111 and 112, or at least one of the first partition member 600a-5 and the second partition member 600b-5, to prevent a temperature of the first battery cell 111 or the second battery cell 112 from rising by improving thermal conductivity while securing fire resistance between the first battery cell 111 and the second battery cell 112.

Furthermore, although not separately illustrated in the drawings, the battery cell stack 100 may further include a cooling plate 850 (see FIG. 10) that is disposed between the first partition member 600a-5 and the second partition member 600b-5.

The cooling plate 850 may be disposed between the first partition member 600a-5 and the second partition member 600b-5 to cool the first partition member 600a-5 and the second partition member 600b-5, or the first battery cell 111 and the second battery cell 112. The cooling plate 850 may also be disposed between a pair of barrier members 800 that are disposed between the first partition member 600a-5 and the second partition member 600b-5.

The cooling plate 850 may be formed of a material having thermal conductivity. The cooling plate 850 may be formed of a material having heat dissipation properties. As an example, the cooling plate 850 may be formed of aluminum.

Furthermore, although not separately illustrated in the drawings, at least a portion of the partition body 610-5 may be replaced with the barrier member 800 (see FIG. 10) or the cooling plate 850.

Furthermore, instead of the barrier member 800 and the cooling plate 850, a surface-pressure member 860 (see FIG. 12) that applies a surface pressure to the battery cell 110 may be used.

The barrier member 800 or the cooling plate 850 may receive heat from the partition member 600 or the battery cell 110 in contact and exchange heat with a cooling channel formed inside the pack housing 1200 through the thermal interface material 200. Here, the cooling channel may mean a passage for cooling water to flow.

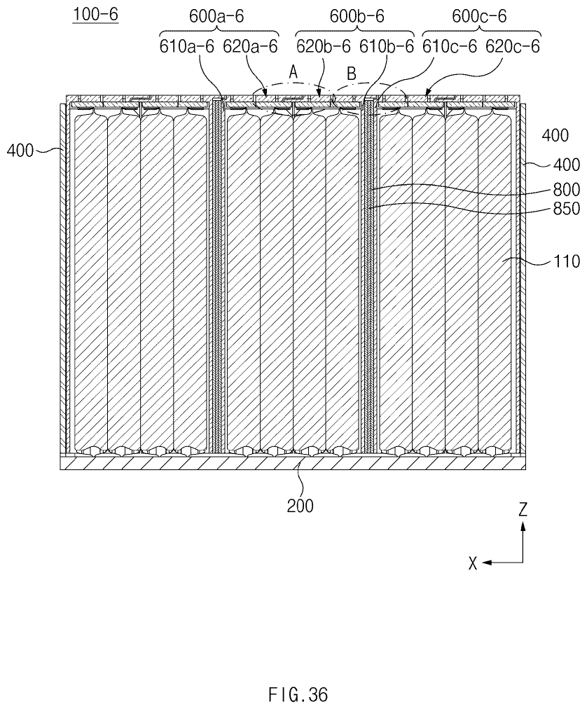

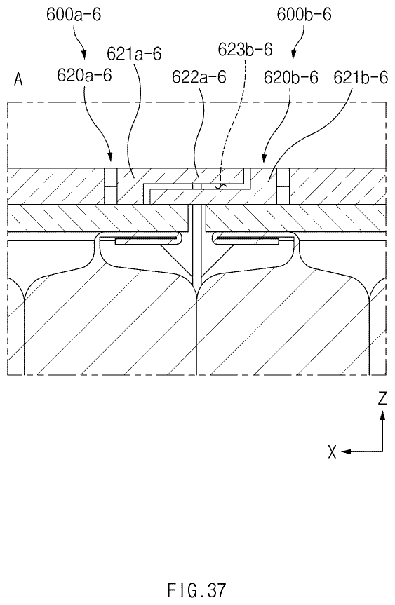

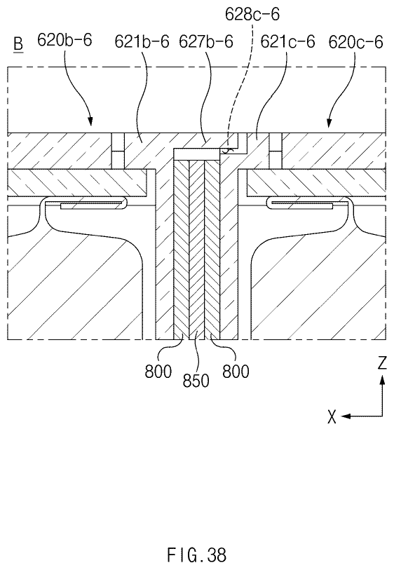

FIG. 36 is a longitudinal cross-sectional view of battery cell stack according to an embodiment of the present disclosure. FIG. 37 is an enlarged view of part A shown in FIG. 36. FIG. 38 is an enlarged view of part B shown in FIG. 36

Referring to FIG. 36, FIG. 37, and FIG. 38, the battery cell stack 100-6 may include a plurality of battery cells 110 arranged in a width direction (a direction opposite to the X direction or the X direction), and a plurality of partition members 600-6 disposed between the plurality of battery cells 110 and partitioning the plurality of battery cells 110.

A plurality of partition members 600-6 may include portions overlapping each other. For example, the partition member 600-6 may include a first partition member 600a-6, a second partition member 600b-6, and a third partition member 600c-6.

The first partition member 600a-6 may include a first partition body 610a-6 disposed between a pair of battery cells 110 among the plurality of the battery cells 110 and extending in a height direction (an opposite direction to the Z direction), and a first cover body 620a-6 extending from the first partition body 610a-6 in a width direction (an opposite direction to the Y direction or the Y direction) so as to cover one surface facing one side (Z direction) of the height direction of at least one of the pair of battery cells 110 partitioned by the first partition body 610a-6.

The second partition member 600b-6 may include a second partition body 610b-6 disposed in parallel with the first partition body 610a-6 and extending in a height direction (a direction opposite to the Z direction) and a second cover body 620b-6 extending from a second partition body 610b-6 in a width direction (a direction opposite to the Y direction or the Y direction), and provided on the other side of the first cover body 620a-6 in the width direction (a direction opposite to the X direction).

Although FIG. 36 illustrates that the first cover body 620a-6 and the second cover body 620b-6 extend in opposite directions from the first partition body 610a-6 and the second partition body 610b-6, the present invention is not limited thereto, and the shape of the partition member 600-6 may refer to the structure of the partition members 600, 600-1, 600-2, 600-3, 600-4, and 600-5 described above. That is, the overlapping structure between the partition members 600-6 to be described below may be applied to all of the partition members 600-1, 600-2, 600-3, 600-4, and 600-5 described above.

The third partition member 600c-6 may be disposed on the other side opposite to one side with respect to the second partition member 600b-6 where the first partition member 600a-6 is disposed on the one side of the second partition member 600b-6.

The third partition member 600c-6 may include a third partition body 610c-6 disposed in parallel with the second partition body 610b-6 and extending in a height direction (an opposite direction to the Z direction) a third cover body 620c-6 extending from the third partition body 610c-6 in a width direction (an opposite direction to the Y direction or the Y direction), and provided on the other side (an opposite direction to the X direction) of the width direction of the second cover body 620b-6.

A plurality of battery cells 110 may be provided between the first partition member 600a-6 and the second partition member 600b-6, the number of battery cells 110 disposed between the first partition member 600a-6 and the second partition member 600b-6 may not be limited to four, and at least one battery cell 110 may be provided.

In addition, between the second partition member 600b-6 and the third partition member 600c-6, the barrier member 800 formed of a material having heat insulation or fire-resistance, or a cooling plate (850) formed of a material having thermal conductivity may be placed.

For example, a pair of barrier members 800 may be provided between the second partition member 600b-6 and the third partition member 600c-6, and a cooling plate 850 may be provided between the pair of barrier members 800.

However, this invention may not be limited thereto, and it is sufficient if a barrier member 800 or a cooling plate 850 may be provided between the second partition member 600b-6 and the third partition member 600c-6.

Referring to FIG. 37, the first partition member 600a-6 and the second partition member 600b-6 may include portions overlapping each other. At least one of the first cover body 620a-6 and the second cover body 620b-6 may include a portion protruding toward the other. At least a portion of the first cover body 620a-6 may overlap the second cover body 620b-6.

For example, the first cover body 620a-6 may include a portion protruding toward the second cover body 620b-6.

For example, the first cover body 620a-6 may include a first cover body area 621a-6 disposed on one side (Z direction) in the height direction of the battery cell 110, and a first cover protrusion area 622a-6 protruding from the first cover body area 621a-6 toward the second cover body 620b-6.

For example, the second cover body 620b-6 may include a second cover body area 621b-6 disposed on one side (in the opposite direction to the X direction) in the width direction of the first cover body area 621a-6, and a second cover insertion groove 623b-6 formed on the second cover body area 621b-6 and into which the first cover protrusion area 622a-6 is inserted.

Referring to FIG. 37, the first cover body 620a-6 may further include a first cover insertion groove 623 formed on the first cover body area 621a-6, and the second cover body 620b-6 may further include a second cover protrusion area 622b protruding from the second cover body area 621b-6 toward the first cover insertion groove 623.

The first cover insertion groove 623 may be formed in a shape that is open toward the second cover body area 621b-6, and the second cover insertion groove 623b-6 may be formed in a shape that is open toward the first cover body area 621a-6.

In addition, the first cover protrusion area 622a-6 and the second cover protrusion area 622b may have a tapered shape in opposite directions.

According to this structure, since the first cover body 620a-6 and the second cover body 620b-6 may be engaged and overlapped with each other, even if pressure is applied to the first cover body 620a-6 and the second cover body 620b-6 by swelling of the battery cell 110, the first cover body 620a-6 and the second cover body 620b-6 may be prevented from being spaced apart from each other.

Therefore, according to another embodiment of the present invention, even if a fire occurs in the battery cells 110, a solid isolation structure between the battery cells 110 may be maintained, and a thermal transfer between the battery cells 110 may be delayed.

Meanwhile, as shown in FIG. 38, at least one of the second partition member 600b-6 and the third partition member 600c-6 may protrude toward the other.

For example, the second cover body 620b-6 may include a portion protruding toward the third cover body 620c-6.

The third cover body 620c-6 may include a third cover body area 621c-6 disposed on one side (in a direction opposite to the X direction) in the width direction of the second cover body area 621b-6, and a cover seating groove 628c-6 formed on the third cover body area 621c-6.

The second cover body 620b-6 may include a cover seating area 627b-6 protruding from the second cover body area 621b-6 toward the third cover body area 621c-6 and inserted into the cover seating groove 628c-6.

The length of the cover seating area 627b-6 in the width direction (i.e., the direction opposite to the X direction) may be shorter than the length of the first cover protruding area 622a-6 in the width direction (i.e., the direction opposite to the X direction).

This may be because a more robust structure is required between the first cover body 620a-6 and the second cover body 620b-6 than between the second cover body 620b-6 and the third cover body 620c-6.

According to the structure of the cover seating area 627b-6 and the cover seating groove 628c-6, the cover seating area 627b-6 may cover one side (Z direction) in the height direction of the blocking member 800 or one side (Z direction) in the height direction of the cooling plate 850.

According to this structure, not only one side (Z direction) in the height direction of the barrier member 800 and the cooling plate 850 that may be provided between the second partition member 600b-6 and the third partition member 600c-6 is covered, but also even if swelling occurs in the battery cell 110, a solid structure between the second partition member 600b-6 and the third partition member 600c-6 may not be shaken, thereby delaying the heat transfer between the battery cells 110.

The cover seating groove 628c-6 may be formed in a shape that is open toward the second cover body area 621b-6, or may be formed in a shape that is open toward one side (Z direction) in the height direction.

The cover seating groove 628c-6 described above may be applied to the structure of the first partition member 600a-6 as it is, and the first cover protrusion area 622a-6 and the first cover insertion groove 623 may be applied to the structure of the third partition member 600c-6 as it is.

Meanwhile, the partition member 600-6 of the battery cell stack 100-6 shown in FIG. 36, FIG. 37, and FIG. 38 may have a shape different from the shape of the partition member 600 of the battery cell stack 100 shown in FIG. 3.

For example, the partition member 600 may not include overlapping portions on one side (Z direction) in the height direction of the barrier member 800 or the cooling plate 850 disposed between the plurality of partition members 600, and the partition member 600-6 may not include overlapping portions on one side (Z direction) in the height direction of the blocking member 800 or the cooling plate 850 disposed between the plurality of partition members 600-6.

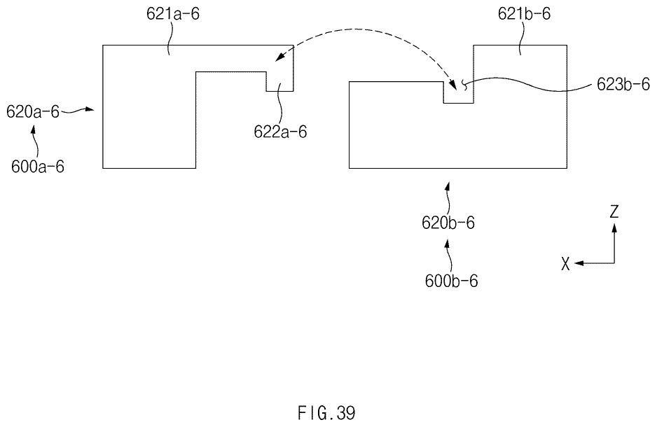

FIG. 39 is a front view of a first partition member and a second partition member according to another embodiment of the present invention when viewed in a longitudinal direction.

Referring to FIG. 39, the first cover body 620a-6 of the first partition member 600a-6 and the second cover body 620b-6 of the second partition member 600b-6 may differ from the structures of the first cover body 620a-6 of the first partition member 600a-6 and the second cover body 620b-6 of the second partition member 600b-6 shown in FIG. 36, and the description of FIG. 36, FIG. 37, and FIG. 38 are referred to in addition to the description described below.

For example, first cover body 620a-6 may be provided at a position overlapping the second cover body 620b-6. The first cover body 620a-6 may include a first cover body area 621a-6 and a first cover protrusion area 622a-6. The second cover body 620b-6 may include a second cover body area 621b-6 and a second cover insertion groove 623b-6.

The second cover insertion groove 623b-6 may be formed on the second cover body area 621b-6, and may be formed in a concave shape. The second cover insertion groove 623b-6 may be formed so that the second cover protrusion area 622a-6 is inserted. The second cover insertion groove 623b-6 may have a shape that is open toward one side (Z direction) in the height direction.

The first cover protrusion area 622a-6 may extend from the second cover body area 621a-6 toward the second cover body area 621b-6, and may be bent to be inserted into the second cover insertion groove 623b-6. That is, the first cover protrusion area 622a-6 may be inserted into and fixed to the second cover insertion groove 623b-6 by a snap fit method.

The first cover protrusion area 622a-6 may protrude from the first cover body area 621a-6 toward the second cover body area 621b-6, and may protrude to be seated in and fixed to the second cover insertion groove 623b-6.

As described above, the second cover insertion groove 623b-6 may have a concave shape toward one side in the width direction as shown in FIG. 37, or may have a concave shape toward one side (Z direction) in the height direction as shown in FIG. 39.

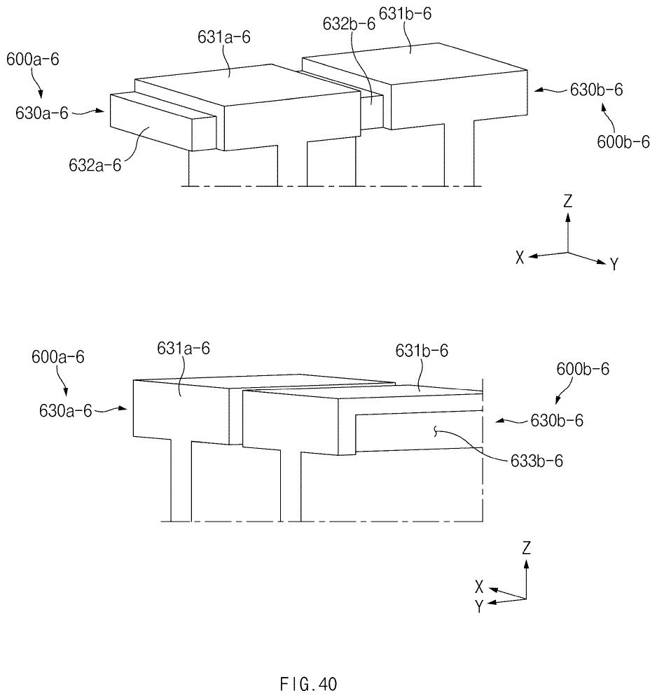

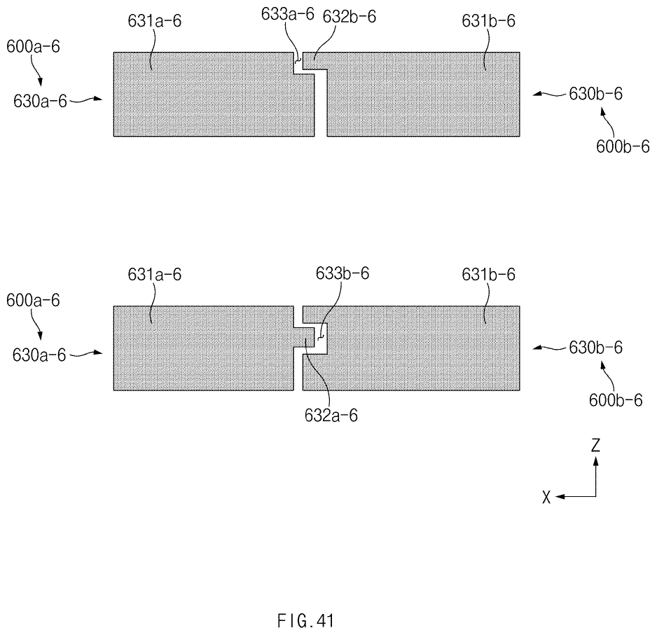

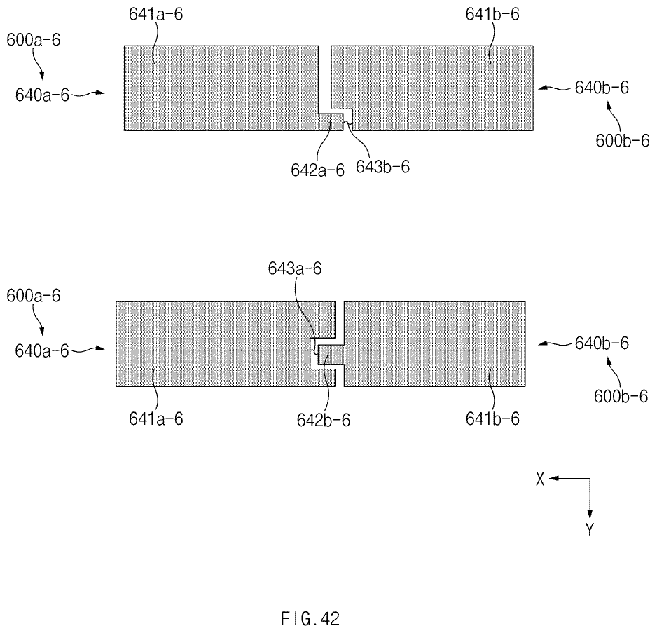

FIG. 40 is a perspective view of a first end cover body of a first partition member and a second end cover body of a second partition member according to an embodiment of the present disclosure. FIG. 41 is a longitudinal cross-sectional view of a first partition member and a second partition member when a first end cover body of the first partition member and a second end cover body of the second partition member are coupled to each other. FIG. 42 is a horizontal cross-sectional view of a first partition member and a second partition member when a first guide cover body of the first partition member and a second guide cover body of the second partition member are coupled to each other.

Referring to FIG. 40, FIG. 41, FIG. 42, and as shown in FIG. 6, the first end cover body 630a-6 (see FIG. 36) of the first partition member 600a-6 may extend from the first cover body 620a-6 to an opposite side (an opposite direction to the Z-direction) in the height direction on one side of the battery cell 110 covered by the first cover body 620 in the lengthwise direction.

The first end cover body 630a-6 may extend from the first cover body 620a-6 to cover at least a portion of the battery cell 110 partitioned by the first partition body 610a-6 on one side of the battery cell 110 partitioned by the first partition body 610a-6 in the lengthwise direction.

The second end cover body 630b-6 of the second partition member 600b-6 may extend from the second cover body 620b-6 to an opposite side (an opposite direction to the Z-direction) in the height direction on one side of the battery cell 110 covered by the second cover body 620b-6 in the lengthwise direction.

The second end cover body 630b-6 may extend from the second cover body 620b-6 to cover at least a portion of the battery cell 110 partitioned by the second partition body 610b-6 on one side of the battery cell 110 partitioned by the second partition body 610b-6 in the lengthwise direction.

The first end cover body 630a-6 and the second end cover body 630b-6 may be disposed parallel to each other.

When the first partition member 600a-6 and the second partition member 600b-6 are viewed while being spaced apart from each other in the height direction of the plurality of battery cells 110, the first end cover body 630a-6 may be provided at a position that overlaps the second end cover body 630b-6.

As an example, the first end cover body 630a-6 may include a first end body area 631a-6, a first end protrusion area 632a-6 that protrudes from the first end body area 631a-6 toward the second end cover body 630b-6, or a first end cover recess 633a-6 that is formed on the first end body area 631a.-6

The second end cover body 630b-6 may include a second end body area 631b-6, a second end cover protrusion area 632b-6 that protrudes from the second end body area 631b-6 toward the first end cover body 630a-6, or a second end cover recess 633b-6 that is formed on the second end

body area 631b-6.

The first end cover body 630a-6 may include a first end protrusion area 632a-6 that is formed on one side in the widthwise direction, and a first end cover recess 633a-6 that is formed on an opposite side in the widthwise direction.

The second end cover body 630b-6 may include a second end cover area 632b-6 that is formed on one side in the widthwise direction, and a second end cover recess 633b-6 that is formed on an opposite side in the widthwise direction.

The first end protrusion area 632a-6 and the second end protrusion area 632b-6 may protrude from the first end body area 631a-6 and the second end body area 631b-6, respectively, in the same direction.

The second end protrusion area 632b-6 may be inserted into the first end cover recess 633a-6. The first end protrusion area 632a-6 may be inserted into the second end cover recess 633b-6.

With this structure, the second end cover body 630b-6 and the first end cover body 630a-6 may improve a delay of heat transfer to the battery cell 110, in which no fire occurs, due to external foreign substances or high-pressure fluid introduced from one side of the battery cell stack 100 in the height direction, even when the battery cell 110 swells.

Furthermore, the structure in which the first end cover body 630a-6 and the second end cover body 630b-6 overlap each other may prevent the first end cover body 630a-6 and the second end cover body 630b-6 from being separated even if pressure is applied to the first end cover body 630a-6 and the second end cover body 630b-6.

Therefore, even if a fire occurs in the battery cell 110, a solid isolation structure between the plurality of battery cells 110 may be maintained, and a thermal transfer between the plurality of battery cells 110 may be delayed.

The first structure or the second structure of FIG. 41 may be selected depending on a coupling direction of the first end cover body 630a-6 and the second end cover body 630b-6.

Furthermore, the first guide cover body 640a-6 may be disposed parallel to the first end cover body 630a-6 on one side of the battery cell 110 covered by the first cover body 620a in the lengthwise direction.

The second guide cover body 640b-6 may be disposed parallel to the second end cover body 630b-6 on one side of the battery cell 110 covered by the second cover body 620b-6 in the lengthwise direction.

When the first partition member 600a-6 and the second partition member 600b-6 are viewed while the first guide cover body 640a-6 and the second guide cover body 640b-6 are spaced apart from each other in the lengthwise direction of the plurality of battery cells 110, at least a portion of the first guide cover body 640a-6 may be provided at a position that overlaps the second guide cover body 640b-6.

The first guide cover body 640a-6 may include a first guide body area 641a-6, a first guide protrusion area 642a-6 that protrudes from the first guide body area 641a-6 toward the second guide cover body 640b-6, or a first guide cover groove 643a-6 that is formed on the first guide body area 641a-6.

The second guide cover body 640b-6 may include a second guide body area 641b-6, a second guide protrusion area 642b-6 that protrudes from the second guide body area 641b-6 toward the first guide cover body 640a-6, or a second guide cover groove 643b-6 that is formed on the second guide body area 641b-6.

The first guide cover body 640a-6 may include a first guide protrusion area 642a-6 that is formed on one side of the first guide body area 641a-6 in the widthwise direction, and a first guide cover groove 643a-6 that is formed on an opposite side of the first guide body area 641a-6 in the widthwise direction.

The second guide cover body 640b-6 may include a second guide protrusion area 642b-6 that is formed on one side of the second guide body area 641b-6 in the widthwise direction, and a second guide cover groove 643b-6 that is formed on an opposite side of the second guide body area 641b-6 in the widthwise direction.

The first guide protrusion area 642a-6 and the second guide protrusion area 642b-6 may protrude from the first guide body area 641a-6 and the second guide body area 641b-6, respectively, in the same direction.

The second guide protrusion area 642b-6 may be inserted into the first guide cover groove 643a-6. The first guide protrusion area 642a-6 may be inserted into the second guide cover groove 643b-6.

With this structure, the second guide cover body 640b-6 and the first guide cover body 640a-6 may improve a delay of heat transfer to the battery cell 110, in which no fire occurs, due to external foreign substances or high-pressure fluid introduced from one side of the battery cell stack 100 in the lengthwise direction, even when the battery cell 110 swells.

In addition, the structure in which the first guide cover body 640a-6 and the second guide cover body 640b-6 overlap each other may prevent the first guide cover body 640a-6 and the second guide cover body 640b-6 from being separated even if pressure is applied due to swelling in the battery cell 110.

Therefore, even if a fire occurs in the battery cell 110, a solid isolation structure between the plurality of battery cells 110 may be maintained, and a thermal transfer between the plurality of battery cells 110 may be delayed.

The first structure or the second structure of FIG. 42 may be selected depending on a coupling direction of the first guide cover body 640a-6 and the second guide cover body 640b-6.

An overlapping relationship between the first end cover body 630a-6 and the second end cover body 630b-6 and an overlapping relationship between the first guide cover body 640a-6 and the second guide cover body 640b-6 are not limited to the partition member 600-6 according to an embodiment of the present disclosure, and may also be applied to the partition members 600, 600-1, 600-2, 600-3, 600-4, and 600-5.

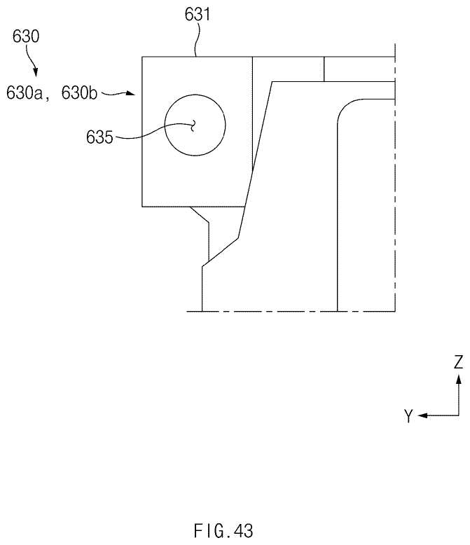

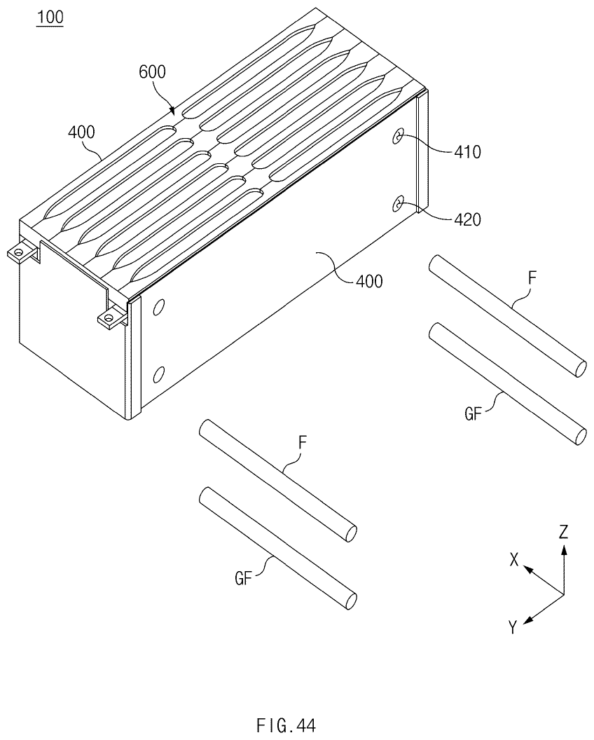

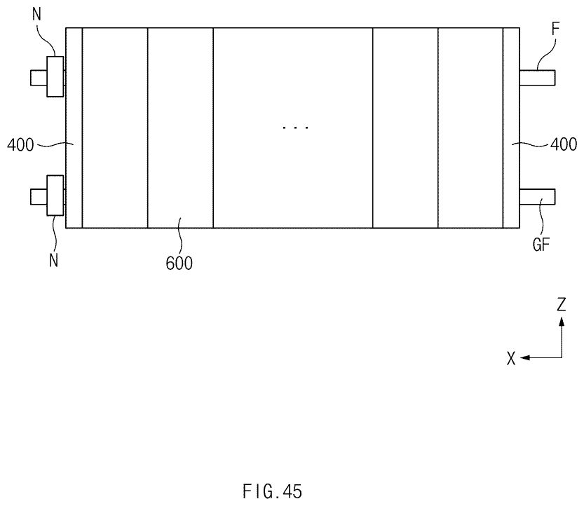

FIG. 43 is a side view of an end cover body viewed in a widthwise direction according to still another embodiment of the present disclosure. FIG. 44 is an exploded perspective view illustrating a state, in which a coupling member and a guide coupling member are spaced apart from an end plate of a battery cell stack, according to still another embodiment of the present disclosure. FIG. 45 is a side view of a partition member, a coupling member, a guide coupling member, and a nut member of a battery cell stack viewed in a lengthwise direction according to still another embodiment of the present disclosure.

Referring to FIG. 43, FIG. 44, and FIG. 45, the plurality of partition members 600 may include coupling holes 635 that are formed on areas that face each other. The coupling hole 635 may be formed in the end cover body 630 of each of the plurality of partition members 600. The coupling hole 635 may be formed on an end body area 631 of the end cover body 630. The coupling hole 635 may be formed to pass in the widthwise direction of the end body area 631.

As described above, the first partition member 600a (see FIG. 8) may include a first end cover body 630a. The second partition member 600b may include a second end cover body 630b. The first partition member 600a and the second partition member 600b may be disposed in parallel with each other.

The first end cover body 630a, as described above, may protrude from the first cover body 620a to an opposite side (an opposite direction to the Z-direction) in the height direction on one side of the battery cell 110 covered by the first cover body 620a in the lengthwise direction.

The second end cover body 630b, as described above, may protrude from the second cover body 620b to an opposite side (an opposite direction to the Z-direction) in the height direction on one side of the battery cell 110 covered by the second cover body 620b in the lengthwise direction.

The first end cover body 630a and the second end cover body 630b may both include a coupling hole 635. The coupling hole 635 may have a shape that is open toward a width direction (a direction opposite to the X direction or the X direction). The coupling hole 635 of the first end cover body 630a and the coupling hole 635 of the second end cover body 630b may be formed at positions that face each other.

Furthermore, the first partition member 600a may further include a first guide cover body 640a. The first guide cover body 640a may be disposed parallel to the first end cover body 620a to cover the battery cell 110 covered by the first cover body 620a, and may include a guide hole (not illustrated).

The second partition member 600b may further include a second guide cover body 640b. The second guide cover body 640b may be spaced apart from the second end cover body 620b in the height direction to cover the battery cell 110 that is covered by the second cover body 620b, and may include a guide hole (not illustrated).

A guide hole of the first guide cover body 640a and a guide hole of the second guide cover body 640b may be formed at positions that face each other.

The battery cell stack 100 may include end plates 400 that are provided on opposite sides of the plurality of battery cells 110 in the widthwise direction.

The end plate 400 may include an end hole 410 that is formed at a position that faces the coupling hole 635 of the first end cover body 630a or the coupling hole 635 of the second end cover body 630b.

The end plate 400 may include a guide end hole 420 that is formed at a position that faces the guide hole of the first guide cover body 640a or the guide hole of the second guide cover body 640b.

The battery cell stack 100 may include a coupling member F that passes through both the end hole 410 and the coupling hole 635 to fix the end plate 400 and the partition member 600 together.

The coupling member F may pass through at least one of the end holes 410 of the pair of end plates 400 and at least one of the coupling hole 635 of the first end cover body 630a and the coupling hole 635 of the second end cover body 630b to fix the end plate 400 and the partition member 600 together.

The battery cell stack 100 may include a guide coupling member GF that passes through both the guide end hole 420 and the guide hole to fix the end plate 400 and the partition member 600 together.

The guide coupling member GF may pass through at least one of the guide hole of the first guide cover body 640a and the guide hole of the second guide cover body 640b and at least one of the guide end holes 420 of the end plate 400 to fix the pair of end plates 400 and the partition member 600 together.

The battery cell stack 100 may include a nut member N that is coupled to the coupling member F and the guide coupling member GF to fix positions of the coupling member F and the guide coupling member GF.

With the structure, the battery cells 110 may be prevented from swelling in an interior of the battery cell stack 100, and external foreign substances or high-pressure fluid may be prevented from being introduced into the battery cells 110 as a distance between the plurality of partition members 600 becomes larger due to the swelling.

Accordingly, the battery cell stack 100 may delay heat transfer from the battery cell 110, in which a fire occurs, to the battery cell 110, in which no fire occurs.

In addition, according to this structure, even if swelling occurs in the battery cell 110, the isolation of the plurality of the battery cells 110 may be maintained by a solid structure, so that heat transfer between the plurality of battery cells 110 may be delayed.

As described above, the plurality of partition members 600 of the battery cell stack 100 may include coupling holes 635 or guide holes that are formed on areas that face each other.

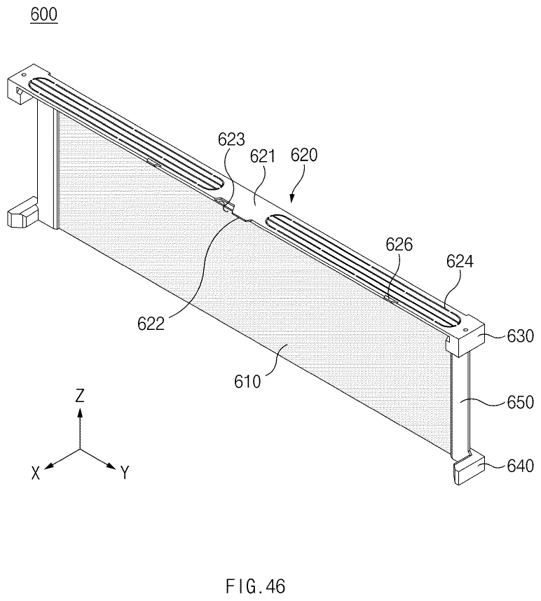

FIG. 46 is a perspective view illustrating that one surface of a partition member is formed of a material having thermal conductivity or a material having heat insulating property according to an embodiment of the present disclosure.

Referring to FIG. 46, one surface of the partition body 610 of the partition member 600 may be formed of a material that has thermal conductivity or a material that has thermal insulation.

One surface of the partition body 610 may be a surface that faces at least one of the pair of battery cells 110 (see FIG. 3) partitioned by the partition body 610.

As an example, according to an embodiment of the present disclosure, one surface of the first partition body 610a (see FIG. 9), which faces the first battery cell 111, or one surface of the second partition body 610b, which faces the second battery cell 112, may be formed of a material that has thermal conductivity or a material that has thermal insulation or fire resistance.

As an example, according to another embodiment of the present disclosure, one surface of the partition body 610-1 (see FIG. 17), which faces at least one of the pair of battery cells 111 and 112, may be formed of a material that has thermal conductivity or a material that has thermal insulation or fire resistance.

As an example, according to another embodiment of the present disclosure, one surface of the partition body 610-2 (see FIG. 24), which faces the first battery cell 111, may be formed of a material that has thermal conductivity or a material that has thermal insulation or fire resistance.

As an example, according to another embodiment of the present disclosure, one surface of the partition body 610-3 (see FIG. 30), which faces the first battery cell 111, may be formed of a material that has thermal conductivity or a material that has thermal insulation or fire resistance.

As an example, according to another embodiment of the present disclosure, one surface of the partition body 610-4 (see FIG. 32), which faces at least one of the pair of battery cells 111 and 112, may be formed of a material that has thermal conductivity or a material that has thermal insulation or fire resistance.

As an example, according to another embodiment of the present disclosure, one surface of the first partition body 610a-5 (see FIG. 34), which faces the first battery cell 111, or one surface of the second partition body 610b-5, which faces the second battery cell 112, may be formed of a material that has thermal conductivity or a material that has thermal insulation or fire resistance.

For example, one surface of the first partition wall body 610a-6 (see FIG. 36) facing the battery cell 110 or the other surface of the second partition wall body 610b-6 facing the battery cell 110 according to another embodiment of the present invention may be formed of a material having thermal conductivity or a material having heat insulation or fire resistance.

With this structure, heat transfer between the plurality of battery cells 110 stacked in the widthwise direction may be delayed.

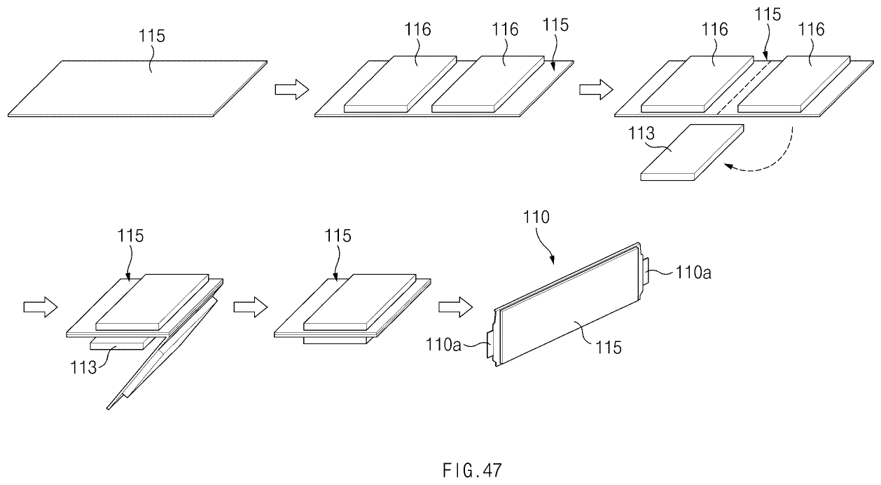

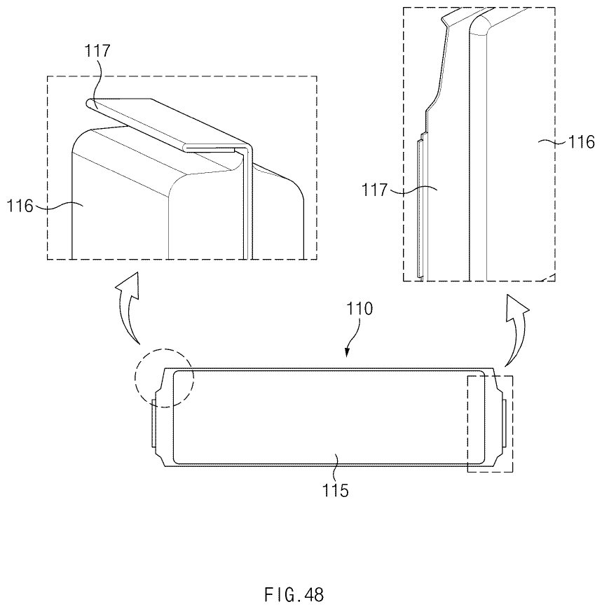

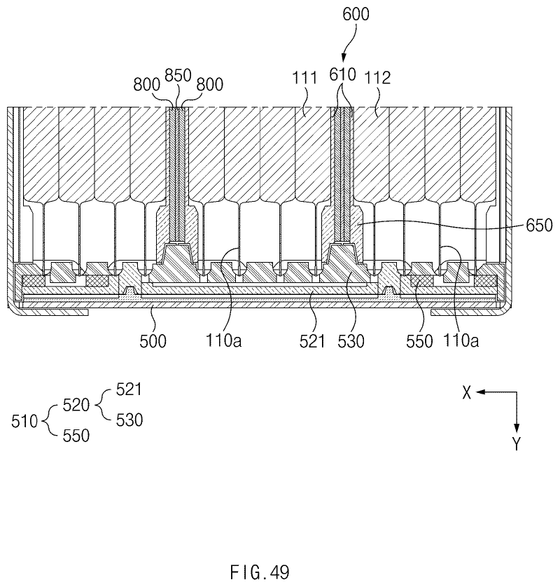

FIG. 47 is a view illustrating a manufacturing process of a battery cell according to an embodiment of the present disclosure. FIG. 48 is an enlarged view of a cover of a battery cell according to an embodiment of the present disclosure. FIG. 49 is a transverse cross-sectional view of a battery cell stack according to an embodiment of the present disclosure.

Referring to FIG. 47, FIG. 48, and FIG. 49, the battery cell 110 may include an electrode stack 113 that includes a first electrode, a second electrode that has a polarity different from that of the first electrode, and a separator that is provided between the first electrode and the second electrode, and a case 115 that surrounds the electrode stack 113.

The case 115 may include a packaging area 116 that surrounds the electrode stack 113 including the first electrode, the second electrode, and the separator, and extension areas 117 that extend from the packaging area 116 to opposite sides in the lengthwise direction.

As an example, the case 115 may be formed of aluminum. The packaging area 116 of the case 115 is a part that is pressed by a mold in a process of manufacturing the battery cell 110, and may be formed to be thinner than an unpressed part so that durability may be weak.

A circumferential portion of the packaging area 116 needs to be protected so that the battery cell 110 may prevent external foreign substances or high-pressure fluid from being introduced into the electrode stack 113.

To this end, opposite surfaces of the packaging area 116 in the height direction may be covered by the cover bodies 620, 620-1, 620-2, 620-3, 620-4, 620a-5, 620b-5, 620a-6, 620b-6, and 620c-6 of the above-described partition members 600, 600-1, 600-2, 600-3, 600-4, 600-5, and 600-6, and the heat transfer material 200 (see FIG. 3), and the support bodies 660-3 and 660-4.

Furthermore, to cover opposite surfaces of the packaging area 116 in the lengthwise direction, opposite sides of the packaging area 116 in the lengthwise direction may be bent to one side or an opposite side in the widthwise direction. The extension area 117 of the battery cell 110 may partially cover the packaging area 116 on one side of the electrode stack 113 in the lengthwise direction.

Accordingly, a portion of a circumferential part of the packaging area 116 of the battery cell 110, except for a portion covered by the extension area 117, may also need to be covered.

To this end, to cover opposite sides of the plurality of battery cells 110 in the lengthwise direction, the battery cell stack 100 may utilize a sensing assembly 510 and a sensing cover 500.

The sensing assembly 510 may include a busbar that is electrically connected to the plurality of battery cells 110, and a sensing frame 520 that supports the busbar. The sensing cover 500 may cover an outer side of the sensing assembly 510.

The sensing frame 520 may include a frame body area 521 that supports a busbar 525 while facing the plurality of battery cells 110, and a frame partition area 530 that protrudes from the frame body area 521 toward the partition member 600.

The frame partition area 530 may extend from the frame body area 521 toward the partition body 610. The frame partition area 530 may contact the connection body 650. The connection body 650 may be a part that protrudes from the partition body 610 in the widthwise direction.

Among the plurality of battery cells 110, each of the pair of battery cells 110 that are partitioned by the partition member 600 may include a cell lead part 110a that extends toward one side in the lengthwise direction.

The frame partition area 530 may be provided between cell lead parts 110a of the pair of battery cells 110.

A plurality of frame partition areas 530 may also be provided, and all the plurality of frame partition areas 530 may be provided between the pair of cell lead parts 110a. The frame partition area 530 may cover an area of one side of the pair of battery cells 110 in the lengthwise direction, except for the cell lead part 110a.

FIG. 49 illustrates the partition member 600 according to an embodiment of the present disclosure, but the sensing assembly 510 and the sensing cover 500 may be applied together with the partition members 600-1, 600-2, 600-3, 600-4, 600-5, and 600-6.

With the structure, because the packaging area 116 of the battery cell 110 may be covered by the cover bodies 620, 620-1, 620-2, 620-3, 620-4, 620a-5, 620b-5, 620a-6, 620b-6, and 620c-6 of the partition members 600, 600-1, 600-2, 600-3, 600-4, 600-5, and 600-6 the heat transfer material 200 (see FIG. 3), the support bodies 660-3 and 660-4, and the sensing assembly 510, safety of the battery cell stack 100 may be improved.

Meanwhile, the frame partition area 530 may have a part, of which a cross section on a plane that is perpendicular to a direction that becomes more distant from the battery cell 110 from one end that faces the battery cell 110 becomes wider as it goes in the direction that becomes more distant from the battery cell 110.

With the structure, because the cell lead part 110a may be guided toward the frame body area 521 along an inclined shape of the frame partition area 530 even when the cell lead part 110a contacts one end of the frame partition area 530, manufacturing performance of the battery cell stack 100 may be improved.

Furthermore, with the structure, because a circumferential portion of the packaging area 116, except for the cell lead part 110a, on one side of the battery cell 110 in the lengthwise direction may be covered by the frame body area 521 and the frame partition area 530, foreign substances or high-pressure fluid outside the battery cell stack 100 may be prevented from being introduced along the lengthwise direction of the battery cell 110, so that transfer of heat to the battery cell 110 may be delayed.

The structure of the battery cell 110 and the structure of the sensing assembly 510 described above may be used together with not only the partition member 600 according to an embodiment of the present disclosure, but also the partition member 600-1 according to another embodiment of the present disclosure or the partition members 600-2, 600-3, 600-4, 600-5, and 600-6 according to still another embodiment of the present disclosure.

FIG. 50 is a transverse cross-sectional view of battery cells, a partition member, and a sensing assembly according to another embodiment of the present disclosure.

Referring to FIG. 50, the sensing frame 520 of the battery cell stack 100 (see FIG. 1) according to another embodiment of the present disclosure may further include a frame guide area 540 in addition to the components of FIG. 49.

The frame guide area 540 may protrude from the frame partition area 530 toward the battery cell 110.

The plurality of battery cells 110 may each include cell lead parts 110a that extends to opposite sides of the battery cell stack 100 in the lengthwise direction.

In this case, the frame guide area 540 may be disposed between the cell lead parts 110a of the plurality of battery cells 110 and may be spaced apart from the cell lead part 110a of each of the plurality of battery cells 110.

The frame guide area 540 may include one end that faces the battery cell 110. One end of the frame guide area 540 may be disposed at a position that is closer to the battery cell 110 than one end of the frame partition area 530, which faces the battery cell 110.

Meanwhile, the frame guide area 540 may also have a part, of which a cross section on a plane that is perpendicular to a direction that becomes more distant from the battery cell 110 from one end that faces the battery cell 110 becomes wider as it goes in the direction that becomes more distant from the battery cell 110.

With the structure, even when the pair of cell lead parts 110a provided between the pair of frame partition areas 530 contact one end of the frame guide area 540, it may be guided toward the frame body area 521 that is an appropriate position along an inclined surface of the frame guide area 540.

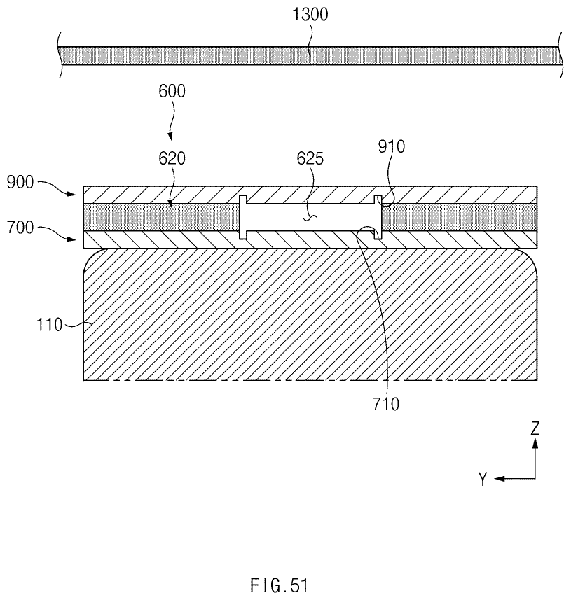

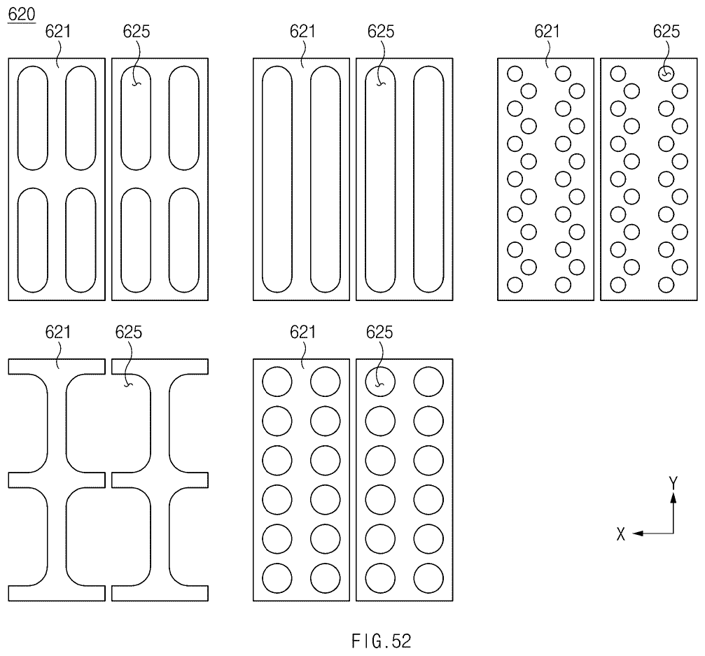

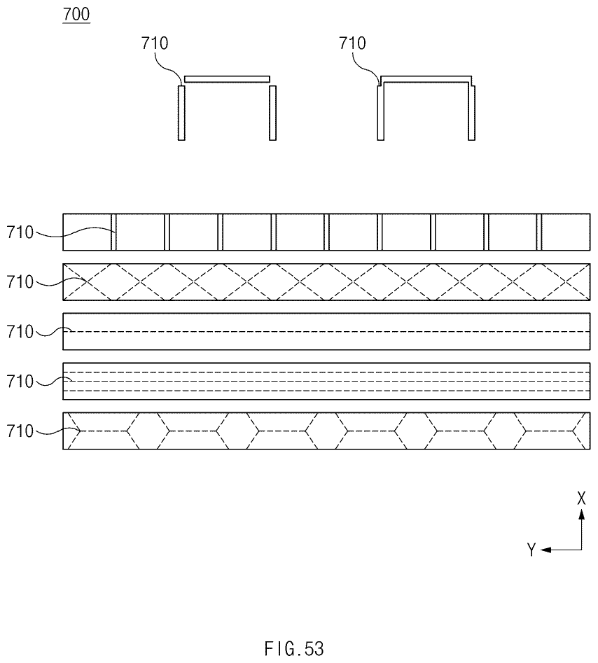

FIG. 51 is a longitudinal cross-sectional view of other battery cells, an inner fire-resistant member, a partition member, and an outer fire-resistant member according to an embodiment of the present disclosure. FIG. 52 is a plan view of a cover body including a cover venting hole according to various embodiments of the present disclosure. FIG. 53 illustrates a side view and a plan view of a fire-resistant member including a cover notch part viewed in a lengthwise direction according to various embodiments of the present disclosure.

Referring to FIG. 51, FIG. 52, and FIG. 53, the cover body 620 of the partition member 600 may include a cover venting hole 625 that is formed on an area that faces the battery cell 110. The cover venting hole 625 may be a hole for venting foreign substances or high-pressure fluid from the battery cell 110, in which a fire occurs to the outside of the battery cell stack 100.

An inner fire-resistant member 700 may be provided between the cover body 620 and the battery cell 110, and may include an inner notch part 710 that is formed on an area that faces the cover notch part 624 (see FIG. 3) or the cover venting hole 625, and has a thickness that is smaller than a peripheral thickness or has a cut shape.

In addition, the cover body 620 and a pack cover 1300 may be provided with an outer fire-resistant member 900. The outer fire-resistant member 900 may include an outer notch part 910 that is formed on an area that faces the cover venting hole 625 or the cover notch part 624, and has a thickness that is smaller than a peripheral thickness or has a cut shape.

As such, the battery cell stack 100 may further include an outer fire-resistant member 900 that is disposed outside the cover body 620.

When a fire occurs in the battery cell 110, the inner notch part 710 of the inner fire-resistant member 700 may be cut along a boundary line of the cover venting hole 625 or the cover notch part 624 due to pressure caused by the fire.

When the inner notch part 710 is cut, the outer notch part 910 may also be cut, and the battery cell 110 and the outside of the battery cell stack 100 (see FIG. 1) may communicate with each other.

Accordingly, foreign substances or high-pressure fluid caused by fire may be vented to the pack cover 1300 outside the battery cell stack 100, and transfer of heat to another battery cell 110 that is adjacent to the battery cell 110, in which a fire occurs, may be delayed.

As illustrated in FIG. 52, the cover venting hole 625 may have different shapes according to various embodiments. The cover venting hole 625 may be formed on the cover body area 621 of the cover body 620. The cover venting hole 625 may be formed to pass through the cover body area 621 in a direction that is perpendicular to the cover body area 621.

As an example, the cover venting hole 625 may have an elliptical shape such that the lengthwise direction of the battery cell 110 becomes a direction of a major axis.

As an example, a plurality of cover venting hole 625 may be formed and may have a circular shape.

As an example, a pair of adjacent cover body areas 621 may be formed together in the cover venting hole 625. The cover venting hole 625 may be formed in a substantially rectangular shape, of which corner portions are rounded.

As illustrated in FIG. 53, the inner fire-resistant member 700 may be formed in shapes according to various embodiments.

As an example, the inner notch part 710 of the inner fire-resistant member 700 may have a shape that is cut while surrounding a specific extent, or may have a thickness that is smaller than a peripheral thickness while surrounding a specific extent.

As an example, the inner notch part 710 may be formed in a rectangular shape that is formed in the lengthwise direction of the inner fire-resistant member 700 and the widthwise direction of the inner fire-resistant member 700.

As an example, the inner notch parts 710 may extend to cross each other, and may be formed along an “X” shape when the inner fire-resistant member 700 is viewed while being spaced apart from the inner fire-resistant member 700.

As an example, the inner notch part 710 may extend along a straight line along the lengthwise direction of the inner fire-resistant member 700.

As an example, the inner notch part 710 may extend along a straight line along the lengthwise direction of the inner fire-resistant member 700, and a plurality of inner notch parts 710 may be provided to be spaced apart from each other in the widthwise direction.

As an example, the inner notch part 710 may extend in the lengthwise direction such that a central area of the inner fire-resistant member 700 is cut, and may be formed to branch at both ends thereof.

The shapes of the cover venting hole 625 and the inner notch part 710 illustrated in FIG. 52 and FIG. 53 may be selected.

With the structure, when a fire occurs in the battery cell 110, foreign substances or high-pressure fluid caused by the fire cut the inner notch part 710 of the inner fire-resistant member 700, and the outer notch part 910 is cut through the cover venting hole 625 or the cover notch part 624, and thus, they may be vented to the outside of the battery cell stack 100, so that transfer of heat to another battery cell 110 that is adjacent to the battery cell 110, in which a fire occurs, may be delayed.

In this way, when a fire occurs in the battery cell 110, the battery cell stack 100 may vent foreign substances or high-pressure fluid caused by the fire upward or downward to the outside of the battery cell stack 100, depending on a direction, in which the battery cell stack 100 is installed.

In this case, for the partition member 600 in an interior of the battery cell stack 100, not only the partition member 600 according to an embodiment of the present disclosure, but also the partition member 600-1 according to another embodiment of the present disclosure, or the partition members 600-2, 600-3, 600-4, 600-5, and 600-6 according to still another embodiment of the present disclosure may be applied.

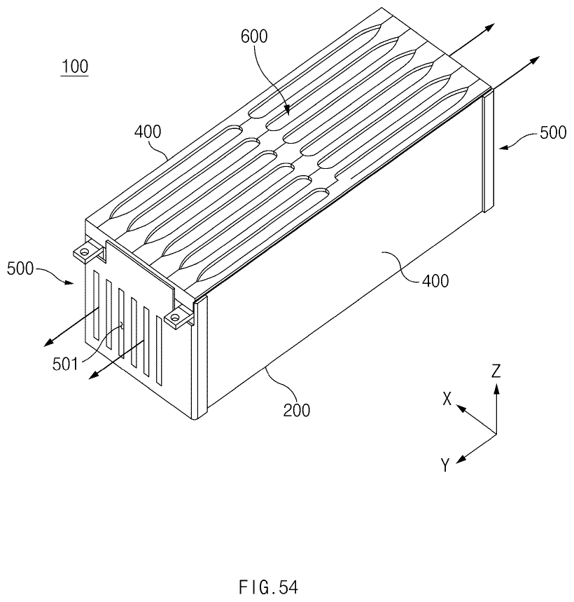

FIG. 54 is a perspective view of a battery cell stack according to still another embodiment of the present disclosure. FIG. 55 is a transverse cross-sectional view of battery cells, a sensing assembly, a sensing fire-resistant member, and a sensing cover illustrated in FIG. 54.

Referring to FIG. 54 and FIG. 55, the battery cell stack 100 according to another embodiment of the present disclosure, unlike the battery cell stack 100 according to various embodiments illustrated in FIG. 50, may have a structure that vents foreign substances or high-pressure fluid caused by fire to opposite sides of the battery cell stack 100 in the lengthwise direction when a fire occurs in the battery cell 110.

The battery cell stack 100 according to still another embodiment of the present disclosure may include the sensing assembly 510, the sensing cover 500, and a sensing fire-resistant member 700-1 that are different from the sensing assembly 510, the sensing cover 500, and the inner fire-resistant member 700 according to the above-described embodiments.

According to still another embodiment of the present disclosure, the sensing assembly 510 may include a busbar 525 that is electrically connected to the plurality of battery cells 110, and a sensing frame 520 that supports the busbar 525 and has a sensing hole 511 formed on an area that faces the plurality of battery cells 110.

According to still another embodiment of the present disclosure, the sensing cover 500 may cover an outer side of the sensing assembly 510 and may include a cover hole 501 formed on an area that faces the sensing hole 511.

Furthermore, according to still another embodiment of the present disclosure, the sensing fire-resistant member 700-1 may be disposed between the sensing assembly 510 and the sensing cover 500, and may include a sensing notch part 710-1 that is formed on an area that faces the sensing hole 511 and a sensing cover hole 501 and has a thickness that is thinner than a surrounding thickness or has a cut shape.

With the structure, when a fire occurs in any one of the plurality of battery cells 110, foreign substances or high-pressure fluid caused by the fire contact the sensing fire-resistant member 700-1 along the sensing hole 511, and the sensing notch part 710-1 may be cut.

When the sensing notch part 710-1 is cut, the sensing hole 511 and the sensing cover hole 501 may communicate with each other, and foreign substances or high-pressure fluid caused by the fire may be vented to the outside of the battery cell stack 100 through the sensing cover hole 501.

The sensing assembly 510 and the sensing cover 500 illustrated in FIG. 54 and FIG. 55 may be applied to not only the partition member 600 but also the battery cell stack 100 including the partition members 600-1, 600-2, 600-3, 600-4, 600-5, and 600-6.

Meanwhile, the above-described partition members 600, 600-1, 600-2, 600-3, 600-4, 600-5, and 600-6 may be mixed with a material having fire resistance or heat insulation to be used.

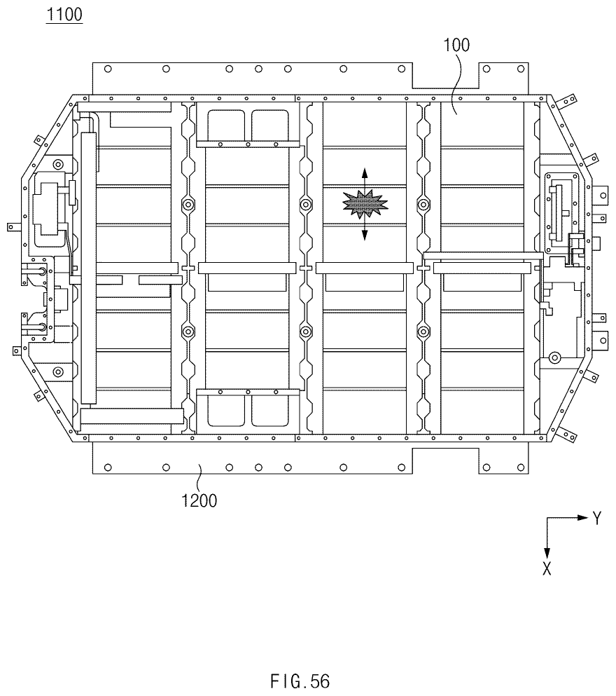

FIG. 56 is a plan view of a battery pack, in which a battery cell stack is mounted, according to an embodiment of the present disclosure.

Referring to FIG. 56, the battery cell stack 100 according to the above-described embodiments may be mounted on a battery pack 1100. The battery pack 1100 may include a pack housing 1200, on which the battery cell stack 100 is seated.

When a fire occurs in any one of the plurality of battery cell stacks 1100 in an interior of the battery pack 1100, foreign substances or high-pressure fluid may be vented to the outside of the battery cell stack 100 due to the above-described structure or principle, while not being introduced into an adjacent battery cell stack 100, and may be vented to the outside of the battery pack 1100.

According to the present technology, because the partition member may spatially separate battery cells that are stacked in the widthwise direction from each other, a fire may be prevented from occurring in battery cells disposed in an adjacent space even when a fire occurs in a battery cell in any one space.

Furthermore, transfer of heat between adjacent battery cells may be delayed by the partition body of the partition member, and a fire may be prevented from occurring in adjacent battery cells even when a fire occurs in any one battery cell.

Furthermore, according to the present technology, because the partition body of the partition member and the cover body of the partition member are formed integrally, the one surface of the battery cell in the widthwise direction and the one surface of the battery cell in the height direction may be covered, so that assembling performance of the battery cell stack may be improved.

Furthermore, according to the present technology, because a cover venting hole or a cover notch part is formed in the cover body of the partition member, foreign substances or high-pressure fluid may be vented to the outside of the battery cell stack while not flowing to adjacent battery cells even when a fire occurs in a battery cell.

Furthermore, according to the present technology, because the end cover body, the guide cover body, and the connection body of the partition member may cover areas, except for cell lead parts, on opposite sides of the battery cell in the lengthwise direction, external foreign substances or high-pressure fluid may be prevented from being introduced through one side of the battery cell

in the lengthwise direction.

Furthermore, according to the present technology, because the cover bodies, the end cover bodies, and the guide cover bodies of an adjacent pair of partition members overlap each other or are coupled to each other, external foreign substances or high-pressure fluid may be prevented from being introduced into the battery cells even when the battery cells swell.

Furthermore, according to the present technology, because the plurality of partition members and the end plate are coupled to each other, a gap between adjacent partition members may be prevented from becoming wider even when the battery cells swell, so that external foreign substances or high-pressure fluid may be prevented from being introduced into the battery cells.

Furthermore, according to the present technology, because the barrier member or the cooling plate that contacts the partition member or the battery cell is disposed, a temperature of the battery cell may be prevented from excessively rising, so that safety of the battery cell stack may be improved.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A battery cell stack comprising:
a plurality of battery cells arranged in a widthwise direction thereof; and
a partition member disposed between the plurality of battery cells and configured to partition the plurality of battery cells,
wherein the partition member includes:
a partition body provided between a pair of battery cells, among the plurality of battery cells, and extending in a height direction;
a cover body extending from the partition body toward a side in the widthwise direction to cover a first surface facing a first side of a first battery cell of the pair of battery cells, in the height direction; and
a support body extending from the partition body parallel to the cover body to cover a second surface facing a second side of the first battery cell in the height direction, the first surface and the second surface facing opposite sides of the first battery cell.

2. The battery cell stack of claim 1, wherein the plurality of battery cells includes a second battery cell provided on an opposite side to a side facing the partition body with respect to the first battery cell,
wherein the first surface of the first battery cell and a first surface of the second battery cell facing a first side in the height direction are configured to be covered by the cover body, and
wherein the second surface of the first battery cell and a second surface of the second battery cell facing a second side in the height direction are configured to be covered by the support body.

3. The battery cell stack of claim 2, wherein the partition member includes:
an end cover body extending from the cover body toward the support body to cover together at least a portion of the first battery cell and at least a portion of the second battery cell on a side of the first battery cell in a lengthwise direction; and
a guide cover body extending from the support body toward the cover body to cover at least a portion of the first battery cell and at least a portion of the second battery cell on the side of the first battery cell in the lengthwise direction.

4. The battery cell stack of claim 3, wherein the partition member further includes:
a connection body connecting the end cover body and the guide cover body and having a thickness greater than a thickness of the partition body in the widthwise direction.

5. The battery cell stack of claim 4, wherein the first battery cell includes a cell lead part extending to the side in the lengthwise direction, and
wherein the connection body protrudes from the partition body toward the cell lead part of the first battery cell.

6. The battery cell stack of claim 5, wherein the connection body is spaced apart from the cell lead part.

7. The battery cell stack of claim 1, further comprising:
an end plate disposed at a side of the plurality of battery cells in the widthwise direction; and
a support member disposed between, among the plurality of battery cells, a battery cell located at an end in the widthwise direction and the end plate, and configured to cover a side of, among the plurality of battery cells, the battery cell located at the end in the widthwise direction.

8. The battery cell stack of claim 7, wherein the support member is disposed parallel to the cover body.

9. The battery cell stack of claim 7, wherein the support member includes:
a support partition body provided between, among the plurality of battery cells, the battery cell located at the end in the widthwise direction and the end plate and extending in the height direction;
a first support cover body extending from the support partition body toward the cover body; and
a second support cover body extending from the support partition body toward the support body.

10. The battery cell stack of claim 2, wherein the cover body includes a cover venting hole formed on an area facing the first battery cell or an area facing the second battery cell, or a cover notch part formed on an area facing the first battery cell or an area facing the second battery cell and having a cut shape or a thickness smaller than a thickness of a surrounding area, and
wherein the battery cell stack further includes an inner fire-resistant member provided between the cover body and the first battery cell or between the cover body and the second battery cell and including an inner notch part formed on an area facing the cover venting hole or cover notch part, and having a cut shape or a thickness smaller than a thickness of a surrounding area.

11. The battery cell stack of claim 1, further comprising:
a sensing assembly including a bus bar electrically connected to the plurality of battery cells and a sensing frame supporting the bus bar and having a sensing hole formed on an area facing the plurality of battery cells;
a sensing cover covering an outer side of the sensing assembly and including a cover hole formed on an area facing the sensing hole; and
a sensing fire-resistant member disposed between the sensing assembly and the sensing cover and including a sensing notch part formed on an area facing the sensing hole and the cover hole and having a cut shape or a thickness smaller than a thickness of a surrounding area.

12. The battery cell stack of claim 1, wherein a surface of the partition body facing the first battery cell is formed of a material having thermal conductivity or a material having heat insulation or fire resistance.

13. The battery cell stack of claim 2, wherein the partition member includes a first partition member covering the first battery cell and the second battery cell together and a second partition member provided parallel to the first partition member, and
wherein the battery cell stack further includes a barrier member contacting i) at least one of the first partition member and the second partition member, or ii) at least one of the first battery cell and the second battery cell.

14. The battery cell stack of claim 13, wherein the barrier member is formed of a material having heat insulation or fire resistance or a material having thermal conductivity.

15. The battery cell stack of claim 13, further comprising: a cooling plate disposed between the first partition member and the second partition member to cool the first partition member and the second partition member.

16. The battery cell stack of claim 1, wherein each of the plurality of battery cells includes:
a first electrode;
a second electrode having a polarity different from the first electrode;
a separator provided between the first electrodes and the second electrodes; and
a case including a packaging area surrounding the first electrode, the second electrode, and the separator, and an extension area extending from the packaging area to a side the battery cell in the lengthwise direction of, and
wherein the extension area is bent to a side in the widthwise direction to cover a side of the packaging area in the lengthwise direction.
